(19) United States
(12) Patent Application Publication
(10) Pub. No.: US 2026/0312720 A1
(43) Pub. Date: Oct. 8, 2026

(54) RECEIVER SELECTION FOR WIRELESS SYSTEMS AND APPLICATIONS

(71) Applicant: NVIDIA Corporation, Santa Clara, CA (US)

(72) Inventor: Xingqin Lin, Cupertino, CA (US)

(21) Appl. No.: 19/255,549

(22) Filed: Jun. 30, 2025

Related U.S. Application Data
(60) Provisional application No. 63/784,794, filed on Apr. 7, 2025.

(51) Int. Cl. H04L 1/00; H04L 41/16

(52) U.S. Cl. CPC H04L 1/0047; H04L 41/16

(57) ABSTRACT

In various examples, apparatuses, systems, software, and methods are described for selecting decoders to decode messages from encoders in a wireless network. For example, a base station includes a processor that uses a machine learning model to select a decoder from a plurality of decoders to decode an encoded representation of information received from an encoder in a user equipment (UE) device.

### CROSS REFERENCE TO RELATED APPLICATIONS

This application claims the benefit of U.S. Provisional Application No. 63/784,794 (Attorney Docket No.: 0112912-F04PR0), filed Apr. 7, 2025, entitled “RECEIVER SELECTION FOR WIRELESS SYSTEMS AND APPLICATIONS,” the entire contents of which is incorporated herein by reference.

### TECHNICAL FIELD

Apparatuses, systems, and methods for selecting a decoder from a group of decoders to decode received messages, where each message is transmitted through one or more wireless channels. For example, a base station includes a processor that uses a machine learning model to select a decoder from a plurality of decoders to decode an encoded representation of information received from a user equipment (UE) device. Specifically, the UE uses an encoder to generate the encoded representation, which travels through one or more channels before being received by the base station.

### BACKGROUND

A transmitter in a wireless network sends wireless signals including data over a distance using an encoder, where the encoder compresses the data to reduce bandwidth usage and adds error-correction information to improve transmission reliability. A receiver receives the wireless signals and uses a decoder to correct errors and decompress the data to restore the original content. Encoding and decoding techniques can be inefficient or error-prone, particularly when adapting to dynamic wireless environments, leading to increased latency, data loss, or reduced throughput. Accordingly, there is a need to address this technical problem and provide additional technical benefits.

### BRIEF DESCRIPTION OF DRAWINGS

FIG. 1A illustrates a communications system, in accordance with at least one embodiment;

FIG. 1B illustrates a communications system with a transmitter that includes a machine learning model (e.g., machine learning model to encode) and receiver that includes another machine learning model (e.g., machine learning model to decode), in accordance with at least one embodiment;

FIG. 2 illustrates a communications system for selecting a decoder to decode a message from an encoder, in accordance with at least one embodiment;

FIG. 3 illustrates a machine learning model (e.g., a neural network) to select a receiver, in accordance with at least one embodiment;

FIG. 4 is a block diagram illustrating a process for training a machine learning model (e.g., receiver model selector) to select a decoder to decode a message representation from an encoder, in accordance with at least one embodiment;

FIG. 5 is a flow diagram illustrating a process for selecting a neural receiver model using a receiver model selector during message decoding, in accordance with one or more embodiments;

FIG. 6 illustrates a sequence diagram for updating a receiver model selector and a corresponding receiver using a shared dataset, in accordance with at least one embodiment;

FIG. 7 illustrates a system for jointly training a neural receiver model and a neural receiver model selector based on a latent signal representation, in accordance with at least one embodiment;

FIG. 8 illustrates a system for independently training a receiver model and a receiver model selector, in accordance with at least one embodiment;

FIG. 9 illustrates a sequence diagram for training a receiver model and a receiver model selector using a transferred transmitter model, in accordance with at least one embodiment;

FIG. 10 illustrates a system for jointly updating a receiver model and a receiver model selector, in accordance with at least one embodiment;

FIG. 11 illustrates a system for separately updating a neural receiver model and a receiver model selector, in accordance with at least one embodiment;

FIG. 12 illustrates a data center system, in accordance with at least one embodiment;

FIG. 13 illustrates an system-on-a-chip (SoC), in accordance with at least one embodiment;

FIG. 14A illustrates a parallel processor, in accordance with at least one embodiment;

FIG. 14B illustrates a processing cluster, in accordance with at least one embodiment;

FIG. 14C illustrates a graphics multiprocessor, in accordance with at least one embodiment;

FIG. 15 illustrates an accelerator processor, in accordance with at least one embodiment;

FIG. 16A illustrate a central processing unit, in accordance with at least one embodiment;

FIG. 16B illustrates a core of central processing unit in FIG. 16A, in accordance with at least one embodiment;

FIG. 17 illustrates another accelerator processor, in accordance with at least one embodiment;

FIG. 18 illustrates a neuromorphic processor, in accordance with at least one embodiment;

FIG. 19 illustrates a supercomputer, in accordance with at least one embodiment;

FIG. 20 illustrates another accelerator processor, in accordance with at least one embodiment;

FIG. 21 illustrates another processor, in accordance with at least one embodiment;

FIG. 22 illustrates another accelerator processor, in accordance with at least one embodiment;

FIG. 23 illustrates a tensor processing unit, in accordance with at least one embodiment;

FIG. 24 illustrates a software stack of a programming platform, in accordance with at least one embodiment;

FIG. 25A illustrates inference and/or training logic, in accordance with at least one embodiment;

FIG. 25B illustrates inference and/or training logic, in accordance with at least one embodiment;

FIG. 25C illustrates training and deployment of a neural network, in accordance with at least one embodiment;

FIG. 26 illustrates an example high level system, in accordance with at least one embodiment; and

FIG. 27 illustrates simulation software for a wireless network, such as a 5G New Radio (NR) or radio access network (RAN), in accordance with at least one embodiment.

### DETAILED DESCRIPTION

An encoder executed using one or more processors can use a machine learning model to perform encoding and/or compression (e.g., receiving a message and generating an encoded and compressed representation of that message). In some embodiments, the encoder may use a neural network, in which case the encoder may be referred to as a neural encoder. Similarly, a decoder executed using one or more processors can use a machine learning model to perform decoding of messages (e.g., messages generated by the encoder). When the decoder uses a neural network, it may be referred to as a neural decoder. In some embodiments, a neural encoder and a neural decoder are trained as a fixed pair, such that each neural decoder is only compatible with its corresponding neural encoder. This pairing can create challenges in multi-vendor environments, such as fifth-generation (5G) and sixth-generation (6G) networks, where encoders and decoders may be developed independently by different vendors and are expected to interoperate.

In a telecommunications network, a neural encoder can encode a message into a latent representation for transmission as a wireless signal, and a neural decoder can decode (e.g., reconstruct) this latent representation after it passes through the wireless channel, in order to recover the original (unencoded) message. A latent representation may be a compressed version of the original message and may include features used by the neural decoder to infer the original content. Because the latent representation is compressed, it can be transmitted using less bandwidth than the original message. Unlike traditional encoding schemes, which rely on predefined symbols and bit structures, neural encoding can learn a latent space that adapts to real-world transmission conditions. In at least one embodiment, the latent representation constitutes both a compression and an encoding of the original message.

One technical problem is that neural encoders and decoders are often jointly trained, resulting in systems where each neural encoder is tied to a specific neural decoder. This tight coupling limits interoperability and flexibility in multi-vendor environments. In 5G and 6G networks, base stations should be capable of supporting a variety of encoders used by different user equipment (UE) devices, including independently trained neural encoders and decoders.

To address this technical problem and provide additional technical benefits, a machine learning model (e.g., a neural network) can be used to select a neural decoder from among multiple available neural decoders, based on characteristics of the message's latent signal representation after transmission through the wireless channel. These characteristics may include modulation scheme (used prior to transmission), signal structure, power levels, spectral characteristics, noise conditions, and channel state information. The machine learning model and the candidate decoders may be jointly trained using latent signal representations and corresponding ground truth messages. The loss function can be configured to optimize both decoder selection accuracy and message reconstruction quality. Training data may include both vendor-provided datasets and field-collected examples to allow for continuous adaptation. A base station can use the trained neural network to dynamically select among neural decoders when receiving messages from different UE devices, where each UE may have used a different encoding model.

Transceivers are devices in wireless communication systems that combine both transmitter and receiver functions into a single unit. One transceiver is located on the UE device and another on a network node (e.g., in a base station or an edge server). The transmitter component includes an encoder that converts data into signals suitable for transmission over a communication channel (e.g., a medium such as radio waves), while the receiver component includes a decoder that receives these signals and converts them back into the original data. This dual functionality enables efficient two-way communication in various wireless networks. In this disclosure, in some embodiments, a transmitter and encoder are used interchangeably, as are a receiver and decoder.

As used herein, a transmitter can be a physical or logical entity configured to process and emit electromagnetic signals representative of encoded information. A receiver can be a physical or logical entity configured to receive, process, and decode electromagnetic signals transmitted by a transmitter through a communication channel. An encoder can be a hardware, software, or firmware module configured to receive input data and generate a structured output for transmission over a communication channel. A decoder can be a hardware, software, or firmware module configured to receive encoded data and recover, reconstruct, or otherwise generate the original input data. A neural encoder can be a machine learning model trained to transform input data into a latent representation for transmission over a communication channel. A neural decoder can be a machine learning model trained to process a received representation of transmitted data and reconstruct, recover, or otherwise generate the original input data.

Various embodiments of this disclosure can be implemented in Third Generation Partnership Project (3GPP) networks, such as fourth-generation (4G) Long-Term Evolution (LTE), fifth-generation (5G) and sixth-generation (6G) networks. Also, various embodiments of this disclosure can be implemented in an open radio access network (O-RAN).

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) are small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software. For example, a processor can receive inputs from neural networks or machine learning models and use those to modify its outputs in a parallelization of the Riding Peaks algorithm.

In one or more embodiments, the system and methods described herein may be deployed in a gaming application, e.g., a base station communicating to with a server that is providing a gaming application to one or more UE devices. For example, a gaming console, PC, tablet, mobile device, and/or other gaming device may include cellular wireless capability and one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a robotics application, e.g., a robot can be a UE device. For example, a robot or robotic system may have cellular wireless capability and include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system or IX application (e.g., for occupant and driver monitoring) within a machine (e.g., cars, trucks, drones, construction equipment, robots, semi-autonomous vehicles, or autonomous vehicles) may include cellular wireless capability and one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

In the following description, numerous specific details are set forth to provide a more thorough understanding of at least one embodiment. However, it will be apparent to one skilled in the art that the inventive concepts may be practiced without one or more of these specific details.

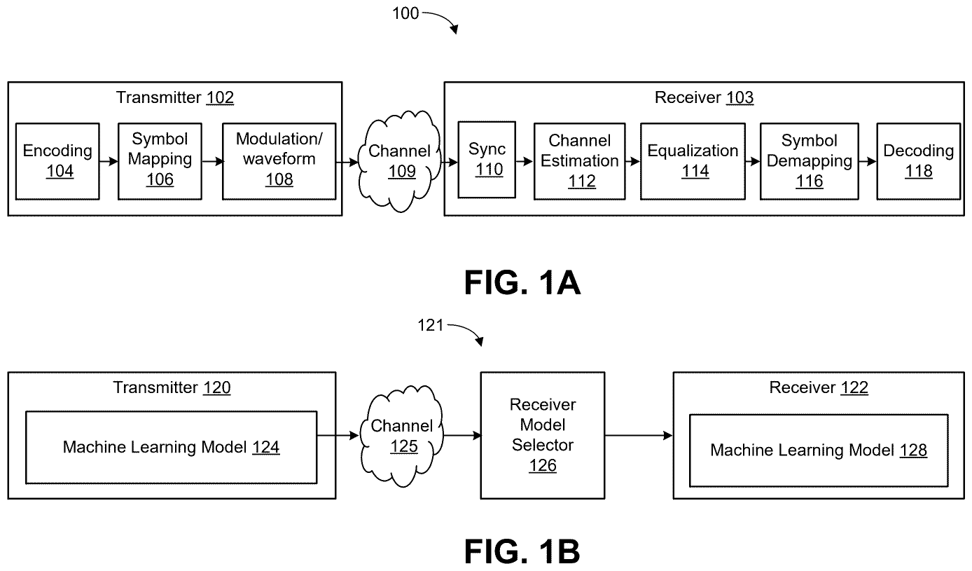

FIG. 1A illustrates a communication system 100, and FIG. 1B illustrates a different communication system 121. In particular, FIG. 1A shows a transmitter 102 and a receiver 103 that employ linked encoding and decoding blocks, such that the decoder is configured to complement the specific encoder used. In contrast, FIG. 1B shows communication system 121, in which a machine learning model 124 is used for encoding at transmitter 120, and a separate machine learning model 128 is used for decoding at receiver 122. As further described in this disclosure, the receiver model selector 126 is configured to select from among multiple decoding machine learning models based on encoding characteristics, channel conditions, signal features, or other context, thereby enabling the use of different models for encoding and decoding. Although communication systems 100 and 121 differ in architecture, they may be used in combination. For example, communication system 100 may serve as a fallback or default system in cases where receiver model selector 126 is unavailable or produces an error. In at least one embodiment, communication system 100 uses an engineer to share specific encoding and decoding symbols or sequences between the transmitter and receiver to ensure correct interpretation of transmitted messages. By contrast, in communication system 121, machine learning model 124 and machine learning model 128 may be trained independently, and it is not necessary for an engineer to explicitly share encoding and decoding code words or symbols between the transmitter and receiver—although such information may be provided as part of the training data in some implementations.

Communication system 100 comprises a transmitter 102 and a receiver 103 configured to communicate wireless over a communication channel 109. Transmitter 102 can be located in a UE device or a network node, such as a base station. Transmitter 102 can also be a UE device, e.g., a mobile phone, in-machine infotainment device, such as a vehicle, robot, watercraft, aircraft, etc., talking kiosk, smart device, security system, and other wireless-capable devices. Similarly, receiver 103 can be located in a UE device or a network device. Transmitter 102 and receiver 103 can be performed, executed, or otherwise implemented as separate devices rather than as parts of a single transceiver device or a single system.

Transmitter 102 can comprise an encoding module 104, a symbol mapping module 106, and a modulation/waveform module 108, which are software that can be performed by one or more processors. These components can operate sequentially to process input data for transmission over communication channel 109. Encoding module 104 receives input data and applies a forward error correction (FEC) code or other encoding schemes to improve robustness against transmission impairments. Suitable encoding techniques may include convolutional codes, turbo codes, low-density parity-check (LDPC) codes, polar codes, Reed-Solomon codes, or neural network-based encoders. The encoded output may include parity bits or redundancy bits that enable downstream error detection and correction at receiver 103.

In at least one embodiment, symbol mapping module 106 maps encoded bits into modulation symbols according to a defined constellation. The mapping may be based on modulation schemes such as binary phase-shift keying (BPSK), quadrature phase-shift keying (QPSK), M-ary quadrature amplitude modulation (M-QAM), or amplitude phase shift keying (APSK), among others. In some embodiments, the symbol mapping may also account for bit interleaving or Gray coding to decrease (e.g., minimize) the effect of bit errors caused by symbol misclassification. In deep learning-based transceivers, symbol mapping may be implemented via trainable neural layers that optimize symbol placement in the constellation.

In at least one embodiment, modulation/waveform module 108 receives the mapped symbols and converts them into a continuous-time waveform for transmission. This module may apply pulse shaping filters (e.g., root-raised cosine filters), carrier modulation, and digital-to-analog conversion. The resulting waveform may be constructed according to a predefined or dynamically selected modulation format, such as orthogonal frequency-division multiplexing (OFDM), single-carrier frequency domain equalization (SC-FDE), or other multi-carrier or spread spectrum techniques. In a neural transceiver architecture, this module may be jointly trained with preceding components to generate a waveform optimized for the characteristics of a given communication channel.

In some embodiments, communication channel 109 is a wireless communication channel, through which signals are transmitted via electromagnetic waves. This may include terrestrial radio frequency (RF) propagation in licensed or unlicensed spectrum, and may support technologies such as 4G LTE, 5G NR, Wi-Fi, Bluetooth, or satellite links. Communication channel 109 may be subject to various impairments such as path loss, multipath fading, Doppler shift, shadowing, or interference from co-channel users. The wireless medium may further be modeled using channel models such as Additive White Gaussian Noise (AWGN), Rayleigh fading, Rician fading, or non-stationary and non-linear channel models in advanced environments.

In at least one embodiment, receiver 103 recovers transmitted data from a received signal impaired by channel distortions and noise. Receiver 103 comprises a synchronization module 110, a channel estimation module 112, an equalization module 114, a symbol demapping module 116, and a decoding module 118. These modules can operate sequentially to reverse the signal processing operations applied by transmitter 102 and to mitigate the degradations introduced by communication channel 109. In at least one embodiment, synchronization module 110 aligns the timing and frequency of the received signal with the original transmitted waveform. This includes frame synchronization, frequency offset correction, and phase alignment. In some embodiments, synchronization is achieved using predefined training sequences or pilot symbols embedded in the transmitted waveform. In some embodiments, channel estimation module 112 estimates the parameters of communication channel 109, such as impulse response, fading coefficients, or channel transfer function. These parameters are used to compensate for time-varying or frequency-selective distortions. Channel estimation may be performed using pilot-aided methods, blind estimation techniques, or learning-based models. The resulting channel state information (CSI) can be used by subsequent modules for adaptive signal processing.

In at least one embodiment, equalization module 114 mitigates inter-symbol interference (ISI) and other channel-induced distortions using the estimated channel information. Equalization techniques may include linear equalizers (e.g., zero-forcing, MMSE), decision feedback equalizers (DFE), or neural network-based equalizers trained to approximate inverse channel characteristics. This module restores the integrity of the transmitted signal before symbol-level interpretation. Symbol demapping module 116 converts the equalized signal into soft or hard symbol decisions. This involves identifying the most likely transmitted symbols from the constellation used during modulation. Demapping may be implemented using minimum distance detection, log-likelihood ratio (LLR) generation for soft decoding, or learned classifiers in data-driven systems. In some embodiments, the demapping process accounts for residual channel uncertainty or varying noise levels.

In at least one embodiment, decoding module 118 reconstructs the original information bits from the demapped symbols. The module applies error correction decoding corresponding to the encoding scheme used at the transmitter, such as Viterbi decoding for convolutional codes, belief propagation for LDPC. Decoding module 118 corrects bit errors introduced during transmission and outputs the estimated original data stream.

As described above, transmitter 102 and receiver 103 are implemented using modular pipeline structure, with each module dedicated to a distinct function. In some embodiments, each module may implement explicit mathematical operations and algorithms (e.g., Fourier transforms, channel codes, and maximum likelihood detection). Transmitter 102 and receiver 103 can be designed separately to rely on predefined standards (e.g., code words, symbols, predefined sequence of bits) to ensure interoperability. Transmitter 102 and receiver 103 can be designed for standard channel models like Gaussian noise or Rayleigh fading, but their performance degrades if the channel environment degrades (e.g., deviates significantly from assumptions).

Each module in transmitter 102 and receiver 103 may be implemented using conventional hardware (e.g., ASIC, FPGA, RFIC), software routines, such as those executed by a digital signal processor, CPU, or GPU, or any combination thereof in conjunction with or independent from machine learning-based components. Alternatively, transmitter 102 and receiver 103 may be implemented using a machine learning model. For example, the functionality of the modules 104-108 and the functionality of the modules 110-118 may be implemented using neural networks, such as convolutional neural networks (CNNs), recurrent neural networks (RNNs), transformers, or other deep learning architectures.

When implemented as machine learning models, a transmitter and a receiver can be referred to as a neural encoder and a neural decoder, respectively. In some embodiments, the machine learning model in the transmitter is referred to a neural encoder and the machine learning in the receiver is referred to as the neural decoder.

In some embodiments, neural encoders and neural decoders use a holistic, end-to-end approach, in which a single neural network- or multiple interconnected networks—is trained to optimize the entire communication process for a specific channel model or task.

Neural encoders and decoders can use autoencoders, a type of neural network architecture where the encoder (transmitter) and decoder (receiver) are jointly optimized. The transmitter/encoder maps the input data to a signal representation (modulated waveform) that can traverse the wireless channel. During training, the neural network learns to adapt to the impairments of real-world wireless channels (e.g., noise, interference, attenuation, multipath fading, doppler shift, and non-linearity). The receiver/decoder learns to reverse the impairments introduced by the channel and recover the original data.

Designing a neural receiver that is compatible with a neural transmitter introduces several challenges, primarily due to the tightly coupled and interdependent nature of the two components. Traditional transceiver systems often separate the transmitter and receiver design through standards and modularization, but neural transceivers rely on joint optimization, creating unique obstacles. The training complexity inherent in a two-sided AI/ML model is further compounded by the necessity for multi-vendor interoperability and compatibility.

Consider the example of a transmitter/encoder located at the UE device and a receiver/decoder situated at a network node, such as a base station. The decoder located at the base station needs to be compatible with different encoders at the UE side, and vice versa. To cope with diverse encoder models used in different UEs or even the same UE, the base station would need to be equipped multiple decoder models. To be interoperable, each encoder is paired with a specific decoder, so that the base station can determine which decoder to use for signals generated by a specific encoder. This static pairing solution reduces flexibility in dynamic environments, where the channel conditions or transmitter configurations might change frequently. For example, if the transmitter changes its encoder, the receiver will fail unless the corresponding decoder is available.

FIG. 1B is an example communication system 121 with a neural encoder and an neural decoder. System 121 can address the challenges described in connection with FIG. 1A using a receiver model selector 126, which can select an appropriate receiver (e.g., decoder) 122 from multiple receivers based on characteristics of a received signal or latent signal representation from a transmitter 120. Each of the multiple receivers is similar to receiver 122.

Receiver model selector 126 may be implemented as a classifier, a scoring function, or another machine learning model that evaluates the incoming signal and identifies the most suitable machine learning model for decoding. This approach addresses the challenge of interoperability in multi-vendor or dynamically adaptive transceiver systems, where different transmitters may use different encoders or model configurations. Transmitter 120 may be located on either the UE device or the network node. Correspondingly, receiver 122 is located on, either on the network node or the UE device.

In some embodiments, receiver model selector 126 may be located in a base station (e.g., gNB), a distributed unit (DU) such as an O-DU, a centralized unit (CU) such as an O-CU, a UE device, a controller, or another node within a 5G core network. Receiver model selector 126 is trained to learn the mapping from a received latent signal representation directly to a neural receiver, such as receiver 122.

Transmitter 120 includes a machine learning model 124 that is trained to perform the combined functionality of encoding module 104, symbol mapping module 106, and modulation/waveform module 108 as described in FIG. 1A. In some embodiments, machine learning model 124 is trained to map input data into a latent signal representation suitable for transmission over communicational channel 125. Machine learning model 124 may learn to encode redundancy, optimize constellation geometry, and synthesize waveforms in a channel-aware manner, either through supervised training, reinforcement learning, or end-to-end autoencoder training frameworks.

In at least one embodiment, transmitter 120 is referred to as a neural encoder. In some other embodiments, machine learning model 124 is referred to as a neural encoder. Machine learning model 124 can be implemented using various types of machine learning models. For example, machine learning model 124 can be implemented as a deep learning model, such as a Convolutional Neural Network (CNN), a Transformer network, a Recurrent Neural Network (RNN), or an Autoencoder. In some embodiments, machine learning model 124 can be implemented as traditional machine learning models that rely on statistical, probabilistic, or linear techniques and include algorithms. Examples of these traditional machine learning models include Gaussian mixture model (GMM), Naive Bayes, and Logistic Regression. The selection of model architecture may depend on system requirements, channel characteristics, and available training data.

In at least one embodiment, the signal generated by machine learning model 124 is transmitted over channel 125, which may correspond to any physical or simulated communication medium, including wireless, optical, wired, or hybrid links. Channel 125 may introduce impairments such as fading, noise, non-linearity, or interference.

Receiver 122 includes a machine learning model 128, which is trained to perform the combined functionality of synchronization module 110, channel estimation module 112, equalization module 114, symbol demapping module 116, and decoding module 118 to recover the original data from the received signal. In at least one embodiment, receiver 122 is referred to as a neural decoder. In some other embodiments, machine learning model 128 is referred to as a neural decoder. Machine learning model 128 may be implemented using various types of machine learning models. For example, machine learning model 128 can be implemented as a deep learning model, such as a Convolutional Neural Network (CNN), a Transformer network, a Recurrent Neural Network (RNN), or an Autoencoder. In some embodiments, machine learning model 128 can be implemented as traditional machine learning models that rely on statistical, probabilistic, or linear techniques and include algorithms. Examples of these machine learning models include Gaussian mixture model (GMM), Naive Bayes, and Logistic Regression. The selection of model architecture may depend on system requirements, channel characteristics, and available training data.

In at least one embodiment, at least one feature described in connection with FIGS. 1A and 1B is implemented using at least one feature of any system(s) and/or process(es) depicted in and/or described in connection with other figures in this disclosure. In at least one embodiment, at least one feature described in connection with FIGS. 1A and 1B is used to implement at least a portion of any system(s) and/or process(es) depicted in and/or described with respect to the other figures in this disclosure.

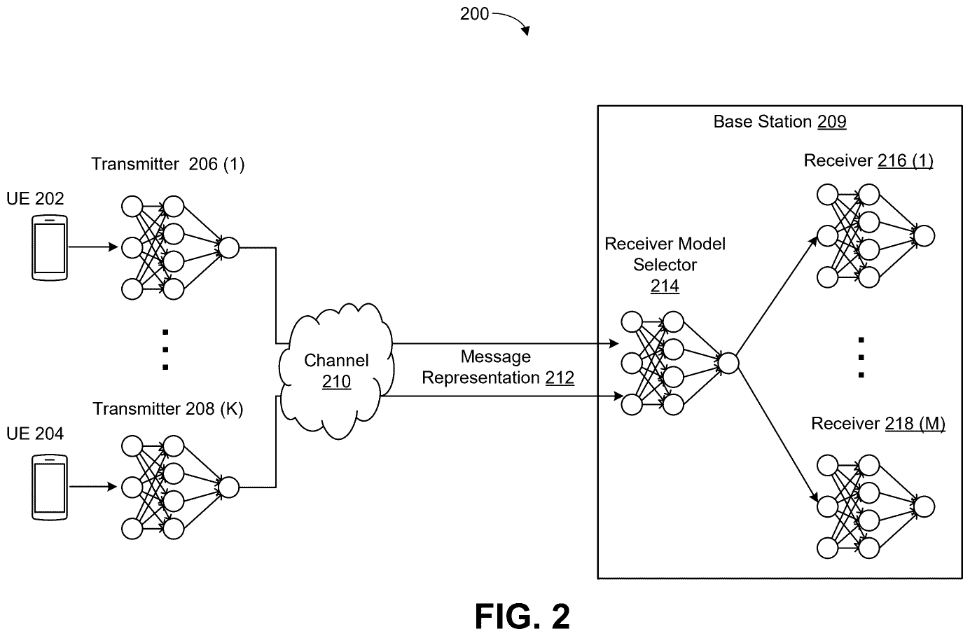

FIG. 2 illustrates an example communications system 200 for selecting a decoder to decode a message from an encoder, in accordance with at least one embodiment. Communications system 200 is an example of communications system 121 as described in connection with FIG. 1B. More specifically, communications system 200 illustrates a process of using a receiver model selector 214 to select a receiver from multiple receivers 216 through 218 to decode a message representation 212 transmitted over a communication channel 210 from one of a plurality of transmitters 206 through 208 located in UE devices 202 through 204.

In some embodiments, each of transmitters 206 through 208 is a neural transmitter or a neural encoder, similar to transmitter 120 as described in connection with FIG. 1B. Each of receivers 216 through 218 is a neural receiver or a neural decoder, similar to receiver 122 as descried in connection with FIG. 1B. Receiver model selector 214 can be a deep learning model or another type of machine learning model, and is similar to receiver model selector 126 as described in connection with FIG. 1B. Channel 210 is similar to channel 125 as described in connection with FIG. 1B.

In some embodiments, each of transmitter 206 through 208 can generate a message representation 212, which is information or data that needs to be transmitted from one of the UE devices 202 through 204 to a base station 209. Message representation 212 is a latent signal representation of a message. The message can be one of a variety of data types and forms, which include textual data (e.g., email content, SMS), audio data, video data, sensor data, and control signals. In some embodiments, a latent signal representation of a message is a compressed, encoded version of data that captures its essential features, through techniques such as feature extraction, dimensionality reduction, and encoding. This transformation simplifies the data, preserving essential information while reducing complexity, making it more suitable for efficient processing, analysis, or transmission, such as in 5G networks. In some implementations, the latent signal representation may further include structured redundancy or error-correcting information (e.g., parity bits or encoded patterns), which can be used during transmission to detect and/or correct errors caused by channel impairments such as noise, interference, or fading.

In some embodiments, message representation 212 contains redundancy information used to survive channel noise, rather than to decrease (e.g., minimize) data size. Message representation 212 has characteristics that can be used by receiver model selector 214 to select an appropriate receiver to decode message representation 212 and reconstruct the original message. In some embodiments, the characteristics are fingerprints specific to one of transmitters 206 through 208 and are shaped by how the corresponding transmitter or neural encoder was trained. In some embodiments, the characteristics correspond to the effects of a wireless channel on message representation 212 during transmission. These channel effects include distortions such as fading, noise, interference, and non-linearities. In some embodiments, the characteristics are generated as a joint function of the neural encoder and the channel conditions during transmission. In some embodiments, the characteristics include spectral characteristics, which describe the frequency-domain properties of a signal derived from message representation 212 after modulation and passage through a communication channel, such as channel 210. In some embodiments, the characteristics include information indicating how the signal power of message representation 212 is distributed across time, space, or modulation dimensions, including temporal energy patterns, amplitude variance, and subcarrier power spread. In some embodiments, the characteristics include the statistical and geometric organization of the latent signal representation vectors that describe the structure of the encoded data in message representation 212.

In some embodiments, a UE device (e.g., UE device 202) uses a neural transmitter/neural encoder (e.g., transmitter 206) to map input data to a latent signal representation (e.g., message representation 212 that traverses channel 210). Base station 209 uses receiver model selector 214 to map the received latent signal representation to a neural receiver model, which can be one of receivers 216 through 218. Base station 209 then applies the selected neural receiver model to recover the data encoded by the neural transmitter model and impaired by the wireless channel.

In at least one embodiment, at least one feature described in connection with FIG. 2 is implemented using at least one feature of any system(s) and/or process(es) depicted in and/or described in connection with other figures in this disclosure. In at least one embodiment, at least one feature described in connection with FIG. 2 is used to implement at least a portion of any system(s) and/or process(es) depicted in and/or described with respect to the other figures in this disclosure.

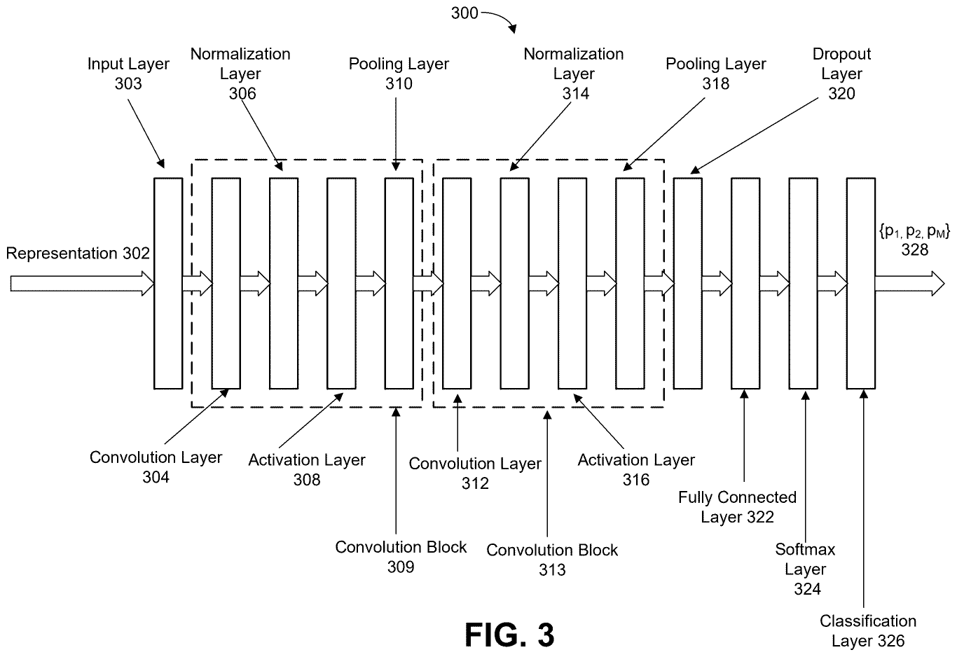

FIG. 3 illustrates an example receiver model selector 300, in accordance with at least one embodiment. The example receiver model selector 300 corresponds to receiver model selector 126 as described in connection with FIG. 1B, and receiver model selector 214 as described in connection with FIG. 2.

Receiver model selector 300 receives, as input, a representation 302, at an input layer 303. In some embodiments, representation 302 is a latent signal representation that corresponds to the output of a neural encoder associated with a transmitter. Representation 302 may have been transmitted over a wireless channel and may include distortions resulting from channel effects such as fading, interference, and noise.

Representation 302 is subsequently processed by a first convolution block 309, which comprises a sequence of a convolution layer 304, a normalization layer 306, an activation layer 308, and a pooling layer 310. Convolution layer 304 applies convolutional filters to extract spatial or temporal features from representation 302. Normalization layer 306 standardizes activations to accelerate training and improve stability. Activation layer 308 applies a non-linear transformation, such as a ReLU or GELU function, and pooling layer 310 reduces the dimensionality of the feature map while preserving salient features.

The output of the first convolution block 309 is processed by a second convolution block 313, which includes a convolution layer 312, a normalization layer 314, an activation layer 316, and a pooling layer 318. This second convolution block 313 further refines the feature representation by learning deeper or higher-level abstractions.

Following the convolutional processing, the output is provided to a dropout layer 320, which is configured to randomly deactivate a subset of activation units, e.g., individual scalar values within the output tensor. This deactivation helps prevent overfitting and enhances the generalization capability of the receiver model selector 300.

The result is then fed into a fully connected layer 322, which maps the pooled features to a vector of class logits. These logits are processed by a softmax layer 324 to produce a probability distribution over M possible neural receiver models. An output classification layer 326 generates the final M-dimensional vector 328, denoted as {P₁, P₂, P_{M}}, where each element represents the probability that the corresponding neural receiver model should be selected to decode the received latent signal representation.

In at least one embodiment, at least one feature described in connection with FIG. 3 is implemented using at least one feature of any system(s) and/or process(es) depicted in and/or described in connection with other figures in this disclosure. In at least one embodiment, at least one feature described in connection with FIG. 3 is used to implement at least a portion of any system(s) and/or process(es) depicted in and/or described with respect to the other figures in this disclosure.

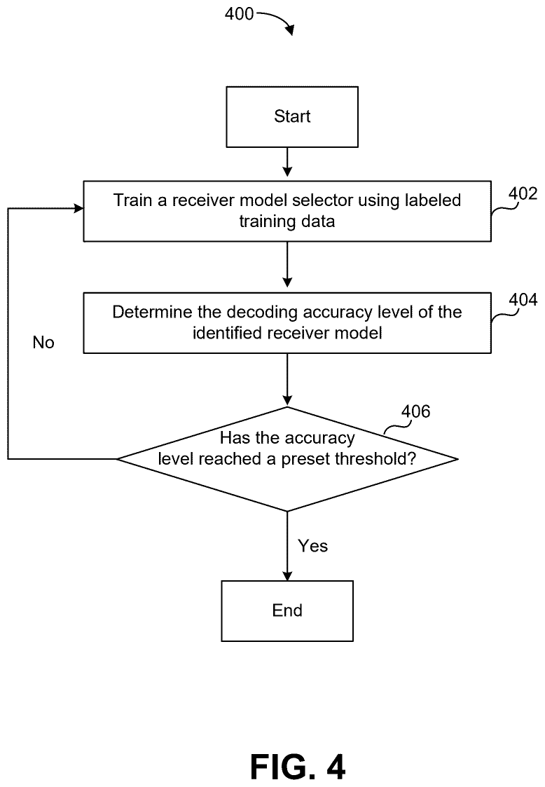

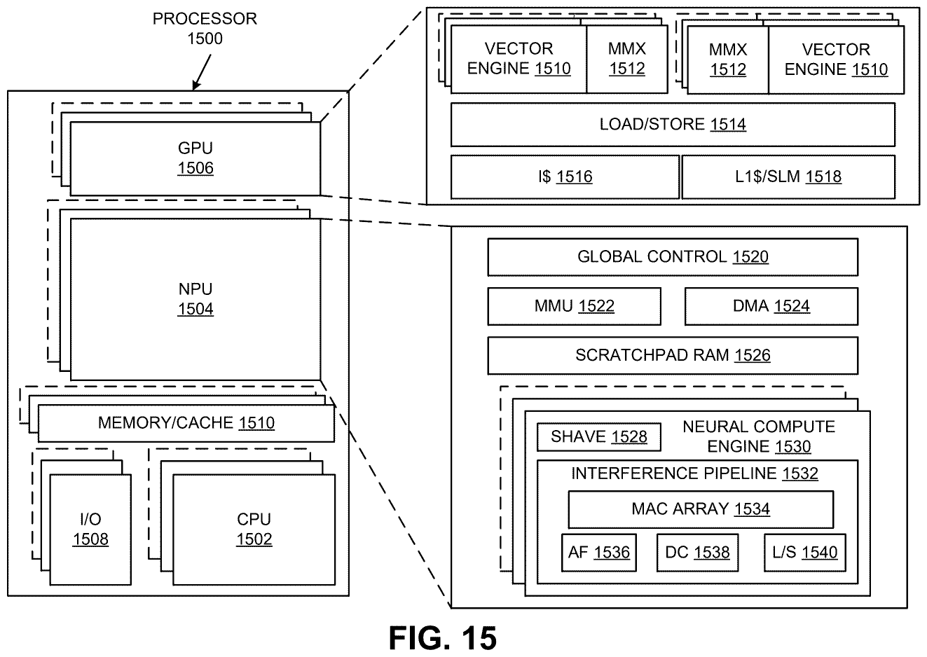

FIG. 4 is a block diagram illustrating a process 400 of training a receiver model selector to select a decoder to decode a message representation from an encoder, in accordance with at least one embodiment. The receiver model selector to be trained can correspond to receiver model selector 126 as described in connection with FIG. 1B, and receiver model selector 214 as described in connection with FIG. 2. Process 400 can be executed or otherwise performed by one or more processors, such as processor 1500 as described in connection with FIG. 15. The one or more processors may be located at a network node, such as a base station or a server, that is configured to train one or more neural models.

Different types of training can be used to train the receiver model selector. Supervised learning can be applied by training the receiver model selector network on labeled datasets. In some embodiments, latent signal representations generated by neural encoders can be provided by vendors, such as Qualcomm or MediaTek, when these vendors release these neural encoders. During offline interoperability testing, a base station developer (e.g., developers at Ericsson) develops decoders corresponding to each neural encoder. These encoder-decoder pairs provide labeled training data (e.g., known latent representations from encoders with corresponding decoder labels), allowing supervised learning of the receiver model selector.

In some embodiments, after deployment, the receiver model selector can periodically test the latent signal representations on all available decoders to evaluate which one yields the best message reconstruction performance to fine-tune and/or update the receiver model selector. Reinforcement learning can further refine the receiver model selector by rewarding it for correctly selecting a matching decoder based on a latent representation generated by an encoder. Transfer learning can also be utilized, where a pre-trained model on a related task is fine-tuned using domain-specific training data to improve efficiency and reduce training time.

At block 402, one or more processors can train the receiver model selector using labeled training data comprising latent signal representations generated by neural encoders. For example, each latent signal representation is associated with a label identifying the correct or optimal neural receiver model (decoder) for decoding that representation. The labeled training data may be obtained through various mechanisms. In one embodiment, the data is generated during offline interoperability testing, wherein base station vendors (e.g., Ericsson) obtain latent representations from neural encoders provided by device vendors (e.g., Qualcomm, MediaTek) and develop corresponding neural receiver models for each encoder. In another embodiment, vendors may share input-output pairs of encoder bitstreams and their resulting latent representations, without disclosing the internal architecture of the encoder itself. The receiver model selector is trained using this data to learn patterns that distinguish encoder-specific latent representations—even when distorted by wireless channel effects—so as to accurately classify and select the appropriate decoder model. In yet another embodiment, training data is collected in deployment settings by periodically evaluating each latent representation across multiple candidate decoders, identifying the decoder with the best reconstruction accuracy, and using this decoder as a pseudo-label to further fine-tune or update the receiver model selector.

The receiver model selector and the neural receiver models may be trained separately or jointly. In some embodiments, in joint training, the neural receiver model and the neural receiver model selector are treated as a unified learning system. During training, the receiver model selector receives latent signal representations and identifiers of the correct neural receiver models, while the selected receiver model receives the same latent signal representation and ground-truth data from which the latent signal representation was generated.

The learning system is optimized end-to-end using a composite loss function that fuses information reconstruction loss (e.g., mean square error or bit error rate) and receiver model selection loss. The information reconstruction loss measures the fidelity of the decoded output against the original transmitted data, and the model selection loss (e.g., cross-entropy or KL divergence) measures the accuracy with which the model selector assigns probabilities to candidate receiver models. This joint training allows the receiver model selector and the receiver to co-evolve: as the selector becomes more precise in choosing the optimal decoder, the decoder concurrently becomes more robust in reconstructing the transmitted data. This interdependence enables tight alignment between model selection dynamics and decoding performance, which is useful for volatile or rapidly changing channel conditions.

In separate training, the one or more processors train the neural receiver model exclusively using the information reconstruction loss, optimizing its parameters to enhance decoding accuracy under varying channel impairments, while the receiver model selector is trained independently using the model selection loss, focusing on classifying which receiver model is best suited to process a given signal. This modular training scheme allows for isolated updates—the receiver model can be enhanced without retraining the selector, and vice versa. In some embodiments, during training, the receiver model selector receives latent signal representations and identifiers of the correct neural receiver models, while the selected receiver model receives the same latent signal representation and ground-truth data from which the latent signal representation was generated. In some embodiments, during separate training, for each latent signal representation, the one or more processors train the selected receiver model only. In some other embodiments, during separate training, for each latent signal representation, the one or more processors train all receiver models that may be selected.

At block 404, one or more processors can determine the decoding accuracy level of the identified receiver model. This may include applying the selected decoder to the message representation, reconstructing the original message, and comparing it to the known ground truth message. In some embodiments, the decoding accuracy is quantified using metrics such as bit error rate (BER), symbol error rate (SER), or reconstruction loss (e.g., mean squared error or categorical cross-entropy). The result reflects how effectively the selected model decodes the given representation.

At block 406, one or more processors can evaluate whether the accuracy level has reached a preset threshold. The threshold may correspond to a target decoding performance (e.g., a BER below 10⁻³ or a reconstruction loss below a certain tolerance) considered acceptable for training purposes. If the accuracy level falls below the threshold, the process returns to block 402 to continue evaluating additional representations or iteratively adjusting model weights. If the threshold is met, the process may end, indicating that the selector is sufficiently trained or that the selected receiver model is appropriately matched for the given representation.

In some embodiments, if the selector repeatedly fails to meet the threshold, the training process may trigger a fine-tuning phase involving backpropagation to update the selector's weights using the observed decoding performance as a supervision signal. This facilitates continual learning in dynamic or multi-vendor environments where latent signal characteristics may shift over time.

In at least one embodiment, at least one feature described in connection with FIG. 4 is implemented using at least one feature of any system(s) and/or process(es) depicted in and/or described in connection with other figures in this disclosure. In at least one embodiment, at least one feature described in connection with FIG. 4 is used to implement at least a portion of any system(s) and/or process(es) depicted in and/or described with respect to the other figures in this disclosure.

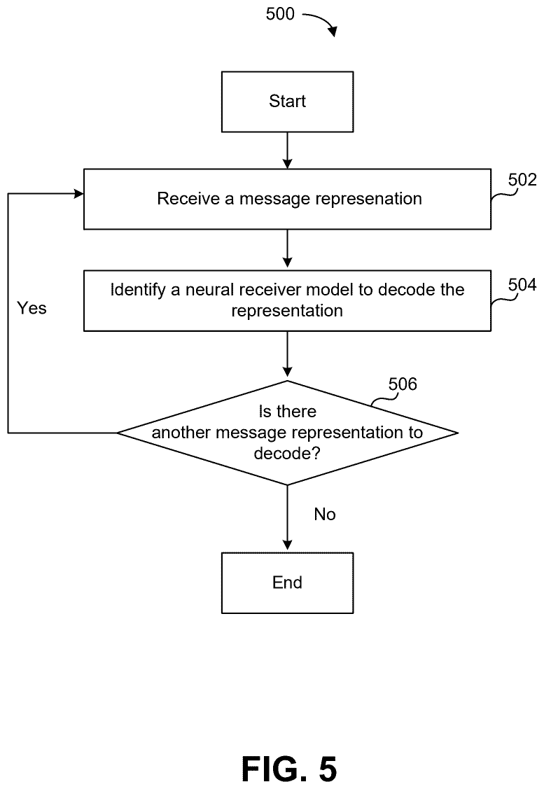

FIG. 5 is a flow diagram illustrating a process 500 of selecting a neural receiver model using a receiver model selector during message decoding, in accordance with one or more embodiments. Process 500 may be executed or otherwise performed by one or more processors, such as processor 1500 as described in connection with FIG. 15. The one or more processors may be located at a network node, such as a base station or an edge server, configured to receive latent signal representations and select appropriate neural receiver models.

At block 502, one or more processors can receive a message representation. In some embodiments, the message representation is a latent signal representation received from a UE device, which may have been encoded by a neural transmitter and transmitted through a wireless channel. The received latent signal representation may contain distortions resulting from transmission effects such as multipath fading, noise, or interference.

At block 504, one or more processors can use a receiver model selector to identify a neural receiver model to decode the message representation. In some embodiments, the receiver model selector outputs a M-dimensional vector [p₁, p₂, . . . , pₘ], where m denotes the number of neural receiver models and pₘ denotes the probability of the neural receiver model m being the target candidate. In some embodiments, the receiver model selector uses the categorical cross-entropy as the classification loss. Specifically, for example, qₘ denotes the actual label from the one-hot encoded target vector, e.g., qₘ is 1 if the neural receiver model m is the target and is 0 if the neural receiver model m is not the target. Accordingly, the categorical cross-entropy is given by

$$- \frac{1}{N} {\sum }_{n = 1}^{N} {\sum }_{m = 1}^{M} {q}_{m} [ n ] \cdot log {p}_{m} [ n ] ,$$

where n is the sample index.

At block 506, one or more processors can determine whether there is another message representation to decode. If there is another message representation, process 500 returns to block 502 to process the message representation. Otherwise, process 500 terminates.

In at least one embodiment, at least one feature described in connection with FIG. 5 is implemented using at least one feature of any system(s) and/or process(es) depicted in and/or described in connection with other figures in this disclosure. In at least one embodiment, at least one feature described in connection with FIG. 5 is used to implement at least a portion of any system(s) and/or process(es) depicted in and/or described with respect to the other figures in this disclosure.

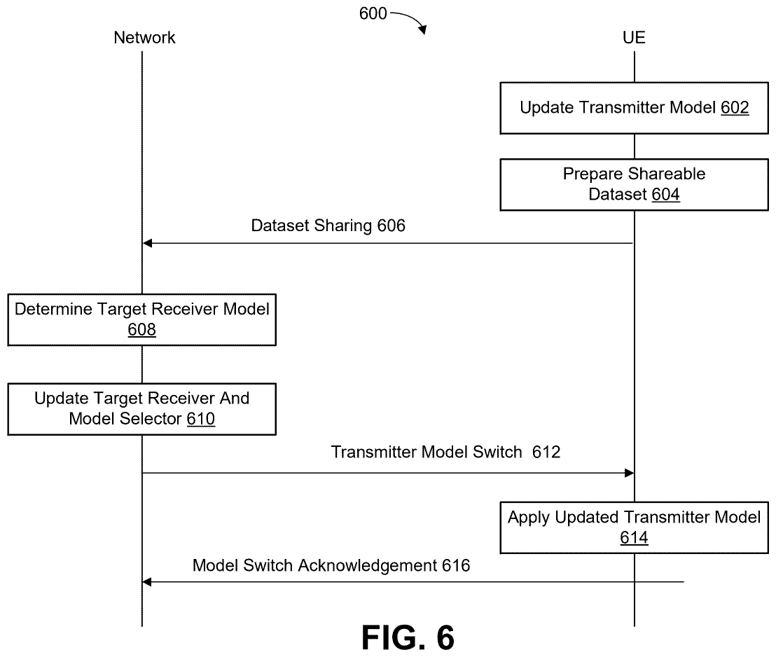

FIG. 6 illustrates a sequence diagram 600 for updating a receiver model selector and a corresponding receiver using a shared dataset, in accordance with at least one embodiment. Sequence diagram 600 illustrates a use case in which a transmitter/encoder vendor (e.g., Qualcomm) prefers not to share their neural encoder models with other vendors responsible for building neural decoders. Instead of disclosing the encoder itself, the transmitter/encoder vendor provides only input data (e.g., messages to be transferred) and corresponding output data (e.g., latent signal representations). Decoder vendors can then use this shared output data to update their neural decoders as well as their receiver model selectors, enabling compatibility without access to the proprietary encoder designs.

At 602, a UE device can update its neural transmitter model. In some embodiments, the UE device may use a UE-side neural receiver model to assist in this process. The UE-side receiver model, in this context, is not used for inference but rather serves as a co-training component to support joint training of the updated neural transmitter/encoder model. For example, a neural encoder vendor may update transmitter model in a UE device without sharing the design of the transmitter/encoder model.

At block 604, the UE device can generate a dataset consisting of pairs of latent signal representations produced by the updated neural transmitter (e.g., the encoded messages) and their corresponding ground-truth input data. The UE device can execute the updated neural transmitter model to process a predefined set of input messages, generating corresponding latent signal representations. Each input message may include structured application-layer data, such as textual strings, media packets, or control instructions. These latent signal representations preserve the statistical and geometric encoding features shaped by the updated neural transmitter's training. The UE device then compiles a dataset comprising the original input messages and their associated latent outputs, forming supervised pairs that can be used downstream for receiver model retraining. This dataset encapsulates both the encoding behavior of the new model and how it compresses or reshapes data before over-the-air transmission.

At 606, the UE device shares the dataset with a network node, such as base station or an edge server, where a receiver model selector and receiver models are located. The UE device can transmit the generated dataset to a network node, such as base station or an edge server, where the neural receiver models and the receiver model selector are maintained. The transmission may occur over a dedicated control channel, encrypted for confidentiality and authenticated to ensure dataset integrity. Upon receipt, the network node parses and stores the dataset for training the or fine-tuning the receiver model selector and the receiver models.

At 608, the network node uses the receiver model selector (e.g., receiver model selector 214 as described in connection with FIG. 2) to determine a target neural receiver model to be used for the corresponding transmitter/encoder model. In some embodiments, the one or more processors cause a neural receiver model most recently used in communication with the same neural transmitter model on the UE side to be selected. This approach relies on temporal continuity, assuming the transmitter model has not changed. In some embodiments, the one or more processors cause a neural receiver model to be selected based on a probability vector generated by the receiver model selector. The probability vectors include elements that each denote the probability that a neural receiver model is optimal for decoding the latent signal representation. The one or more processors selects the neural receiver model corresponding to the highest probability value in the output probability vector. In some embodiments, the one or more processors provide the latent signal representation as input to each of the available neural receiver models, and evaluate the decoding performance of each model by comparing its output to the target data that may be received from a UE device. The comparison may use error metrics such as mean squared error (MSE) or bit error rate (BER). The model yielding the lowest error is selected as the target neural receiver model.

At 610, the network node proceeds to update the target neural receiver model as well as the neural receiver model selector by using the received dataset to fine-tune or retrain the neural receiver model and the neural receiver model selector for improved alignment with the updated UE-side transmitter model. The network node can train the selected neural receiver model and the receiver model selector separately or jointly.

At 612, the network node initiates a transmitter model switch command directed to the UE device, instructing it to activate the updated neural transmitter model that was previously trained. This switch command informs the UE device that its updated neural transmitter model is now recognized and a corresponding neural receiver/decoder has been updated on the network node. The message may include a unique model identifier or checksum that the UE device can use to validate synchronization.

At 614, the UE device applies the updated transmitter model in response to the switch command. Up receiving the switch command, the UE device activates the updated neural transmitter model for subsequent message encoding tasks. The transition from the previous transmitter model to the updated one may involve reinitializing internal state buffers, reloading neural weights, or reconfiguring signal processing pipelines. At 616, the UE device sends a model switch acknowledgement to the network node, confirming successful deployment of the new transmitter model and thereby synchronizing model states between the UE and the network. This acknowledgment may include diagnostic or status data, such as model version identifiers, initialization status, and available compute capacity on the UE device to support model operation. It serves as the final synchronization step, allowing the network to update logs, trigger downstream processes, or enable monitoring pipelines for the new encoder-decoder pair. In some embodiments, this acknowledgment also includes a confirmation timestamp to aid in auditing, diagnostics, or subsequent model lifecycle management.

This coordinated update procedure facilitates mutual adaptation between the neural transmitter, the target neural receiver model, and the receiver model selector, enhancing communication robustness under dynamic channel conditions and evolving model architectures.

In at least one embodiment, at least one feature described in connection with FIG. 6 is implemented using at least one feature of any system(s) and/or process(es) depicted in and/or described in connection with other figures in this disclosure. In at least one embodiment, at least one feature described in connection with FIG. 6 is used to implement at least a portion of any system(s) and/or process(es) depicted in and/or described with respect to the other figures in this disclosure.

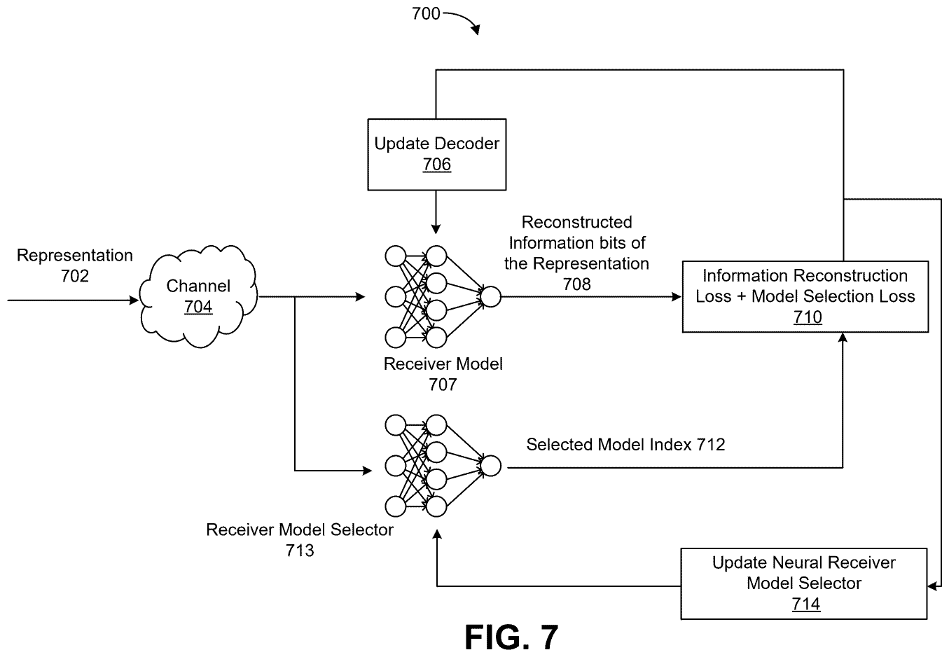

FIG. 7 illustrates an example system 700 for jointly updating a neural receiver model (e.g., decoder) and a neural receiver model selector based on a latent signal representation, in accordance with at least one embodiment. As shown, a representation 702 is transmitted through a channel 704, which may impair the signal due to transmission effects such as fading, noise, interference, or non-linearity. System 700 includes a receiver model 707 and a receiver model selector 713. Receiver model 707 is a neural decoder, similar to receiver/decoder 122 as described in connection with FIG. 1B. Receiver model selector 713 is similar to receiver model selector 126 as described in connection with FIG. 1B. Channel 704 is similar to channel 125 as described in connection with FIG. 1B.

Receiver model 707 receives representation 702, which is a latent signal representation of a message and outputs reconstructed information bits 708. The output is compared against ground-truth data to compute an information reconstruction loss, which may be implemented using various loss metrics such as mean squared error or bit error rate. Simultaneously, receiver model selector 713 receives the same latent signal representation and outputs a selected model index 712, indicating which neural receiver model is most appropriate for decoding. A neural receiver model selection loss is computed by comparing this prediction against a one-hot encoded ground-truth label.

In some embodiments, system 700 calculates the neural receiver model selection loss as cross entropy loss using −Σᵢ qᵢ log(pᵢ), where qᵢ and pᵢ are the ground truth and the neural network score for each model i. In some embodiments, system 700 calculates the neural receiver model selection loss as cross entropy loss using −Σᵢ qᵢ log(f(p)ᵢ), where

$${f ( p )}_{i} = \frac{exp ( {p}_{i} )}{{\sum }_{j} exp ( {p}_{j} )} ,$$

qᵢ and pᵢ are the ground truth and the neural network score for each model i. In some embodiments, system 700 calculates neural receiver model selection loss as Kullback-Leibler divergence loss using

$$- {\sum }_{i} {q}_{i} log ( \frac{{q}_{i}}{{p}_{i}} ) ,$$

where qᵢ and pᵢ are the ground truth and the neural network score for each model i.

System 700 combines the information reconstruction loss and the model selection loss at block 710 to compute a joint loss function. This combined loss is used to simultaneously update the neural receiver model at block 706 and the neural receiver model selector at block 714, thereby improving both modules in tandem.

In at least one embodiment, at least one feature described in connection with FIG. 7 is implemented using at least one feature of any system(s) and/or process(es) depicted in and/or described in connection with other figures in this disclosure. In at least one embodiment, at least one feature described in connection with FIG. 7 is used to implement at least a portion of any system(s) and/or process(es) depicted in and/or described with respect to the other figures in this disclosure.

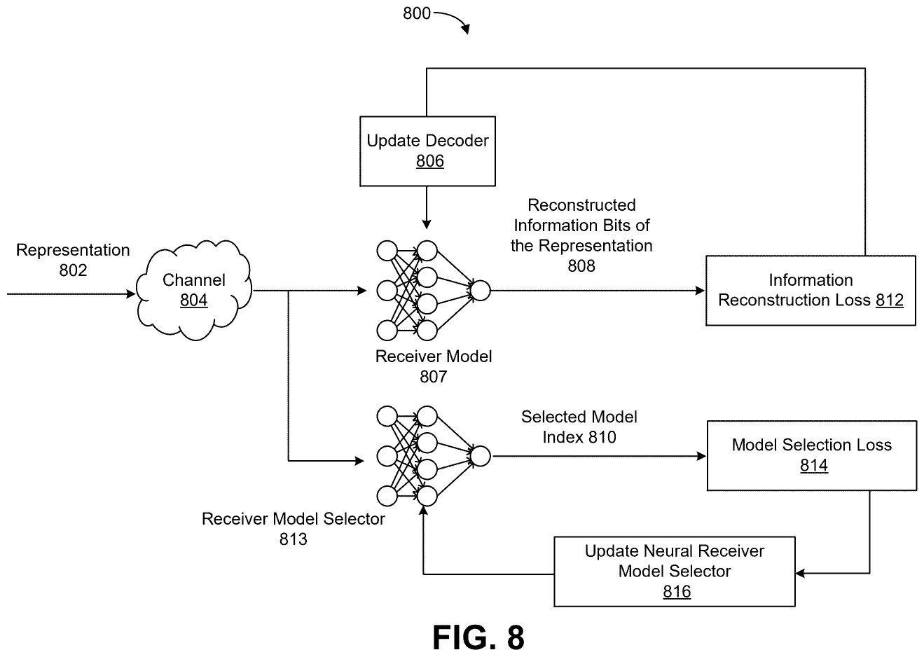

FIG. 8 illustrates an example system 800 for independently updating a receiver model and a receiver model selector, in accordance with at least one embodiment. As shown, a representation 802 is transmitted over a channel 804, which may introduce impairments such as fading, noise, interference, or non-linearity, resulting in a distorted latent signal representation. Representation 802 corresponds to representation 702 described in connection with FIG. 7, and channel 804 corresponds to channel 704 as described in connection with FIG. 7.

A receiver model 807 and a receiver model selector 813 operate in parallel. Receiver model 807 and receiver model selector 813 correspond to receiver model 707 and receiver model selector 713 as described in connection with FIG. 7, respectively.

Receiver model 807 reconstructs the original information and outputs reconstructed information bits 808. This output is compared against ground-truth data to compute an information reconstruction loss 812. The reconstruction loss may be based on a metric such as mean squared error or bit error rate. System 800 updates receiver model 807 at block 806 using this information reconstruction loss 812 alone, as opposed to a joint loss as described in connection with FIG. 7.

Simultaneously, receiver model selector 813 outputs a selected model index 810 indicating a predicted receiver model most appropriate for decoding representation 802. This prediction is compared against the true model label to compute a model selection loss 814. The loss may be computed using methods such as cross-entropy loss or Kullback-Leibler divergence, as described previously in connection with FIG. 7. The selector is updated independently at block 816 based solely on the model selection loss.

In this embodiment, the information reconstruction loss and neural receiver model selection loss are computed separately, and the respective modules are updated using their corresponding losses.

In at least one embodiment, at least one feature described in connection with FIG. 8 is implemented using at least one feature of any system(s) and/or process(es) depicted in and/or described in connection with other figures in this disclosure. In at least one embodiment, at least one feature described in connection with FIG. 8 is used to implement at least a portion of any system(s) and/or process(es) depicted in and/or described with respect to the other figures in this disclosure.

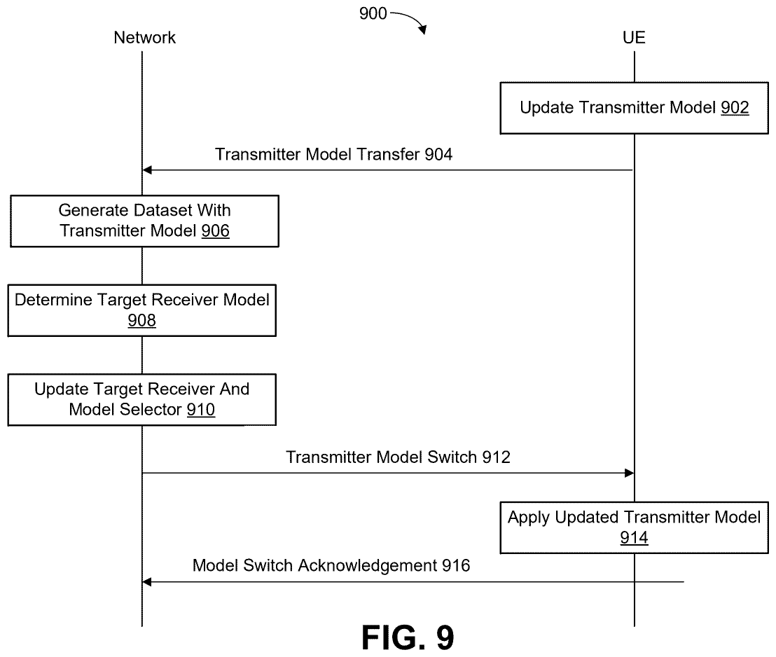

FIG. 9 illustrates a sequence diagram 900 for updating a receiver model and a receiver model selector using a transferred transmitter model, in accordance with at least one embodiment. Sequence diagram 900 illustrates a use case in which a transmitter vendor (e.g., Qualcomm) provides an updated transmitter/encoder to a receiver/decoder vendor, as opposed to the use case illustrated in FIG. 6, where the encoder vendor provides only input data (e.g., messages to be transferred) and corresponding output data (e.g., latent signal representations). Sequence diagram 900 is similar to sequence diagram 600 except that the dataset used to determine a target receiver model to update is generated on the network side.

Block 902 corresponds to block 602, where a UE device updates its transmitter model. After the transmitter model is updated, the UE device transfers the updated transmitter model at block 904 to the network side, where the received model is used to generate a dataset, as shown at block 906. The dataset is generated in accordance with the description provided for block 604 of sequence diagram 600.

The remainder of sequence diagram 900 is similar to that of sequence diagram 600. For example, blocks 908, 910, 912, 914, and 916 correspond to blocks 608, 610, 612, 614, and 616 of sequence diagram 600, respectively.

In at least one embodiment, at least one feature described in connection with FIG. 9 is implemented using at least one feature of any system(s) and/or process(es) depicted in and/or described in connection with other figures in this disclosure. In at least one embodiment, at least one feature described in connection with FIG. 9 is used to implement at least a portion of any system(s) and/or process(es) depicted in and/or described with respect to the other figures in this disclosure.

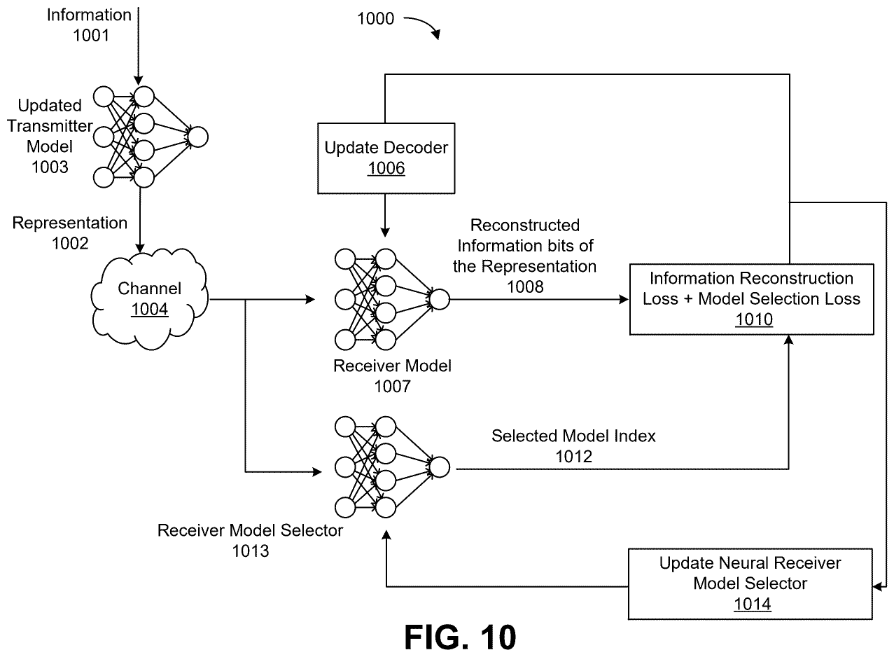

FIG. 10 illustrates an example system 1000 for jointly updating a receiver model and a receiver model selector, in accordance with at least one embodiment. System 1000 is similar to system 700, except that system 1000 directly uses the received updated transmitter model from a transmitter/encoder vendor to generate data during operation for jointly updating neural receiver and model selector, rather than using pre-generated dataset as in system 700.

As shown, information bits 1001 are input into an updated transmitter model 1003, which outputs a representation 1002. This representation is transmitted through a channel 1004, which may introduce distortions such as fading, interference, or noise. The updated transmitter model 1003 is provided by a transmitter/encoder vendor. System 1000 does not update the parameters of the transmitter model 1003 during the process of updating the receiver model and the receiver model selector. Therefore, the transmitter model 1003 is treated as frozen during the process.

The remainder of system 1000 is similar to that of system 700. For example, elements 1002-1014 correspond to elements 702-714 of system 700, respectively.

In at least one embodiment, at least one feature described in connection with FIG. 10 is implemented using at least one feature of any system(s) and/or process(es) depicted in and/or described in connection with other figures in this disclosure. In at least one embodiment, at least one feature described in connection with FIG. 10 is used to implement at least a portion of any system(s) and/or process(es) depicted in and/or described with respect to the other figures in this disclosure.

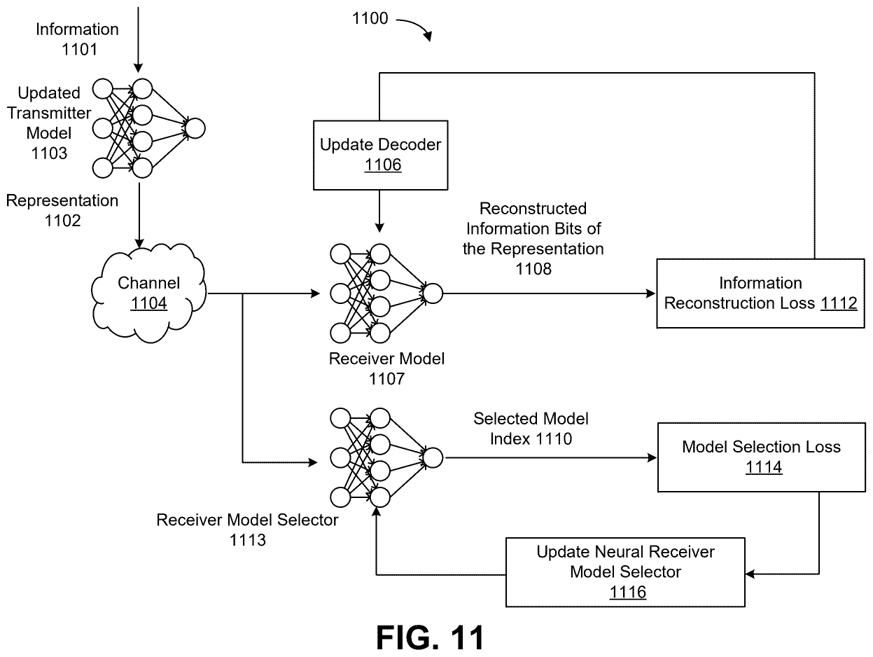

FIG. 11 illustrates an example system 1100 for separately updating a neural receiver model and a receiver model selector, in accordance with at least one embodiment. Similar to system 1000, system 1100 uses randomly generated information bits during operation by an updated transmitter model provided by a transmitter/encoder vendor, rather than using a pre-generated a dataset. As shown, information bits 1101 are input into an updated transmitter model 1103, which outputs a representation 1102. This representation is transmitted through a channel 1104, which may introduce distortions such as fading, interference, or noise. System 1100 does not update the parameters of the transmitter model 1103 during the process of updating the receiver model and the receiver model selector. Therefore, the transmitter model 1103 is treated as frozen during the process.

The remainder of system 1100 is similar to that of system 800. For example, elements 1102-1114 correspond to elements 802-816 of system 800, respectively.

In at least one embodiment, at least one feature described in connection with FIG. 11 is implemented using at least one feature of any system(s) and/or process(es) depicted in and/or described in connection with other figures in this disclosure. In at least one embodiment, at least one feature described in connection with FIG. 11 is used to implement at least a portion of any system(s) and/or process(es) depicted in and/or described with respect to the other figures in this disclosure.

### Data Center

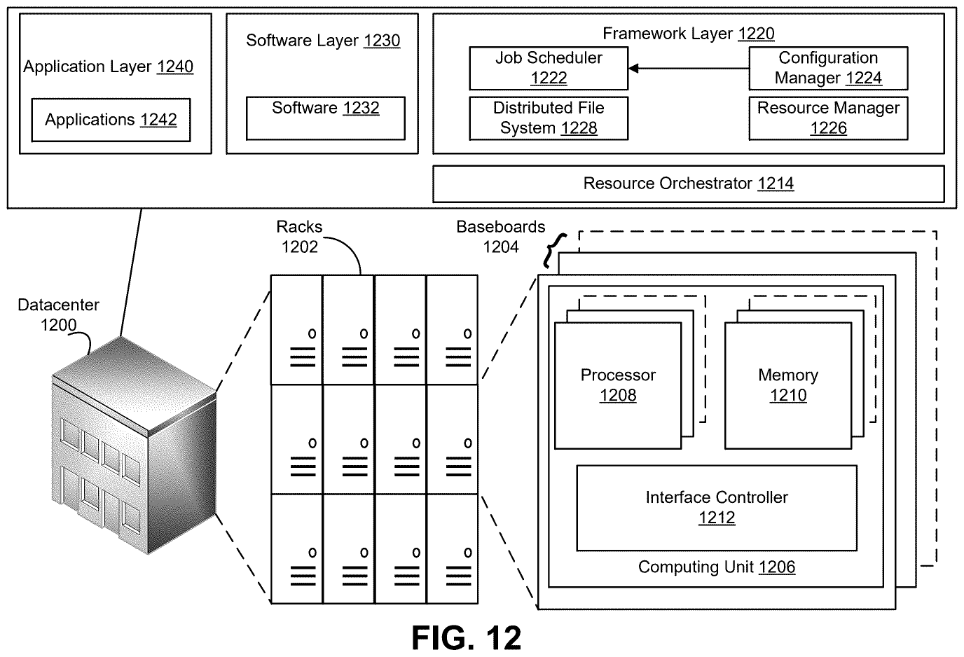

FIG. 12 illustrates an example data center 1200, in accordance with at least one embodiment. Data center 1200 may include one or more rooms having racks 1202 and auxiliary equipment used to house one or more racks 1202 and one or more baseboards 1204. Rack 1202 can include one or more baseboards 1204. Rack 1202 can include a housing that receives and supports individual baseboards 1204. Operational aspects of rack 1202 may be regulated at a rack level, corresponding to a group of baseboards 1204, or at a baseboard level, corresponding to individual baseboards 1204, among other options. Rack 1202 or baseboards 1204 can have particularly selected maximum operating parameters, such as, but not limited to, power consumption, operating frequencies, and others. Data center 1200 can be supported by various cooling systems, such as, but not limited to, cooling towers, cooling loops, pumps, and other support systems. Cooling systems may include sensors and controllers to monitor and managing cooling properties for racks 1202. Baseboards 1204 within racks 1202 can get operational power from one or more power distribution units (PDUs; not shown). PDUs may be arranged within racks 1202, for example between racks 1202 including baseboards 1204, or within racks 1202 that also house baseboards 1204.

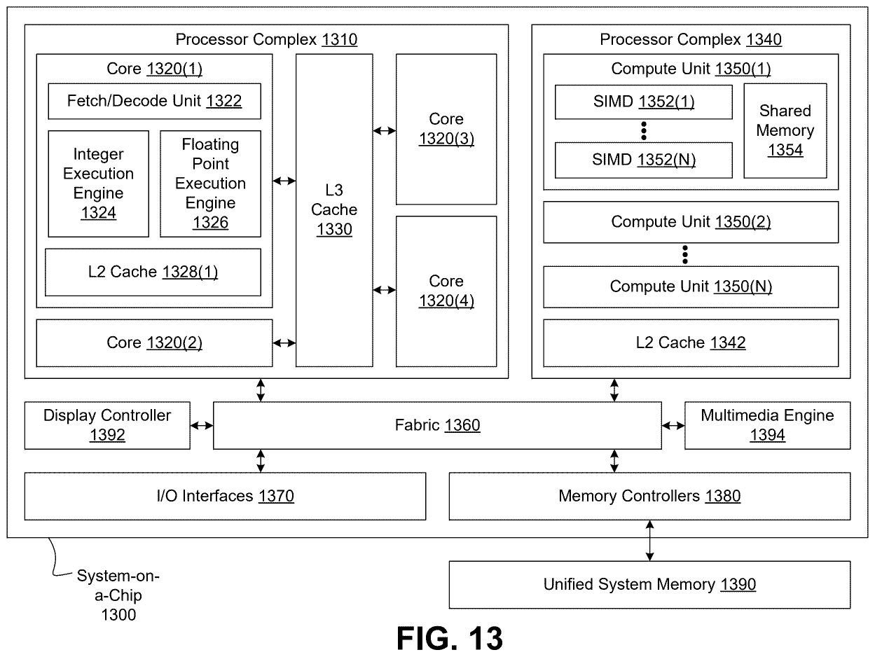

Racks 1202 and baseboards 1204 can include sub-systems, modules, add-in cards, and other semiconductor components. Baseboards 1204 can include one or more computing units 1206 that can include one or more processors 1208, one or more memory 1210, and an interface controller 1212. Computing units 1206 may include any number of processors, such as, but not limited to, central processing units (“CPUs”), graphics processing units (“GPUs”), or other processors (including accelerators, field programmable gate arrays (FPGAs), graphics processors, etc.), including any processors described herein, such as, but not limited to, processors in FIGS. 13-25. Computing units 1206 can include one or more memory storage devices 1210 (e.g., dynamic read-only memory, solid state storage or disk drives), as well as network input/output (“NW I/O”) devices, network switches, virtual machines (“VMs”), power modules, and cooling modules, etc. One or more computing units 1206 may be a server having one or more of above-mentioned computing resources.

Computing units 1206 can include separate groupings of computing units housed within one or more racks (not shown), or many racks housed in data centers at various geographical locations (also not shown). Separate groupings of computing units may include grouped compute, network, memory or storage resources that may be configured or allocated to support one or more workloads. Several computing units (e.g., including CPUs and/or other processors) may be grouped within one or more racks to provide compute resources to support one or more workloads. A resource orchestrator 1214 may configure or otherwise control one or more computing units 1206 or groups of computing units. Resource orchestrator 1214 may include a software design infrastructure (“SDI”) management entity for data center 1200. Resource orchestrator 1214 may include hardware, software or some combination thereof.

Data center 1200 can include any one of or any combination of a framework layer 1220, a software layer 1230 and an application layer 1240. As shown in FIG. 12, framework layer 1220 includes a job scheduler 1222, a configuration manager 1224, a resource manager 1226 and a distributed file system 1228. Framework layer 1220 may include a framework to support software 1232 of software layer 1230 and/or one or more application(s) 1242 of application layer 1240. Software 1232 or application(s) 1242 may respectively include web-based service software or applications, such as, but not limited to, those provided by Amazon Web Services, Google Cloud and Microsoft Azure. Framework layer 1220 may be a type of free and open-source software web application framework such as, but not limited to, Apache Spark™ (hereinafter “Spark”) that may utilize distributed file system 1228 for large-scale data processing (e.g., “big data”). Job scheduler 1222 may include a Spark driver to facilitate scheduling of workloads supported by various layers of data center 1200. Configuration manager 1224 may be capable of configuring different layers such as, but not limited to, software layer 1230 and framework layer 1220 including Spark and distributed file system 1228 for supporting large-scale data processing. Resource manager 1226 may be capable of managing clustered or grouped computing units 1206 mapped to or allocated for support of distributed file system 1228 and job scheduler 1222. Resource manager 1226 may coordinate with resource orchestrator 1214 to manage these mapped or allocated computing resources.

Software 1232 can be included in software layer 1230 and may include software used by at least portions of a computing unit 1206, one or more computing units 1206, groups of computing units 1206, and/or distributed file system 1228 of framework layer 1220. One or more types of software may include, but are not limited to, Internet web page search software, e-mail virus scan software, database software, and streaming video content software.

Application(s) 1242 can be included in application layer 1240 and may include one or more types of applications used by at least portions of a computing unit 1206, one or more computing units 1206, groups of computing units 1206, and/or distributed file system 1228 of framework layer 1220. One or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

Any of configuration manager 1224, resource manager 1226, and resource orchestrator 1214 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

Data center 1200 may include tools, services, software or other resources to train one or more machine learning models or predict or infer information using one or more machine learning models in accordance with one or more embodiments described herein. For example, a machine learning model may be trained by calculating weight parameters in accordance with a neural network architecture using software and computing resources described above with respect to data center 1200. Trained machine learning models corresponding to one or more neural networks may be used to infer or predict information using resources described above with respect to data center 1200 by using weight parameters calculated through one or more training techniques described herein.

Data center 1200 may use CPUs, application-specific integrated circuits (ASICs), GPUs, FPGAs, or other hardware (e.g., embodiments in FIGS. 13-25) to perform some or all of processes and techniques described elsewhere herein, such as, but not limited to, training and/or inferencing using above-described resources. Moreover, one or more software and/or hardware resources described above may be configured as a service to allow users to train or performing inferencing of information, such as, but not limited to, image recognition, speech recognition, or other artificial intelligence services.

In at least one embodiment, processor 1208 can include one of the processors below and/or comprises one or more circuits to use a neural network to select a decoder from a plurality of decoders to decode an encoded representation of information received from an encoder or otherwise perform any of the operations described above or elsewhere herein. In at least one embodiment, processor 1208 is configured by software 1232 to use a neural network to select a decoder from a plurality of decoders to decode an encoded representation of information received from an encoder or otherwise perform any of the operations described above or elsewhere herein. Data center 1200 may use logic, CPUs, application-specific integrated circuits (ASICs), GPUs, FPGAs, or other hardware (e.g., embodiments in FIGS. 13-25) to perform any of the operations described above or elsewhere herein.

### Processors

The following figures set forth, without limitation, example processors and processing systems that can be used to use a neural network to select a decoder from a plurality of decoders to decode an encoded representation of information received from an encoder or otherwise perform some or all of processes, operations and/or and techniques described elsewhere herein. Example processors and processing systems can be configured by software to use a neural network to select a decoder from a plurality of decoders to decode an encoded representation of information received from an encoder or otherwise perform any of the operations described above or elsewhere herein. Processors and processing systems can include logic, central processing units (CPUs), application-specific integrated circuits (ASICs), graphics processing units (GPUs), field programmable arrays (FPGAs), XPUs (e.g., any compute architecture that best fits the need of an application) or other hardware (e.g., embodiments in FIGS. 13-25) to perform any of the operations described above, below, or elsewhere herein. Processors and/or processing systems described herein can include one or more circuits that can be used to use a neural network to select a decoder from a plurality of decoders to decode an encoded representation of information received from an encoder or otherwise perform any of the operations described above or elsewhere herein. As used herein, one or more circuits can be configured by software to use a neural network to select a decoder from a plurality of decoders to decode an encoded representation of information received from an encoder or otherwise perform any of the operations described above or elsewhere herein. FIGS. 30A and 30B illustrate logic 3015 which, as described elsewhere herein, can be used in one or more devices to perform operations such as, but not limited to, those discussed herein in accordance with at least one embodiment. Logic can refer, for example, to any combination of software logic, hardware logic, and/or firmware logic to provide functionality and/or operations described herein, wherein logic may be, collectively or individually, embodied as circuitry that forms part of a larger system, for example, an integrated circuit (IC), an application-specific integrated circuit (ASIC), a field programmable array (FPGA), system-on-chip (SoC), or one or processors (e.g., CPU, GPU).

FIG. 13 illustrates a processor which is a system-on-a-chip (SOC) 1300 (which may be referred to as system-on-chip, a superchip, or another name), in accordance with at least one embodiment. SOC 1300 can include processor complex 1310 and processor complex 1340. SOC 1300 can include any number of processor complexes 1310 and/or processor complexes 1340 that may include any number of processors that are described herein, such as, but not limited to, those in FIGS. 13-25, in any combination. For example, processor 1310 may include a central processing unit (CPU), and processor 1340 may include a graphics processor. Alternatively, processor 1310 may include a graphics processor, and processor 1340 may include a graphics processor. SOC 1300 may include any number of display controllers 1392, any number of multimedia engines 1394, any number of I/O Interfaces 1370, any number of memory controllers 1380, and any number of fabrics 1360 in any combination. For explanatory purposes, multiple instances of like objects are denoted herein with reference numbers identifying the object and parenthetical numbers identifying the instance where needed. SOC 1300 can include a processor from Broadcom in Palo Alto, CA.

Processor complex 1310 can include a CPU, processor complex 1340 can include a GPU, and SOC 1300 can include a processing unit that integrates 1310 and 1340 onto a single chip. Some tasks may be assigned to processor complex 1310 and other tasks may be assigned to processor complex 1340. Processor complex 1310 can be configured to execute main control software associated with SOC 1300, such as, but not limited to, an operating system. Processor complex 1310 can be the master processor of SOC 1300, controlling and coordinating operations of other processors. Processor complex 1310 can issue commands that control the operation of processor complex 1340 to perform some or all of the operations described herein. Processor complex 1310 can be configured to execute host executable code derived from CUDA or other source code (e.g., HIP source code), and processor complex 1340 can be configured to execute device executable code derived from CUDA or other source code in order to perform any of the operations described herein.

Processor complex 1310 can include cores 1320(1)-1320(4) and a cache (e.g., L3 cache) 1330 to store information to perform operations described herein. Processor complex 1310 may include any number of cores 1320 and any number and type of caches in any combination. Cores 1320 can be configured to execute instructions of a particular instruction set architecture (“ISA”) to perform some or all of the operations described herein. Each core 1320 can include a CPU core. Core 1320(1)-1320(4) can be referred to as a computing units or compute units. SOC 1300 can includes any number of processor complexes 1310, fabric 1360, I/O interfaces 1370, and memory controllers 1380.

Each core 1320 can include a fetch/decode unit 1322, an integer execution engine 1324, a floating point execution engine 1326, and an L2 cache 1328. Fetch/decode unit 1322 can fetch instructions to perform some or all of the operations described herein (such as, but not limited to, an API that is compiled into instructions) and decode such instructions, generate micro-operations, and dispatch separate micro-instructions to integer execution engine 1324 and/or floating point execution engine 1326. Fetch/decode unit 1322 can concurrently dispatch one micro-instruction to integer execution engine 1324 and another micro-instruction to floating point execution engine 1326. Integer execution engine 1324 can execute integer and memory operations. Floating point engine 1326 can execute floating point and vector operations. Fetch-decode unit 1322 can dispatch micro-instructions to one or more execution engines that replaces both integer execution engine 1324 and floating point execution engine 1326.

Each core 1320(i), where i is an integer representing a particular instance of core 1320, may access L2 cache 1328(i) included in core 1320(i). Each core 1320 included in core complex 1310(j), where j is an integer representing a particular instance of core complex 1310, can be connected to other cores 1320 included in core complex 1310(j) via L3 cache 1330(j) included in core complex 1310(j). Cores 1320 included in core complex 1310(j), where j is an integer representing a particular instance of core complex 1310, can access all of L3 cache 1330(j) included in core complex 1310(j). L3 cache 1330 may include any number of slices.

Processor complex 1340 can be a graphics complex that can be configured to perform compute operations (e.g., compute operations involved in operations described herein) in a highly-parallel fashion. Processor complex 1340 can be configured to execute graphics pipeline operations such as, but not limited to, draw commands, pixel operations, geometric computations, and other operations associated with rendering an image to a display. Processor complex 1340 can be configured to execute operations unrelated to graphics, such as, but not limited to, neural network training and/or simulations. Processor complex 1340 can be configured to execute both operations related to graphics and operations unrelated to graphics.

Processor complex 1340 can include any number of compute units 1350(1)-1350(N), where N is any integer greater than 1, and an L2 cache 1342. Compute units 1350 can share L2 cache 1342, which may store information to be used to perform some or all of the operations described herein. L2 cache 1342 can be partitioned. Processor complex 1340 can include any number of compute units 1350 and any number (including zero) and type of caches. Processor complex 1340 can include any amount of dedicated graphics hardware.

Each compute unit 1350 can include any number of SIMD units 1352(1)-1352(N), where N is any integer greater than 1, and a shared memory 1354. Each SIMD unit 1352 can implement a SIMD architecture and can be configured to some or all of the operations described herein, in parallel. Each compute unit 1350 may execute any number of thread blocks, but each thread block can execute on a single compute unit 1350, although in some embodiments a thread block can execute on multiple compute units. A thread block can include any number of threads of execution. A workgroup can be a thread block. Each SIMD unit 1352 can execute a group of threads. A group of threads (e.g., 16 threads), which can also be referred to as a warp, or subgroup, or wavefront (e.g., as used by AMD and Intel), where each thread in the warp, wave, subgroup, or wavefront can belong to a single thread block and is configured to process a different set of data based on a single set of instructions. Predication can be used to disable one or more threads in a warp, subgroup, or wavefront. A lane can be a thread. A work item can be a thread, such as, but not limited to, e.g., with OpenCL. Different warps, subgroups, or wavefronts in a thread block may synchronize together and communicate via shared memory 1354. Each compute unit 1350 can include one or more thread block clusters, where a thread block cluster can enable programmatic control of locality at a granularity larger than a single thread block of a single streaming multiprocessor (SM). Thread block clusters (also referred to as “clusters”) can enable multiple thread blocks running concurrently across streaming multiprocessors to synchronize and collaboratively fetch, exchange, or otherwise use data. In at least one embodiment, streaming multiprocessors (“SMs”) can be referred to streaming microprocessors, stream processors (“SPs”), stream processing units (“SPUs”), compute units (“CUs”), execution units (“EUs”), and/or slices, where a slice in this context can refer to a portion of processing resources in a processing unit (e.g., 16 cores, a ray tracing unit, a thread director or scheduler).

Fabric 1360 can be a system interconnect that facilitates data and control transmissions across processor complex 1310, processor complex 1340, I/O interfaces 1370, memory controllers 1380, display controller 1392, and multimedia engine 1394, e.g., to perform some or all of the operations described herein. SOC 1300 may include any amount and type of system interconnect in addition to or instead of fabric 1360 that facilitates data and control transmissions across any number and type of directly or indirectly linked components that may be internal or external to SOC 1300. I/O interfaces 1370 can be representative of any number and type of I/O interfaces (e.g., PCI, PCI-Extended (“PCI-X”), PCIe, gigabit Ethernet (“GBE”), USB, etc.). Various types of peripheral devices can be coupled to I/O interfaces 1370. Peripheral devices that can be coupled to I/O interfaces 1370 may include keyboards, mice, printers, scanners, joysticks or other types of game controllers, media recording devices, external storage devices, network interface cards, and so forth.

Display controller 1392 may display images on one or more display device(s), such as, but not limited to, a liquid crystal display (“LCD”) device. Multimedia engine 1394 can include any amount and type of circuitry that is related to multimedia, such as, but not limited to, a video decoder, a video encoder, an image signal processor, etc. Memory controllers 1380 may facilitate data transfers between SOC 1300 and a unified system memory 1390. Processor complex 1310 and processor complex 1340 may share unified system memory 1390. Unified system memory 1390 can include various types of memory devices, including dynamic random access memory (DRAM) or graphics random access memory, such as, but not limited to, synchronous graphics random access memory (SGRAM), including graphics double data rate (GDDR) memory. Unified system memory 1390 may include 3D stacked memory, including but not limited to high bandwidth memory (HBM), HBM2e, or HDM3.

SOC 1300 may implement a memory subsystem that includes any amount and type of memory controllers 1380 and memory devices (e.g., shared memory 1354) that may be dedicated to one component or shared among multiple components in order to perform any of the operations described herein. SOC 1300 can implement a cache subsystem that includes one or more cache memories (e.g., L2 caches 1328, L3 cache 1330, and L2 cache 1342) that may each be private to or shared between any number of components (e.g., cores 1320, core complex 1310, SIMD units 1352, compute units 1350, and processor complex 1340).

In at least one embodiment, SOC 1300 can include one or more circuits to use a neural network to select a decoder from a plurality of decoders to decode an encoded representation of information received from an encoder or otherwise perform any of the operations described above or elsewhere herein. One or more circuits can be configured by software to use a neural network to select a decoder from a plurality of decoders to decode an encoded representation of information received from an encoder or otherwise perform any of the operations described above or elsewhere herein.

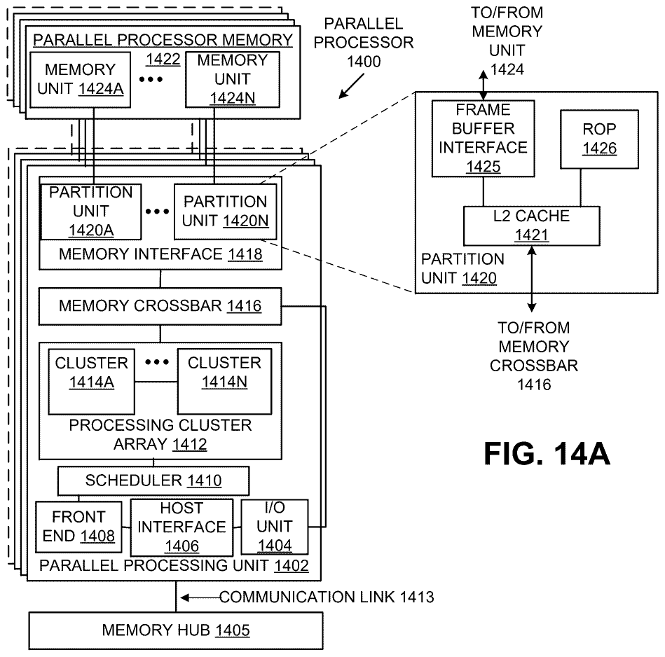

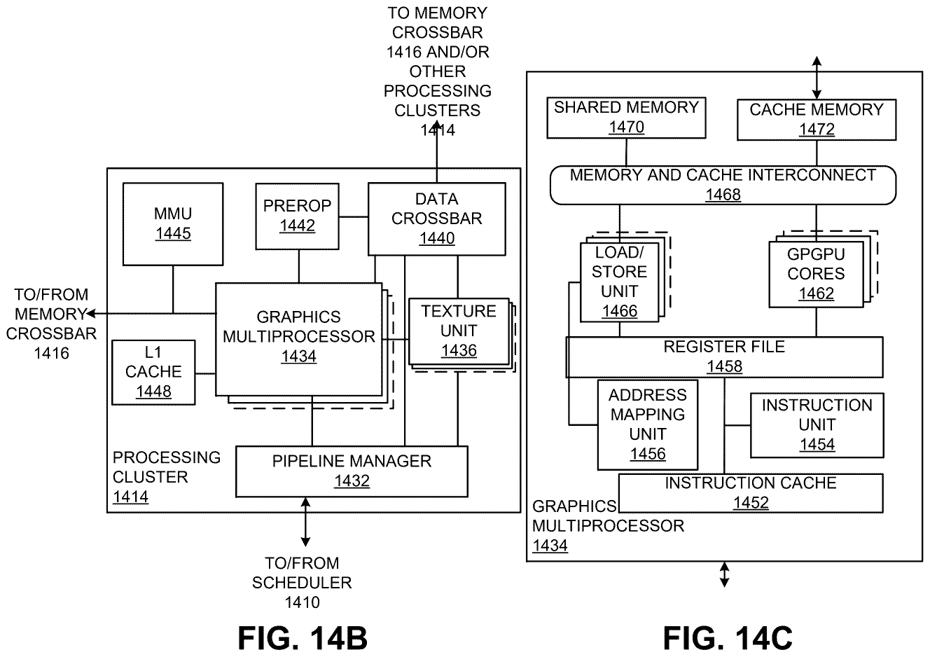

FIG. 14A illustrates a parallel processor 1400, in accordance with at least one embodiment. Parallel processor 1400 may be implemented using one or more circuits and may be referred to as a programmable processor (e.g., a CPU and/or GPU), logic, an application specific integrated circuit (ASIC), a field programmable gate array (FPGA) or other hardware (e.g., embodiments in FIGS. 13-25) to perform any of the operations described above or elsewhere herein.

Parallel processor 1400 can include a parallel processing unit 1402 to perform any of the operations described above or elsewhere herein. Parallel processing unit 1402 can include an I/O unit 1404 that enables communication with other devices, including other instances of parallel processing unit 1402. I/O unit 1404 may be directly connected to other devices. I/O unit 1404 may connect with other devices via use of a hub or switch interface, such as, but not limited to, a memory hub 1405. Connections between memory hub 1405 and I/O unit 1404 can form a communication link 1413. I/O unit 1404 may connect with a host interface 1406 and a memory crossbar 1416, where host interface 1406 receives commands directed to performing processing operations and memory crossbar 1416 receives commands directed to performing memory operations.

When host interface 1406 receives a command buffer via I/O unit 1404, host interface 1406 can direct work operations to perform those commands to a front end 1408. Front end 1408 can couple with a scheduler 1410 (which may be referred to as a sequencer), which is configured to distribute commands or other work items to a processing cluster array 1412. Scheduler 1410 can ensure that processing cluster array 1412 is properly configured and in a valid state before tasks may be distributed to a cluster of processing cluster array 1412. Scheduler 1410 may be implemented via firmware logic executing on a microcontroller. Microcontroller-implemented scheduler 1410 can be configurable to perform complex scheduling and work distribution operations at coarse and fine granularity, enabling rapid preemption and context switching of threads executing on processing array 1412. Host software can prove workloads for scheduling on processing cluster array 1412 via one of multiple graphics processing paths. Workloads can then be automatically distributed across processing array cluster 1412 by scheduler 1410 logic within a microcontroller including scheduler 1410.

Processing cluster array 1412 can perform any of the operations described above or elsewhere herein and can include up to “N” processing clusters (e.g., cluster 1414A, cluster 1414B, through cluster 1414N), where “N” represents a positive integer (which may be a different integer “N” than used in other figures). Each cluster 1414A-1414N of processing cluster array 1412 can execute a large number of concurrent threads. Scheduler 1410 can allocate work to clusters 1414A-1414N of processing cluster array 1412 using various scheduling and/or work distribution algorithms, which may vary depending on workload arising for each type of program or computation. Scheduling can be handled dynamically by scheduler 1410, or can be assisted in part by compiler logic during compilation of program logic configured for execution by processing cluster array 1412. Different clusters 1414A-1414N of processing cluster array 1412 can be allocated for processing different types of programs or for performing different types of computations.

Processing cluster array 1412 can be configured to perform various types of parallel processing operations, such as, but not limited to, any of the operations described above or elsewhere herein. Processing cluster array 1412 can be configured to perform general-purpose parallel compute operations. For example, processing cluster array 1412 can include logic to execute processing tasks including filtering of video and/or audio data, performing modeling operations, including physics operations, and performing data transformations.

Processing cluster array 1412 can be configured to perform parallel graphics processing operations. Processing cluster array 1412 can include additional logic to support execution of such graphics processing operations, including but not limited to, texture sampling logic to perform texture operations, as well as tessellation logic and other vertex processing logic. Processing cluster array 1412 can be configured to execute graphics processing related shader programs such as, but not limited to, vertex shaders, tessellation shaders, geometry shaders, and pixel shaders. Parallel processing unit 1402 can transfer data from system memory via I/O unit 1404 for processing. During processing, transferred data can be stored to on-chip memory (e.g., parallel processor memory 1422) during processing, then written back to system memory.

When parallel processing unit 1402 is used to perform graphics processing, scheduler 1410 can be configured to divide a processing workload into approximately equal sized tasks, to better enable distribution of graphics processing operations to multiple clusters 1414A-1414N of processing cluster array 1412. Portions of processing cluster array 1412 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of clusters 1414A-1414N may be stored in buffers to allow intermediate data to be transmitted between clusters 1414A-1414N for further processing.

Processing cluster array 1412 can receive processing tasks to be executed via scheduler 1410, which receives commands defining processing tasks from front end 1408. Processing tasks can include indices of data to be processed, e.g., surface (patch) data, primitive data, vertex data, and/or pixel data, as well as state parameters and commands defining how data is to be processed (e.g., what program is to be executed). Scheduler 1410 may be configured to fetch indices corresponding to tasks or may receive indices from front end 1408. Front end 1408 can be configured to ensure processing cluster array 1412 is configured to a valid state before a workload specified by incoming command buffers (e.g., batch-buffers, push buffers, etc.) is initiated.

Each of one or more instances of parallel processing unit 1402 can couple with a parallel processor memory 1422 to perform any of the operations described above or elsewhere herein. Parallel processor memory 1422 can be accessed via memory crossbar 1416, which can receive memory requests from processing cluster array 1412 as well as I/O unit 1404. Memory crossbar 1416 can access parallel processor memory 1422 via a memory interface 1418. Memory interface 1418 can include multiple partition units (e.g., partition unit 1420A, partition unit 1420B, through partition unit 1420N) that can each couple to a portion (e.g., memory unit) of parallel processor memory 1422. A number of partition units 1420A-1420N can be configured to be equal to a number of memory units, such that a first partition unit 1420A has a corresponding first memory unit 1424A, a second partition unit 1420B has a corresponding memory unit 1424B, and an N-th partition unit 1420N has a corresponding N-th memory unit 1424N. A number of partition units 1420A-1420N may not be equal to a number of memory units.

Memory units 1424A-1424N can include various types of memory devices, including dynamic random access memory (DRAM) or graphics random access memory, such as, but not limited to, synchronous graphics random access memory (SGRAM), including graphics double data rate (GDDR) memory. Memory units 1424A-1424N may also include 3D stacked memory, including but not limited to high bandwidth memory (HBM), HBM2e, or HDM3. Render targets, such as, but not limited to, frame buffers or texture maps may be stored across memory units 1424A-1424N, allowing partition units 1420A-1420N to write portions of each render target in parallel to efficiently use available bandwidth of parallel processor memory 1422. A local instance of parallel processor memory 1422 may be excluded in favor of a unified memory design that utilizes system memory in conjunction with local cache memory.

Any one of clusters 1414A-1414N of processing cluster array 1412 can process data that will be written to any of memory units 1424A-1424N within parallel processor memory 1422. Memory crossbar 1416 can be configured to transfer an output of each cluster 1414A-1414N to any partition unit 1420A-1420N or to another cluster 1414A-1414N, which can perform additional processing operations on an output. Each cluster 1414A-1414N can communicate with memory interface 1418 through memory crossbar 1416 to read from or write to various external memory devices. Memory crossbar 1416 can have a connection to memory interface 1418 to communicate with I/O unit 1404, as well as a connection to a local instance of parallel processor memory 1422, enabling processing units within different processing clusters 1414A-1414N to communicate with system memory or other memory that is not local to parallel processing unit 1402. Memory crossbar 1416 can use virtual channels to separate traffic streams between clusters 1414A-1414N and partition units 1420A-1420N.

Multiple instances of parallel processing unit 1402 can be provided on a single add-in card, or multiple add-in cards can be interconnected. Different instances of parallel processing unit 1402 can be configured to interoperate even if different instances have different numbers of processing cores, different amounts of local parallel processor memory, and/or other configuration differences. For example, some instances of parallel processing unit 1402 can include higher precision floating point units relative to other instances. Systems incorporating one or more instances of parallel processing unit 1402 or parallel processor 1400 can be implemented in a variety of configurations and form factors, including but not limited to desktop, laptop, or handheld personal computers, servers, workstations, game consoles, and/or embedded systems.

FIG. 14A further includes a block diagram of a partition unit 1420, in accordance with at least one embodiment. Partition unit 1420 is an instance of one of partition units 1420A-1420N of FIG. 14A. Partition unit 1420 can include an L2 cache 1421, a frame buffer interface 1425, and a ROP 1426 (raster operations unit). L2 cache 1421 can be a read/write cache that is configured to perform load and store operations received from memory crossbar 1416 and ROP 1426. Read misses and urgent write-back requests can be output by L2 cache 1421 to frame buffer interface 1425 for processing. Updates can also be sent to a frame buffer via frame buffer interface 1425 for processing. Frame buffer interface 1425 may interface with one of memory units in parallel processor memory, such as, but not limited to, memory units 1424A-1424N (shown as 1424) of FIG. 14A (e.g., within parallel processor memory 1422).

ROP 1426 can be a processing unit that performs raster operations such as, but not limited to, stencil, z test, blending, etc. ROP 1426 can then output processed graphics data that is stored in graphics memory. ROP 1426 can include compression logic to compress depth or color data that is written to memory and decompress depth or color data that is read from memory. Compression logic can be lossless compression logic that makes use of one or more of multiple compression algorithms. A type of compression that is performed by ROP 1426 can vary based on statistical characteristics of data to be compressed. For example, delta color compression is performed on depth and color data on a per-tile basis.

ROP 1426 can be included within each processing cluster (e.g., cluster 1414A-1414N of FIG. 14A) instead of within partition unit 1420. Read and write requests for pixel data may be transmitted over memory crossbar 1416 instead of pixel fragment data. Processed graphics data may be displayed on a display routed for further processing by processor(s), or routed for further processing by one of processing entities within parallel processor 1400 of FIG. 14A.

In at least one embodiment, parallel processor 1400 can include one or more circuits to use a neural network to select a decoder from a plurality of decoders to decode an encoded representation of information received from an encoder or otherwise perform any of the operations described above or elsewhere herein. One or more circuits can be configured by software to use a neural network to select a decoder from a plurality of decoders to decode an encoded representation of information received from an encoder or otherwise perform any of the operations described above or elsewhere herein.

FIG. 14B includes a block diagram of a processing cluster 1414 within a parallel processing unit, in accordance with at least one embodiment. A processing cluster can be an instance of one of processing clusters 1414A-1414N of FIG. 14A that can be used to perform any of the operations described above or elsewhere herein. Processing cluster 1414 can be configured to execute many threads in parallel, where “thread” refers to an instance of a particular program executing on a particular set of input data. Single-instruction, multiple-data (SIMD) instruction issue techniques can be used to support parallel execution of a large number of threads without providing multiple independent instruction units. Single-instruction, multiple-thread (SIMT) techniques may be used to support parallel execution of a large number of generally synchronized threads, using a common instruction unit configured to issue instructions to a set of processing engines within each one of processing clusters.

Operation of processing cluster 1414 can be controlled via a pipeline manager 1432 that distributes processing tasks to SIMT parallel processors. Pipeline manager 1432 can receive instructions from scheduler 1410 of FIG. 14A and manages execution of those instructions via a graphics multiprocessor 1434 and/or a texture unit 1436. Graphics multiprocessor 1434 may be an example instance of a SIMT parallel processor. However, various types of SIMT parallel processors of differing architectures may be included within processing cluster 1414. One or more instances of graphics multiprocessor 1434 can be included within a processing cluster 1414. Graphics multiprocessor 1434 can process data and a data crossbar 1440 can be used to distribute processed data to one of multiple possible destinations, including other shader units. Pipeline manager 1432 can facilitate distribution of processed data by specifying destinations for processed data to be distributed via data crossbar 1440.

Each graphics multiprocessor 1434 within processing cluster 1414 can include an identical set of functional execution logic (e.g., arithmetic logic units, load-store units, etc.) to perform computations for any of the operations described above or elsewhere herein. Functional execution logic can be configured in a pipelined manner in which new instructions can be issued before previous instructions may be complete. Functional execution logic can support a variety of operations including integer and floating point arithmetic, comparison operations, Boolean operations, bit-shifting, and computation of various algebraic functions. Same functional-unit hardware can be leveraged to perform different operations and any combination of functional units may be present.

Instructions transmitted to processing cluster 1414 may constitute a thread, which can also be referred to as a warp, subgroup, wave, or a wavefront. A set of threads executing across a set of parallel processing engines can be referred to as a thread group. A thread group can execute a common program on different input data. Each thread within a thread group can be assigned to a different processing engine within a graphics multiprocessor 1434. A thread group may include fewer threads than a number of processing engines within graphics multiprocessor 1434. When a thread group includes fewer threads than a number of processing engines, one or more of processing engines may be idle during cycles in which that thread group is being processed. A thread group may also include more threads than a number of processing engines within graphics multiprocessor 1434. When a thread group includes more threads than number of processing engines within graphics multiprocessor 1434, processing can be performed over consecutive clock cycles. Multiple thread groups can be executed concurrently on a graphics multiprocessor 1434.

Graphics multiprocessor 1434 includes an internal cache memory to perform load and store operations, such as, but not limited to, any of the operations described above or elsewhere herein. Graphics multiprocessor 1434 can forego an internal cache and use a cache memory (e.g., L1 cache 1448) within processing cluster 1414. Each graphics multiprocessor 1434 may also have access to L2 caches within partition units (e.g., partition units 1420A-1420N of FIG. 14A) that can be shared among all processing clusters 1414 and may be used to transfer data between threads. Graphics multiprocessor 1434 may also access off-chip global memory, which can include one or more of local parallel processor memory and/or system memory. Any memory external to parallel processing unit 1402 may be used as global memory. Processing cluster 1414 can include multiple instances of graphics multiprocessor 1434 and can share common instructions and data, which may be stored in L1 cache 1448.

Each processing cluster 1414 may include an MMU 1445 (memory management unit) that can be configured to map virtual addresses into physical addresses. One or more instances of MMU 1445 may reside within memory interface 1418 of FIG. 14A. MMU 1445 can include a set of page table entries (PTEs) used to map a virtual address to a physical address of a tile and optionally a cache line index. MMU 1445 may include address translation lookaside buffers (TLB) or caches that may reside within graphics multiprocessor 1434 or L1 1448 cache or processing cluster 1414. A physical address can be processed to distribute surface data access locally to allow for efficient request interleaving among partition units. A cache line index may be used to determine whether a request for a cache line is a hit or miss.

A processing cluster 1414 may be configured such that each graphics multiprocessor 1434 is coupled to a texture unit 1436 for performing texture mapping operations, e.g., determining texture sample positions, reading texture data, and filtering texture data. Texture data can be read from an internal texture L1 cache (not shown) or from an L1 cache within graphics multiprocessor 1434 and can be fetched from an L2 cache, local parallel processor memory, or system memory, as needed. Each graphics multiprocessor 1434 can output processed tasks to data crossbar 1440 to provide processed task to another processing cluster 1414 for further processing or to store processed task in an L2 cache, local parallel processor memory, or system memory via memory crossbar 1416. A preROP 1442 (pre-raster operations unit) can be configured to receive data from graphics multiprocessor 1434, and direct data to ROP units, which may be located with partition units as described herein (e.g., partition units 1420A-1420N of FIG. 14A). PreROP 1442 unit can perform optimizations for color blending, organizing pixel color data, and performing address translations.

In at least one embodiment, processing cluster 1414 can include one or more circuits to use a neural network to select a decoder from a plurality of decoders to decode an encoded representation of information received from an encoder or otherwise perform any of the operations described above or elsewhere herein. One or more circuits can be configured by software to use a neural network to select a decoder from a plurality of decoders to decode an encoded representation of information received from an encoder or otherwise perform any of the operations described above or elsewhere herein.

FIG. 14C shows a graphics multiprocessor 1434, in accordance with at least one embodiment, e.g., to perform any of the operations described above or elsewhere herein. Graphics multiprocessor 1434 can couple with pipeline manager 1432 of processing cluster 1414. Graphics multiprocessor 1434 can include an execution pipeline including but not limited to an instruction cache 1452 (that, e.g., can store instructions, such as, not limited to compiled API instructions), an instruction unit 1454, an address mapping unit 1456, a register file 1458, one or more general purpose graphics processing unit (GPGPU) cores 1462, and one or more load/store units 1466, where one or more load/store units 1466 can perform load/store operations to load/store instructions corresponding to performing an operation. GPGPU cores 1462 and load/store units 1466 can be coupled with cache memory 1472 and shared memory 1470 via a memory and cache interconnect 1468. GPGPU cores 1462 can be part of an SoC such as, but not limited to, part of integrated circuit 1300 in FIG. 13.

Instruction cache 1452 can receive a stream of instructions (e.g., to perform any of the operations described above or elsewhere herein) to execute from pipeline manager 1432. Instructions can be cached in instruction cache 1452 and dispatched for execution by an instruction unit 1454. Instruction unit 1454 can dispatch instructions as thread groups (e.g., warps, subgroups, wavefronts, or waves), with each thread of thread group assigned to a different execution unit within GPGPU cores 1462. An instruction can access any of a local, shared, or global address space by specifying an address within a unified address space. Address mapping unit 1456 can be used to translate addresses in a unified address space into a distinct memory address that can be accessed by load/store units 1466.

Register file 1458 can provide a set of registers for functional units of graphics multiprocessor 1434. Register file 1458 may provide temporary storage for operands connected to data paths of functional units (e.g., GPGPU cores 1462, load/store units 1466) of graphics multiprocessor 1434. Register file 1458 may be divided between each of functional units such that each functional unit is allocated a dedicated portion of register file 1458. Register file 1458 can be divided between different warps (which may be referred to as wavefronts, subgroups, and/or waves or threads) being executed by graphics multiprocessor 1434.

GPGPU cores 1462 can each include floating point units (FPUs) and/or integer arithmetic logic units (ALUs) that can be used to execute instructions of graphics multiprocessor 1434. GPGPU cores 1462 can be similar in architecture or can differ in architecture. A first portion of GPGPU cores 1462 can include a single precision FPU and an integer ALU while a second portion of GPGPU cores include a double precision FPU. FPUs can implement IEEE 754-2008 standard floating point arithmetic or enable variable precision floating point arithmetic. Graphics multiprocessor 1434 can additionally include one or more fixed function or special function units to perform specific functions such as, but not limited to, copy rectangle or pixel blending operations. One or more of GPGPU cores 1462 can also include fixed or special function logic.

GPGPU cores 1462 can include SIMD logic capable of performing a single instruction on multiple sets of data. GPGPU cores 1462 can physically execute SIMD4, SIMD8, and SIMD16 instructions and logically execute SIMD1, SIMD2, and SIMD32 instructions. SIMD instructions for GPGPU cores can be generated at compile time by a shader compiler or automatically generated when executing programs written and compiled for single program multiple data (SPMD) or SIMT architectures. Multiple threads of a program can be configured for an SIMT execution model that can be executed via a single SIMD instruction. For example, eight SIMT threads that perform same or similar operations can be executed in parallel via a single SIMD8 logic unit.

Memory and cache interconnect 1468 can include an interconnect network that connects each functional unit of graphics multiprocessor 1434 to register file 1458 and to shared memory 1470. Memory and cache interconnect 1468 may be a crossbar interconnect that allows load/store unit 1466 to implement load and store operations between shared memory 1470 and register file 1458. register file 1458 can operate at a same frequency as GPGPU cores 1462, thus data transfer between GPGPU cores 1462 and register file 1458 can have very low latency. Shared memory 1470 can be used to enable communication between threads that execute on functional units within graphics multiprocessor 1434. Cache memory 1472 can be used as a data cache for example, to cache texture data communicated between functional units and texture unit 1436. Shared memory 1470 can also be used as a program managed cache. Threads executing on GPGPU cores 1462 can programmatically store data within shared memory in addition to automatically cached data that is stored within cache memory 1472.

A parallel processor or GPGPU as described herein may be communicatively coupled to host/processor cores to accelerate graphics operations, machine-learning operations, pattern analysis operations, and various general purpose GPU (GPGPU) functions. A GPU may be communicatively coupled to host processor/cores over a bus or other interconnect (e.g., a high-speed interconnect such as, but not limited to, PCIe or NVLink). An SoC may include a parallel processor or GPGPU as described herein, where said parallel processor or said GPGPU is performed on said SoC. A GPU may be integrated on a package or chip as cores and communicatively coupled to cores over an internal processor bus/interconnect internal to a package or chip. Regardless a manner in which a GPU is connected, processor cores may allocate work to such GPU in a form of sequences of commands/instructions contained in a work descriptor. GPU then may use dedicated circuitry/logic for efficiently processing these commands/instructions to perform any of the operations described above or elsewhere herein.

In at least one embodiment, graphics multiprocessor 1434 can include one or more circuits to use a neural network to select a decoder from a plurality of decoders to decode an encoded representation of information received from an encoder or otherwise perform any of the operations described above or elsewhere herein. One or more circuits can be configured by software to use a neural network to select a decoder from a plurality of decoders to decode an encoded representation of information received from an encoder or otherwise perform any of the operations described above or elsewhere herein.

FIG. 15 shows a processor 1500, in accordance with at least one embodiment. Processor 1500 can include a processor with hybrid architecture (e.g., Lunar Lake or Meteor Lake) from Intel Corporation in Santa Clara, CA or another processor that shares at least some of the components described herein. Processor 1500 can include one or more Central Processing Unit(s) (CPU 1502), one or more Graphics Processing Unit(s) (GPU 1506), and/or one or more Neural Processing Unit(s) (NPU 1508) that can be, e.g., a dedicated AI accelerator that offloads artificial intelligence (AI) workloads from CPU 1502 and GPU 1506. Processor 1500 can use instructions that, if executed cause processor 1500 and/or any of its components to perform some or all of processes and techniques described elsewhere herein. Processor 1500 may include any number of memory and cache units 1510 to facilitate processing amongst different components of processor 1500. Memory and cache 1510 on processor 1500 may include one or more levels of cache (e.g., L1, L2, L3, and/or last-level cache) and high-bandwidth memory (e.g., HBM2e or HBM3) in any combination. With respect to processor 1500 and any of its components described above or elsewhere herein, one or more of APIs described herein can, for example, get compiled into instructions, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of processor 1500 (e.g., in cache and/or memory). A result of API(s) can then be stored in storage within or outside of processor 1500, including registers, DRAM, flash, SRAM, cache, or other memory. One or more of APIs described herein can include a call.

Processor 1500 can include compute engines as CPUs 1502 and can include any number of cores, such as, but not limited to, up to 16 cores/22 threads. Cores in CPU 1502 can include P-cores (Performance), E-cores (Efficient) & LP-E cores (Low-power Efficient). Performance-cores can be used for low latency single-threaded, compute-intensive workloads, while Efficient-cores can be used for multi-threaded, less compute-intensive workloads. Low-power Efficient cores can be used for scalable multithreaded performance and offloading background tasks. P-cores can be used for single & limited threading performance, whereas E- and LP-E cores can be used for multi-threaded throughput and power efficiency.

GPU 1506 can include any number of graphics engines, such as, but not limited to, Intel® Arc™ graphics engines (Xe LPG) with 8 Xe cores (up to 128 Execution Units or EUs). As shown in FIG. 15, GPU 1506 can include vector engines 1510 and matrix engines 1512, that, for example, can run FP, INT, and matrix operation tasks all at the same time or separately or in batches. GPU 1506 can include a load/store unit 1514, as well as other memory, such as, but not limited to, an instruction cache (I$) 1516 and L1 cache/subsystem local memory (SLM) 1518 that can, e.g., store instructions to perform any of the operations described above or elsewhere herein.

NPU 1504 can include one or more Intel® AI Boost built-in neural processing unit(s) (NPUs). NPU 1504 can be enumerated to a host processor as an integrated PCIe device. NPU 1504 can include one or more (e.g., two) Neural Compute Engine (NCE) tiles 1530. Each tile can be configured with any combination of, but not limited to, (e.g., 2000) Multiply Accumulate (MAC) Engines 1534, a Post Processing Engine (not shown), a AI DSP Processor (not shown), and memory (2 MB of dedicated SRAM) per tile as shown in FIG. 15. For general compute needs, Neural Compute Engines 1530 can include interference pipeline 1532, activation function (AF) 1536, data conversion 1538, load/store 1540, and Streaming Hybrid Architecture Vector Engines (SHAVE) 1528 for high performance parallel computing, which can include DMA (Direct Memory Access) engines 1524 to shuttle data between system memory DRAM (Dynamic Random Access Memory) 1526 and a software managed cache. Built-in device MMU (Memory Management Unit) 1522 plus IOMMU (Input-Output Memory Management Unit) (not shown) can support multiple simultaneous hardware contexts and provide security isolation between execution contexts as per MCDM (Microsoft Compute Driver Model) architecture. Processor 1500 can also include a media unit (not shown) that is included on or separately from XCDs or other components of processor 1500 to enable video playback and video processing of compressed or non-compressed data, such using HEVC, AV1, VP9 and AVC HW accelerated decode support and HEVC, VP9 and AVC HW accelerated encode support.

A Intel® Thread Director, which includes firmware that is built into processor 1500, can prioritize and manage distribution of workloads, sending tasks to optimized cores. For example, Thread Director can tie P-cores, E-cores and/or LP-E cores (described above) together with task-scheduling capabilities and ability to send less-demanding tasks to E-cores or LP-E cores. Intel® Deep Learning Boost (Intel® DL Boost) (not shown) can provide built in AI acceleration for training and inference workloads, and may include VNNI (for CPU) and DP4a (for GPU) instruction set support. This instruction set may be optimized with OpenVINO™ Toolkit and oneAPI to accelerate INT8 inferencing. A software stack, e.g., as described elsewhere herein, can be used to enable AI inference using OpenVINO™ toolkit. Processor 1500 can be configured to execute an application program, such as, but not limited to, a CUDA program.

In at least one embodiment, processor 1500 can include one or more circuits to use a neural network to select a decoder from a plurality of decoders to decode an encoded representation of information received from an encoder or otherwise perform any of the operations described above or elsewhere herein. One or more circuits can be configured by software to use a neural network to select a decoder from a plurality of decoders to decode an encoded representation of information received from an encoder or otherwise perform any of the operations described above or elsewhere herein.

Processor 1500 can alternatively include a processor based on AI Engine Direct architecture from Qualcomm Corporation in Santa Clara, CA or another processor that shares at least some of the components described herein. that may include any number of NPUs, GPUs, CPUs and other related components, such as, but not limited to, NPU 1504 as a Hexagon NPU, GPU 1506 as a Adreno GPU, CPU 1502 as a Kryo or Qualcomm Oryon CPU, as well as a Qualcomm Sensing Hub (not shown) and a memory subsystem 1510, in any combination. Hexagon NPU 1504 can include a power rail a micro-tile inferencing unit, a hardware acceleration unit, a tensor unit, a scalar unit, and a vector unit (all not shown), which can have dedicated memory or share memory (e.g., cache or memory, such HBM3) for, e.g., storing instructions to perform any of the operations described above or elsewhere herein. Adreno GPU 1506 can provide graphics and parallel processing for AI in formats, such as, but not limited to, 32-bit floating point (FP32), 16-bit floating point (FP16), and 8-bit integer (INT8). Kryo or Qualcomm Oryon CPUs 1502 can perform AI workloads, and can handle contextualization for pervasive generative AI applications. CPU 1502 can also include an instruction fetch unit, a rename and retire unit, a memory management unit, a vector execution unit, an integer execution unit, and a load and store unit for processing and instruction management. With respect to processor 1500 and any of its components described above or elsewhere herein, one or more of APIs described herein can, for example, get compiled into instructions, which may be fetched by instruction fetch unit, decoded by a processor decoder or equivalents, scheduled (e.g., in order or out of order) for execution by a scheduler or equivalents, executed by execution logic or equivalents, reordered, and then retired by rename and retire unit. API(s) (and/or compiled instructions including API(s)) can be stored in any storage outside or inside of processor 1500 (e.g., in cache and/or memory). Any number of CPU cores 1502 may be included in any number of CPU cluster(s) that can be coupled to memory and/or cache, such as, but not limited to a shared L2 cache. Memory can be separate or shared, e.g., CPU clusters of CPU cores 1502 can couple to memory subsystem 1510 that can include fabric, system level cache and any number of memory management units that can, for example, read and write memory (e.g., DRAM). Qualcomm Sensing Hub (not shown) includes micro NPUs, a power rail, and traditional sensors (a gyrometer, accelerometer, even a barometer) with voice and data streams. Memory subsystem 1510 can include memory and cache on processor 1500, which may include one or more levels of cache (e.g., L1, L2, L3, and/or last-level cache) and high-bandwidth memory (e.g., HBM2e or HBM3) in any combination, e.g., for storing information and/or instructions to perform any of the operations described above or elsewhere herein. All or some of memory and/or cache in memory subsystem 1510 can be shared or used individually by any one or combinations of components (e.g., GPU 1506, NPU 1504, and CPU 1502) on processor 1500.

Qualcomm AI Engine 1500 may be programmed and controlled with an a software stack to perform some or all of the operations described herein, and include, e.g., a Qualcomm® Neural Processing SDK for inferencing with versions for Android, Linux, and Windows. Developer libraries and services support programming languages, virtual platforms, and compilers. At a lower level of software stack, system software includes basic real-time operating system (RTOS), system interfaces, and drivers. Software stack supports different operating systems, including Android, Windows, Linux, and QNX, and deployment and monitoring infrastructure like Prometheus, Kubernetes, and Docker. For direct cross-platform access to GPU 1506, OpenCL and DirectML may be supported. For CPU 1502, a LLVM compiler infrastructure optimizations enable accelerated and efficient AI inference. With respect to Qualcomm AI Engine 1500 and any of its components described above or elsewhere herein, one or more of APIs described herein can, for example, get compiled into instructions, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of Qualcomm AI Engine 1500 (e.g., in cache and/or memory). A result of API(s) can then be stored in storage within or outside of Qualcomm AI Engine 1500, including registers, DRAM, flash, SRAM, cache, or other memory.

In at least one embodiment, processor 1500 or Qualcomm AI Engine 1500 can include one or more circuits to use a neural network to select a decoder from a plurality of decoders to decode an encoded representation of information received from an encoder or otherwise perform any of the operations described above or elsewhere herein. One or more circuits can be configured by software to use a neural network to select a decoder from a plurality of decoders to decode an encoded representation of information received from an encoder or otherwise perform any of the operations described above or elsewhere herein.

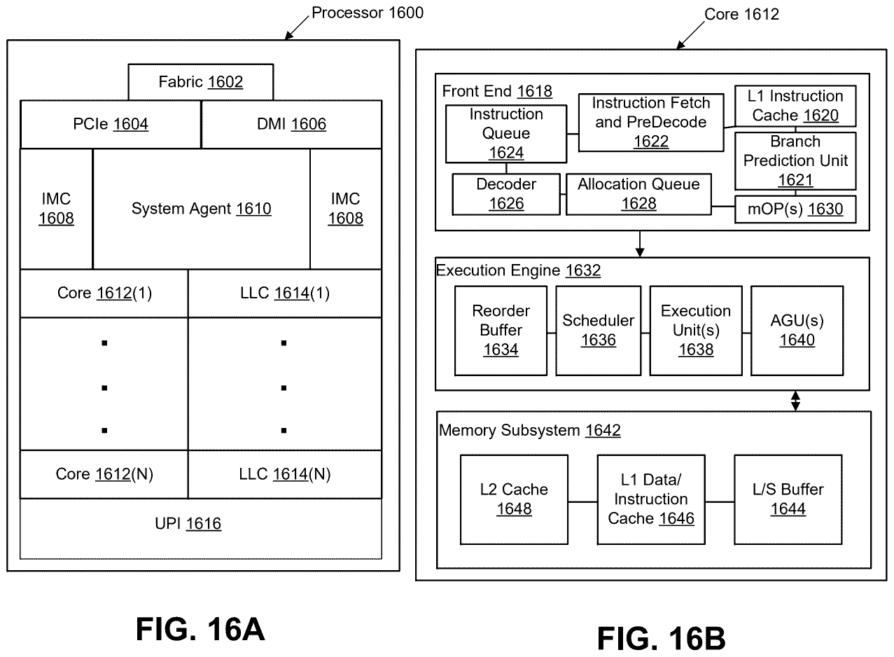

FIG. 16A illustrates a processor 1600, in accordance with at least one embodiment. Processor 1600 can include an processor with scalable family from Intel Corporation in Santa Clara, CA or another processor that shares at least some of the components described herein. Processor 1600 can include one or more cores 1612(1)-1612(N), where N is any integer greater than 1 that can perform the operations described elsewhere herein. Cores 1612(1)-1612(N) can be interlinked together using ring and/or mesh interconnects. With a mesh interconnects architecture, an array of vertical and horizontal communication paths may allow traversal from one core to another 1612(1)-1612(N) through a shortest path (hop on vertical path to correct row, and hop across horizontal path to correct column). For mesh interconnects, a die can house cores 1612(1)-1612(N) and can include a grid of converged mesh stops (CMS) that may be associated (e.g., 1:1) with cores 1612(1)-1612(N). Each core can be associated with one lower level cache (LLC) slice 1614(1)-1614(N), or cores 1612(1)-1612(N) can share cache, e.g., lower level cache. LLCs 1614(1)-1614(N) can be inclusive by incorporating blocks in higher level cache (e.g., L2 cache) or non-inclusive (having blocks that may be not present in higher level cache). Each core and LLC slice can include a Caching and Home Agent (CHA) (not shown) that can maintain cache coherency by providing scalability of resources across mesh interconnects for Intel® Ultra Path Interconnect (Intel® UPI 1616) cache coherency functionality. UPI 1616 can provide a coherent interconnect for scalable systems and can allow for multiple processors to share a single shared address space through links, such as, but not limited to, two or three UPI links per processor.

Processor 1600 can also include System Agent 1610 that can house and/or perform various functionalities, such as, but not limited to, memory management, display functions, and/or input/output (I/O) functions. For example, processor 1600 can include one or more integrated memory controller(s) (IMC) 1608. IMC 1608 can control and manage memory, such as, but not limited to, different memory types e.g., DDR ram, like DDR4 or others described elsewhere herein. System Agent 1610 can include a display controller (not shown) to support display(s). System Agent 1610 can also incorporate PCIe 1604 (e.g., up to 20 lanes of PCIe), e.g., that can connect with an external dedicated graphics hookup over DMI bus (e.g., Intel's DMI 3.0 bus) 1606. System Agent 1610 can include an Image Processing Unit (IPU) (not shown) which incorporates an image signal processor (ISP) on-die. Fabric 1602 can provide scalability for connecting to other nodes (e.g., processors, such as processor 1600), and can, for example, be used with Cornelis Networks, an element of Intel® Scalable System Framework, that delivers the performance for high performance computing (HPC) workloads and the ability to scale to tens of thousands of nodes.

FIG. 16B illustrates components within core 1612, in accordance with at least one embodiment. Core 1612 can include front-end 1618, back-end or execution engine 1632, and memory subsystem 1642. Front-end 1618 can provide execution engine 1632 with operations (e.g., operations described elsewhere herein) by decoding instructions stored in memory. For example, front-end 1618 can include a micro-operations (u Ops) cache path and/or a legacy path, along with branch prediction unit 1621 that can determine paths instructions. A legacy path for instructions may include fetching variable-length (e.g., x86) instructions from L1 instruction cache 1620 with instruction fetch and predecode 1622, queuing the instructions in instruction queue 1624, and decoding instructions using decoder 1626 into u Ops that can be provided to allocation queue 1628. Alternatively, a μOPs cache path may include a cache containing already decoded μOps (μOps 1630) that can be sent to allocation queue 1628. Allocation queue 1628 can perform as an interface between front-end 1618 and execution engine 1632, and can provide instructions to execution engine 1632. One or more of API(s) described herein can, for example, get compiled into instructions that can be stored, processed, and executed by front-end 1618, execution engine 1632, and stored in memory subsystem 1642.

Execution engine 1632 can receive micro-operations into reorder buffer 1634, which can register allocation, rename, and retire μOPs. From reorder buffer, μOPs can be sent to scheduler 1636 that can be connected one or more different execution units 1638, which can be connected to address generation unit (AGU) 1640. Execution units 1638 can perform, e.g., basic arithmetic logic unit (ALU) operations, multiplication, division, and/or more complex operations, such as, but not limited to, various vector operations. Scheduler 1636 may manage queuing μOPs for one or more of execution units 1638 depending, e.g., on operations needed to be performed.

Memory subsystem 1642 can process load and store requests as well as ordering operations. For example, OPs may relate to memory access (e.g. load and store), and those can be sent on dedicated scheduler ports that can perform those memory operations. Store and load operations, for example, can be sent to load and store buffer(s) 1644. Memory subsystem 1642 can also include shared or separate L1 data and instruction cache 1646, as well as L2 cache 1648 that can be used and shared by L1 data and instruction cache 1646. As described above for FIG. 16A, each core 1612 can be connected to a slice of a third level of cache (e.g., LLC 1614) that can be shared by all core 1612.

In at least one embodiment, processor 1600 can include one or more circuits to use a neural network to select a decoder from a plurality of decoders to decode an encoded representation of information received from an encoder or otherwise perform any of the operations described above or elsewhere herein. One or more circuits can be configured by software to use a neural network to select a decoder from a plurality of decoders to decode an encoded representation of information received from an encoder or otherwise perform any of the operations described above or elsewhere herein.

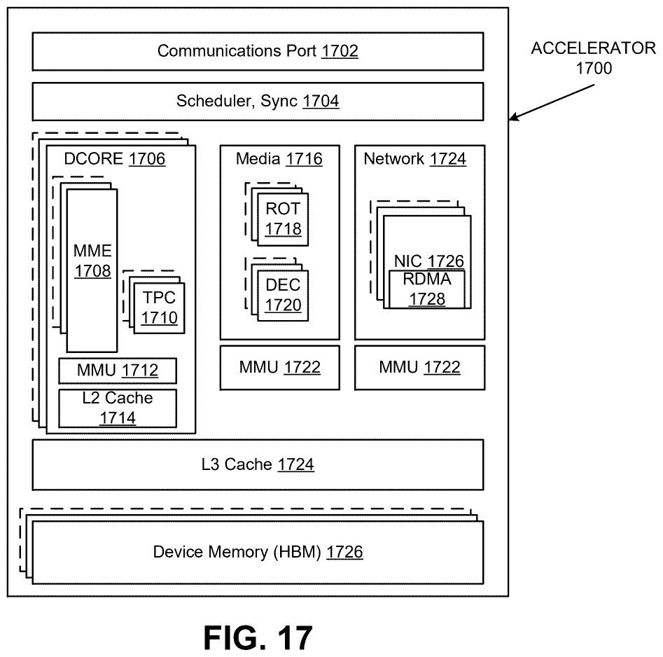

FIG. 17 illustrates an AI accelerator 1700, in accordance with at least one embodiment. Processor 1700 can include a processor with AI accelerator architecture from Intel Corporation in Santa Clara, CA or another processor that shares at least some of the components described herein. AI accelerator 1700 may use instructions that, if executed by AI accelerator 1700, cause AI accelerator 1700 to perform some or all of processes and techniques described elsewhere herein. For example, with respect to AI accelerator 1700 and any of its components described above or elsewhere herein, one or more of APIs described herein can, for example, get compiled into instructions, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of AI accelerator 1700 (e.g., in cache and/or memory). A result of API(s) can then be stored in storage within or outside of AI accelerator 1700, including registers, DRAM, flash, SRAM, cache, or other memory. AI accelerator 1700 may include one or more compute dies that can include homogeneous or heterogeneous processors. Compute dies may include one or more central processing units (CPU), one or more graphics processing units (GPU), or combinations of both.

In at least one embodiment, compute dies may include compute engines to perform AI computations. In at least one embodiment, AI accelerator 1700 compute dies may be split into any number of (e.g., four) clusters that may be referred to as a DCORE (Deep Learning Core) 1706 and contain any number of Matrix Multiplication Engines (MMEs) 1708, Tensor Processor Cores (TPCs) 1710, memory management unit 1712, and L2 Cache 1714, in any combination. MME(s) 1708 can perform operations that use Matrix Multiplication, like fully connected layers, convolutions and batched-General Matrix Multiplications (GEMMs). MMEs 1708 may be equipped with Multiply-Accumulate Units (MACs) (not shown) that, for example, may perform General Matrix Multiplication (GEMM) operations, such as, but not limited to, an A×B multiplication that involves generating tensor C[N×M] from two input tensors, A[N×K] and B[K×N]. MME(s) 1708 may be programmed with array dimensions, locations, data types, and various execution operands. MME(s) 1708 can retrieve tensors A and B from memory, pulling them into its streaming buffers for matrix multiplication to be performed in parallel by MACs. MME(s) 1708 may push tensor C back to memory upon completion. TPC(s) 1710 may include any number of scalar units for performing scalar operations, any number of vector units for performing vector operations, any number of register files or local memory units (e.g., a vector local memory), and load and store components for instructions, which can be coupled to memory or cache (e.g., HBM, L3 cache and/or L2 cache) (all not shown). TPCs can support different types of parallel processing, e.g., Very Long Instruction Word (VLIW) Single-Instruction Multiple-Data (SIMD) that supports data types, such as, but not limited to, FP32, BF16, FP16 & FP8 (both E4M3 and E5M2), UINT32, INT32, UINT16, INT16, UINT8 and INT8 datatypes. Any number of compute dies may be connected through an interconnect. An interconnect that can connect compute dies can be over an interposer bridge that, e.g., is transparent to software.

Memory on AI Accelerator 1700 may include one or more levels of cache (e.g., L1, L2, L3, and/or last-level cache) and high-bandwidth memory (e.g., HBM2e or HBM3) in any combination. Memory and/or cache systems can be unified or separate. Compute dies of AI accelerator 1700 may include on-die memory that includes one or more levels (e.g., two-levels) of cache. On-die SRAM or other memory described elsewhere herein can be used as a uniformly accessible last-level cache (L3) or split to slices of L2 cache that may be accessible to groups of MMEs 1708 and TPCs 1710. Using on-die memory as L2 or L3 cache can be fully configurable by software, which dynamically may decide per I/O tensor its optimal cache allocation. AI Accelerator 1700 may include one or more Memory Management Units (MMUs) 1722 for managing memory, such as allowing AI accelerator 1700 memory subsystem to operate in a virtual space when accessing VRAM.

AI accelerator 1700 may include a communications port (e.g., a PCIe Gen5 X16 port) 1702 for communicating with a host and Scheduling and Synchronization Unit 1704. AI accelerator 1700 may include Media Unit 1716 that may include any number or combinations of Media Decoder Engines (DECs) 1720 and Rotator Engines (ROT) 1718. AI accelerator 1700 may include a network unit 1724 that may include any number or combinations of network ports 1726 and accompanied RDMA Engine(s) 1728, L2 Cache, and memory (e.g., HBM2e or HBM3) stacks. AI accelerator 1700 can incorporate a programmable Control Path entity (not shown) to manage parallel and efficient execution of various engines. Control Path can include Submission Queues (SQs) that may be issued by runtime system, Completion Queues (CQs) that may be used for job completion reporting, a Programmable Scheduling Mechanism that may be utilized for task scheduling, a Programmable Hardware Synchronization Mechanism or ‘Sync Manager (SM)’ that may be used for hardware synchronization, a Programmable Interrupt Service Mechanism or ‘Interrupt Manager (INTR)’ that can enable passing of asynchronous events to drivers.

AI accelerator 1700 may include media decoding units that support Video Formats, such as, but not limited to, HEVC, Progressive H.264, SVC base layer, MVC, VP9, JPEG, Progressive JPEG. AI accelerator 1700 may support post processing of decoded media streams, such as, but not limited to, image down-scaling (resizing an image), vertical and horizontal scaling at different scaling ratios, Image up-scaling, Image cropping, bilinear scaling, and Lancos scaling. AI accelerator 1700 may implement two post processing channels per decoder unit, one with scalar (up and down) and one just to output the original image. AI accelerator 1700 may include a hardware rotator engine that performs the following transformations of an input image: 2D rotation, 3D rotation, Projection, distorting and undistorting images, resampling input data at user-defined coordinates, and rescaling.

RDMA 1728 over Converged Ethernet on AI accelerator 1700 may enable scaling from a single node (e.g., a single AI Accelerator 1700 to hundreds or thousands of nodes or AI Accelerators 1700). NW Subsystem 1724 can include an Intel® Gaudi® Communication Library (IGCL), a master conductor that orchestrates data movement, and a programable scheduling mechanism that can enable smooth activation of engines while maintaining task dependencies. A accelerator networking sub-system can include Gigabit Ethernet NIC ports 1726, a Layer2 MAC (not shown), and RDMA Engines 1728. AI Accelerator 1700 can include Aggregation Engines for performing summing activities. All engines in processor 1700 can operate in parallel, e.g., MME(s) 1708, TPC(s) 1710 and NIC(s) 1726 can all work at the same time. There can be dependency between operations running on different engines, e.g., output of one engine can be used as input of another engine, and/or MME, TPC and NIC can be scheduled to run in parallel. When one engine has completed its executing operation, another engine can be scheduled to start working on the next operation (immediately upon readiness of its inputs).

AI Accelerator 1700 can be operated and controlled using software layer 1728 that may include low-level components, such as, but not limited to, a graph compiler, an automatic kernel fuser and a library of precompiled kernels, as well as integration to AI ecosystems, such as, but not limited to, PyTorch, DeepSpeed, Hugging Face, vLLM, Ray and more, or as described elsewhere herein with respect to software and programming platforms. Software layer 1728 may include implementations of algorithms, such as, but not limited to, Paged Attention, Flash Attention and more. Software layer 1728 may generate optimized binary code that implements a given model topology, such as, but not limited to, performing operator fusion, data layout management, parallelization, pipelining and memory management, and graph-level optimizations.

In at least one embodiment, AI accelerator 1700 can include one or more circuits to use a neural network to select a decoder from a plurality of decoders to decode an encoded representation of information received from an encoder or otherwise perform any of the operations described above or elsewhere herein. One or more circuits can be configured by software to use a neural network to select a decoder from a plurality of decoders to decode an encoded representation of information received from an encoder or otherwise perform any of the operations described above or elsewhere herein.

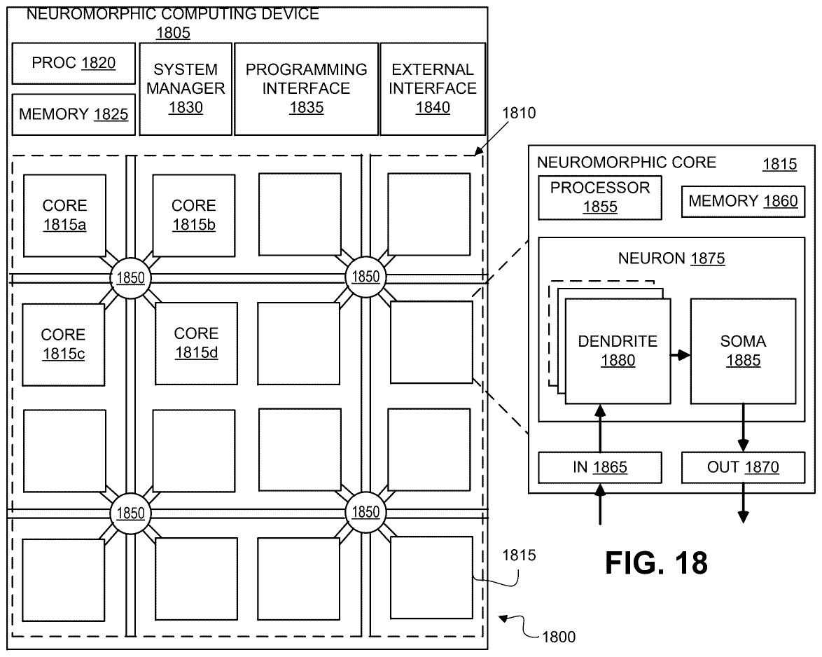

A neuromorphic computing system is described that adopts a multicore architecture where each core houses computing elements including neurons, synapses with on-chip learning capability, and local memory to store synaptic weights and routing tables. FIG. 18 is a simplified block diagram 1800 illustrating an example of at least a portion of such a neuromorphic computing device 1805, in accordance with at least one embodiment. Neuromorphic computing device 1805 can include a neuromorphic processor from Intel Corporation in Santa Clara, CA or another processor that shares at least some of the components described herein. As shown in this example, a device 1805 may be provided with a network 1810 of multiple neural network cores interconnected by an on-device network such that multiple different connections may be potentially defined between cores. For instance, a network 1810 of spiking neural network cores may be provided in device 1805 and may each communicate via short packetized spike messages sent from core to core over network channels. Each core (e.g., 1815) may possess processing and memory resources and logic to implement some number of primitive nonlinear temporal computing elements, such as, but not limited to, multiple (e.g., 1000+) distinct artificial neurons (referred to herein as “neurons”). For instance, each core may be capable of concurrently implementing multiple neurons such that neuromorphic cores may implement many multiples of neurons using device 1805. With respect to neuromorphic computing device 1805 and any of its components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of neuromorphic computing device 1805 (e.g., in cache and/or memory). A result of API(s) can then be stored in storage within or outside of neuromorphic computing device 1805, including registers, DRAM, flash, SRAM, cache, or other memory equivalents.

Continuing with the example of FIG. 18, neuromorphic computing device 1805 may additionally include processor 1820 and system memory 1825 to implement one or more components to manage and provide functionality of neuromorphic computing device 1805. For instance, system manager 1830 may be provided to manage global attributes and operations of neuromorphic computing device 1805 (e.g., attributes affecting network of cores 1810, multiple cores in network 1810, interconnections of neuromorphic computing device 1805 with other devices, manage access to global system memory 1825, among other potential examples). In one example, system manager 1830 may manage the definition and provisioning of a specific routing tables to various routers in network 1810, orchestration of a network definition and attributes (e.g., weights, decay rates, etc.) to be applied in network 1810, core synchronization and time multiplexing management, routing of inputs to appropriate cores, among other potential functions.

As another example, neuromorphic computing device 1805 may additionally include programming interface 1835 through which a user or system may specify a neural network definition to be applied (e.g., through a routing table and individual neuron properties) and implemented by mesh 1810 of neuromorphic cores. A software-based programming tool may be provided with or separate from neuromorphic computing device 1805 through which a user may provide a definition for a particular neural network to be implemented using network 1810 of neuromorphic cores. Programming interface 1835 may take an input of a programmer to then generate corresponding routing tables and populate local memory of individual neuromorphic cores (e.g., 1815) with specified parameters to implement a corresponding, customized network of artificial neurons implemented by neuromorphic cores 1815.

In some cases, neuromorphic computing device 1805 may advantageously interface with and interoperate with other devices, including general purpose computing devices, to realize certain applications and use cases. Accordingly, external interface logic 1840 may be provided in some cases to communicate (e.g., over one or more defined communication protocols) with one or more other devices. An external interface 1840 may be utilized to accept input data from another device or external memory controller acting as a source of input data. External interface 1840 may be additionally or alternatively utilized to allow results or output of computations of a neural network implemented using neuromorphic computing device 1805 to be provided to another device (e.g., another general purpose processor implementing a machine learning algorithm) to realize additional applications and enhancements, among other examples.

As shown in FIG. 18, network 1810 of multiple neural network cores interconnected by an on-device network is shown illustrating a portion of a network fabric interconnecting multiple neuromorphic cores (e.g., 1815 a-d). For instance, a number of neuromorphic cores (e.g., 1815 a-d) may be provided in a mesh, with each core being interconnected by a network including a number of routers (e.g., 1850). In one implementation, each neuromorphic core (e.g., 1815 a-d) may be connected to a single one of routers (e.g., 1850) and routers may be connected to at least one other router (as shown at 1810 in FIG. 18). As an example, in one particular implementation, four neuromorphic cores (e.g., 1815 a-d) may be connected to a single router (e.g., 1850) and each of routers 1850 may be connected to two or more other routers to form a manycore mesh, allowing each neuromorphic core to interconnect with each other neuromorphic core in neuromorphic computing device 1805. Moreover, as each neuromorphic core may be configured to implement multiple distinct neurons, router network of neuromorphic computing device 1805 may similarly enable connections, or artificial synapses (or, simply, “synapses”), to be defined between any two of potentially many (e.g., 30,000+) neurons defined using network of neuromorphic cores 1810 provided in neuromorphic computing device 1805.

FIG. 18 shows a block diagram illustrating internal components of one example implementation of neuromorphic core 1815. In one example, a single neuromorphic core may implement some number of neurons (e.g. 1024) that share architectural resources of neuromorphic core 1815 in a time-multiplexed manner. In one example, each neuromorphic core 1815 may include processor block 1855 capable of performing arithmetic functions and routing in connection with the realization of a digitally implemented artificial neuron, such as, but not limited to, explained herein. Each neuromorphic core 1815 may additionally provide local memory in which a routing table may be stored and accessed for a neural network, accumulated potential of each soma of each neuron implemented using core 1815 may be tracked, parameters of each neuron implemented by core may 1815 be recorded, among other data and usage. Components, or architectural resources, of neuromorphic core 1815 may further include input interface 1865 to accept input spike messages generated by other neurons on other neuromorphic cores and output interface 1870 to send spike messages to other neuromorphic cores over mesh network 1810. In some instances, routing logic for neuromorphic core 1815 may be at least partially implemented using output interface 1870. Further, in some cases, core (e.g., 1815) may implement multiple neurons within an example SNN and some of these neurons may be interconnected. In such instances, spike messages sent between neurons hosted on core 1815 may forego communication over routing fabric of neuromorphic computing device 1805 and may instead by managed locally at particular neuromorphic core 1815.

Each neuromorphic core may additionally include logic to implement, for each neuron 1875, artificial dendrite 1880 and artificial soma 1885 (referred to herein, simply, as “dendrite” and “soma” respectively). Dendrite 1880 may be a hardware-implemented process that receives spikes from network 1810. Soma 1885 may be a hardware-implemented process that receives each dendrite's accumulated neurotransmitter amounts for the current time and evolves each dendrite and soma's potential state to generate outgoing spike messages at the appropriate times. Dendrite 1880 may be defined for each connection receiving inputs from another source (e.g., another neuron). In one implementation, dendrite process 1880 may receive and handle spike messages as they serially arrive in time-multiplexed fashion from network 1810. As spikes are received, neuron's activation (tracked using soma 1885 (and local memory 1860)) may increase. When neuron's activation exceeds a threshold set for neuron 1875, neuron 1875 may generate a spike message that is propagated to a fixed set of fanout neurons via output interface 1870. Network distributes spike messages to all destination neurons, and in response those neurons, in turn, may update their activations in a transient, time-dependent manner, and so on, potentially causing the activation of some of these destination neurons to also surpass corresponding thresholds and trigger further spike messages, as in real biological neural networks.

As noted above, neuromorphic computing device 1805 may reliably implement a spike-based model of neural computation. Such models may also be referred to as Spiking Neural Networks (SNNs). In addition to neuronal and synaptic state, SNNs also incorporate the concept of time. For instance, in an SNN, communication occurs over event-driven action potentials, or spikes, that convey no explicit information other than the spike time as well as an implicit source and destination neuron pair corresponding to the transmission of the spike. Computation occurs in each neuron as a result of the dynamic, nonlinear integration of weighted spike input. In some implementations, recurrence and dynamic feedback may be incorporated within an SNN computational model. Further, a variety of network connectivity models may be adopted to model various real world networks or relationships, including fully connected (all-to-all) networks, feed-forward trees, fully random projections, “small world” networks, among other examples. A homogeneous, two-dimensional network of neuromorphic cores, such as, but not limited to, shown in the example of FIG. 18 may advantageously supports all of these network models. As some or all cores of neuromorphic computing device 1805 may be connected, some or all neurons defined in cores may be therefore also fully connected through some number of router hops. Neuromorphic computing device 1805 may further include fully configurable routing tables to define a variety of different neural networks by allowing each core's neurons to distribute their spikes to any number of cores in mesh 1810 to realize fully arbitrary connectivity graphs.

In an improved implementation of a system capable of supporting SNNs, such as, but not limited to, a very large scale integration (VLSI) hardware device illustrated in the example of FIG. 18, high speed and reliable circuits may be provided to implement SNNs to model information processing algorithms as employed by a brain, but in a more programmable manner. For instance, while a biological brain can only implement a specific set of defined behaviors, as conditioned by years of development, a neuromorphic processor device may provide a capability to rapidly reprogram all neural parameters. Accordingly, a single neuromorphic processor may be utilized to realize a broader range of behaviors than those provided by a single slice of biological brain tissue. This distinction may be realized by adopting a neuromorphic processor with neuromorphic design realizations that differ markedly from those of neural circuits found in nature.

As an example, a neuromorphic processor may utilize time-multiplexed computation in both a spike communication network and neuron machinery of neuromorphic computing device 1805 to implement SNNs. Accordingly, physical circuitry of neuromorphic computing device 1805 may be shared among many neurons to realize higher neuron density. With time multiplexing, a network can connect N cores with O(N) total wiring length, whereas discrete point-to-point wiring would scale as O(N²), realizing a significant reduction in wiring resources to accommodate planar and non-plastic VLSI wiring technologies, among other examples. In neuromorphic cores, time multiplexing may be implemented through dense memory allocation, for instance, using Static Random Access Memory (SRAM), with shared buses, address decoding logic, and other multiplexed logic elements. State of each neuron may be stored in processor's memory, with data describing each neuron state including state of each neuron's collective synapses, all currents and voltages over its membrane, among other example information (such as, but not limited to, configuration and other information).

A neuromorphic processor may adopt a “digital” implementation that diverts from other processors adopting more “analog” or “isomorphic” neuromorphic approaches. For instance, a digital implementation may implement integration of synaptic current using digital adder and multiplier circuits, as opposed to analog isomorphic neuromorphic approaches that accumulate charge on capacitors in an electrically analogous manner to how neurons accumulate synaptic charge on their lipid membranes. Accumulated synaptic charge may be stored, for instance, for each neuron in local memory of a corresponding core. Further, at an architectural level of an example digital neuromorphic processor, reliable and deterministic operation may be realized by synchronizing time across a network of cores such that any two executions of a design, given same initial conditions and configuration, will produce identical results. Asynchrony may be preserved at a circuit level to allow individual cores to operate as fast and freely as possible, while maintaining determinism at a system level. Accordingly, a notion of time as a temporal variable may be abstracted away in neural computations, separating it from a “wall clock” time that the hardware utilized to perform the computation. Accordingly, in some implementation, a time synchronization mechanism may be provided that globally synchronizes neuromorphic cores at discrete time intervals. A synchronization mechanism allows neural computation to complete as fast as circuitry allows, with a divergence between run time and biological time that a neuromorphic system models.

In operation, neuromorphic computing device 1805 may begin in an idle state with all neuromorphic cores inactive. As each core asynchronously cycles through its neurons, it generates spike messages that a mesh interconnect routes to appropriate destination cores containing all destination neurons. Implementation of multiple neurons on a single neuromorphic core may be time-multiplexed, and a time step may be defined in which all spikes involving multiple neurons may be processed and considered using shared resources of a corresponding core. As each core finishes servicing its neurons for a respective time step, cores may, in some implementations, communicate (e.g., using a handshake) with neighboring cores using synchronization messages to flush a mesh of all spike messages in flight, allowing cores to safely determine that all spikes have been serviced for a time step. At that point all cores may be considered synchronized, allowing them to advance their time step and return to an initial state and begin a next time step.

Given this context, and as introduced above, a device (e.g., 1805) implementing a mesh 1810 of interconnected neuromorphic cores may be provided, with core 1815 implementing potentially multiple artificial neurons capable of being interconnected to implement an SNN. Each neuromorphic core (e.g., 1815) may provide two loosely coupled asynchronous processes: an input dendrite process (e.g., 1880) that receives spikes from network 1810 and applies them to an appropriate destination dendrite compartments at the appropriate future times, and output soma process (e.g., 1885) that receives each dendrite compartment's accumulated neurotransmitter amounts for the current time and evolves each dendrite and soma's membrane potential state, generating outgoing spike messages at appropriate times (e.g., when a threshold potential of a soma has been reached). Note that, from a biological perspective, dendrite and soma names used here only approximate a role of these functions and should not be interpreted too literally.

In at least one embodiment, neuromorphic computing device 1805 can include one or more circuits to use a neural network to select a decoder from a plurality of decoders to decode an encoded representation of information received from an encoder or otherwise perform any of the operations described above or elsewhere herein. One or more circuits can be configured by software to use a neural network to select a decoder from a plurality of decoders to decode an encoded representation of information received from an encoder or otherwise perform any of the operations described above or elsewhere herein.

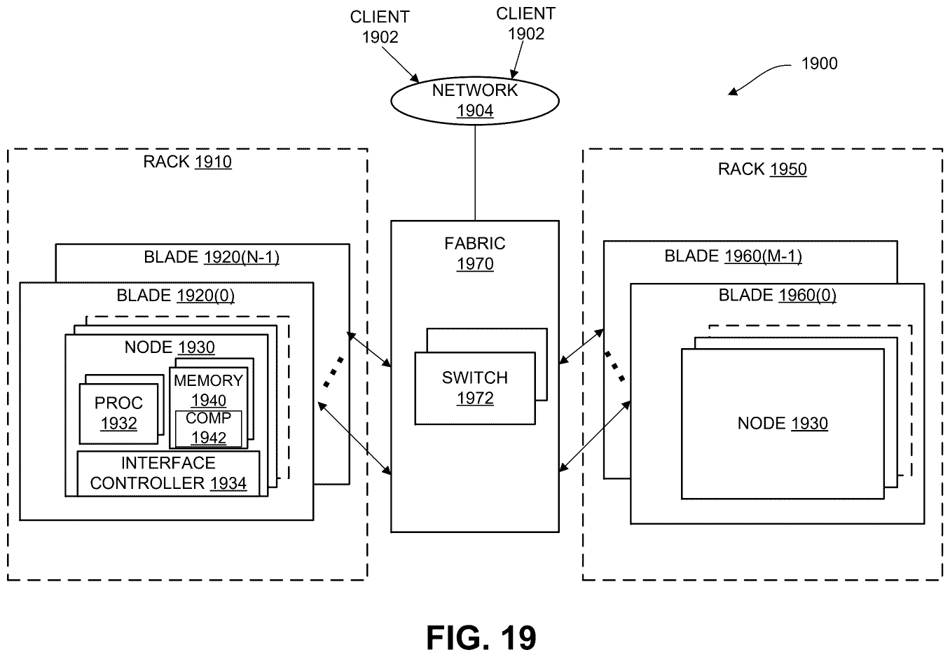

FIG. 19 is a block diagram of an embodiment of a multi-node network in which remote memory computation can be implemented, in accordance with any embodiment. System 1900 may represent a network of nodes described herein that can, e.g., be used to perform some or all of the operations described herein. System 1900 can represent a data center. System 1900 may represent a server farm. System 1900 may represent a data cloud or a processing cloud. System 1900 can represent a supercomputer. System 19 may include tens, hundreds, or thousands of nodes. Nodes of system 1900 may include processors, such as, but not limited to, central processing units (CPUs), graphics processing units (GPUs), or any combination of processors described herein, such as, but not limited to, other processors in FIGS. 13-25. With respect to any of processors in system 1900 and any of its components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of a processor or node (e.g., in cache and/or memory). A result of API(s) can then be stored in storage within or outside of a processor or node, including registers, DRAM, flash, SRAM, cache, or other memory equivalents. System 1900 may include over nine thousand nodes, with each node including two Intel Xeon Max processors, six Intel Max series GPUs and a unified memory architecture, such as, but not limited to, that used in Intel Aurora Supercomputer from Intel Corporation in Santa Clara, CA or another supercomputer that shares at least some of the components described herein.

One or more clients 1902 make requests over network 1904 to system 1900. Network 1904 represents one or more local networks, or wide area networks, or a combination. Clients 1902 can be human or machine clients, which generate requests for execution of operations by system 1900. System 1900 executes applications or data computation tasks requested by clients 1902.

System 1900 can include one or more racks, which represent structural and interconnect resources to house and interconnect multiple computation nodes. Rack 1910 can include multiple nodes 1930. Rack 1910 may host multiple blade components 1920(0) to 1920(N−1), where N is an integer greater than or equal to 2. Hosting can refer to providing power, structural or mechanical support, and interconnection. Blades 1920(0) to 1920(N−1) can refer to computing resources on printed circuit boards (PCBs), where a PCB houses hardware components for one or more nodes 1930. Blades 1920(0) to 1920(N−1) may or may not include a chassis or housing or other “box” other than that provided by rack 1910. Blades 1920(0) to 1920(N−1) may include housing with exposed connector to connect into rack 1910. System 1900 may or may not include rack 1910, and each blade (e.g., 1920(0)) can include a chassis or housing that can stack or otherwise reside in close proximity to other blades and allow interconnection of nodes 1930. System 1900 may include 10,624 compute blades, which include 63,744 Intel Max Series GPUs and 21,248 Intel Xeon Max CPUs across 166 racks.

System 1900 can include fabric 1970, which represents one or more interconnectors for nodes 1930. Fabric 1970 can include multiple switches 1972 or routers or other hardware to route signals among nodes 1930. Additionally, fabric 1970 can couple system 1900 to network 1904 for access by clients 1902. In addition to routing equipment, fabric 1970 can be considered to include cables or ports or other hardware equipment to couples nodes 1930 together. Fabric 1970 can have one or more associated protocols to manage routing of signals through system 1900. A protocol or protocols is at least partly dependent on hardware equipment used in system 1900.

As illustrated, rack 1910 can include N blades (e.g., 1920(0) to 1920(N−1)). In addition to rack 1910, system 1900 can include rack 1950. As illustrated, rack 1950 may include M blades (e.g., 1960(0) to 1960(M−1)). M is not necessarily the same as N; thus, it will be understood that various different hardware equipment components could be used, and coupled together into system 1900 over fabric 1970. Blades 1960(0) to 1960(M−1) can be the same or similar to blades 1920(0) to 1920(N−1). Nodes 1930 can be any type of node as described herein, and may not be necessarily all the same type of node. System 1900 is not limited to being homogenous, nor is it limited to not being homogenous.

A node in blade 1920(0) is illustrated in detail. However, other nodes in system 1900 can be the same or similar. At least some nodes 1930 may be computation nodes, with processor 1932 and memory 1940. A computation node refers to a node with processing resources (e.g., one or more processors) that executes an operating system and can receive and process one or more tasks. At least some nodes 1930 can include storage server nodes with a server as processing resources 1932 and memory 1940. A storage server refers to a node with more storage resources than a computation node, and rather than having processors for execution of tasks, a storage server includes processing resources to manage access to storage nodes within a storage server.

Node 1930 can include interface controller 1934, which can represent logic to control access by node 1930 to fabric 1970. Logic can include hardware resources to interconnect to physical interconnection hardware. Logic can include software or firmware logic to manage interconnection. Interface controller 1934 can include a host fabric interface, which can include a fabric interface in accordance with any embodiment described herein.

Node 1930 may include memory subsystem 1940. Memory 1940 can include memory computation resources (comp) 1942, which represent one or more capabilities by memory 1940 to perform memory computations. System 1900 enables remote memory operations, such as, but not limited to, the operations described elsewhere herein. Thus, nodes 1930 can request memory computations by remote nodes, where data for computation remains local to an executing node instead of being sent over fabric 1970 or instead of being sent from memory to a fabric interface. In response to execution of memory computation, executing node can provide a result to a requesting node.

Processor 1932 can include one or more separate processors. Each separate processor can include a single processing unit, a multicore processing unit, or a combination. A processing unit can include a primary processor such as, but not limited to, a CPU (central processing unit), a peripheral processor such as, but not limited to, a GPU (graphics processing unit), or a combination. Memory 1940 can be or include memory devices and a memory controller.

Reference to memory devices can apply to different memory types. Memory devices generally refer to volatile memory technologies. Volatile memory is memory whose state (and therefore data stored on it) is indeterminate if power is interrupted. Nonvolatile memory refers to memory whose state is determinate even if power is interrupted. Dynamic volatile memory can refresh data stored in a device to maintain state. One example of dynamic volatile memory includes DRAM (dynamic random access memory), or some variant such as, but not limited to, synchronous DRAM (SDRAM). A memory subsystem as described herein may be compatible with a number of memory technologies, such as, but not limited to, DDR3 (dual data rate version 3, original release by JEDEC (Joint Electronic Device Engineering Council) on Jun. 27, 2007, currently on release 21), DDR4 (DDR version 4, initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideI02), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (currently in discussion by JEDEC), HBM2 (HBM version 2), currently in discussion by JEDEC), or others or combinations of memory technologies, and technologies based on derivatives or extensions of such specifications.

In addition to, or alternatively to, volatile memory, in one embodiment, reference to memory devices can refer to a nonvolatile memory device whose state is determinate even if power is interrupted. In one embodiment, nonvolatile memory device is a block addressable memory device, such as, but not limited to, NAND or NOR technologies. Thus, a memory device can also include a future generation nonvolatile devices, such as, but not limited to, a three dimensional crosspoint (3DXP) memory device, other byte addressable nonvolatile memory devices, or memory devices that use chalcogenide phase change material (e.g., chalcogenide glass). In one embodiment, a memory device can be or include multi-threshold level NAND flash memory, NOR flash memory, single or multi-level phase change memory (PCM) or phase change memory with a switch (PCMS), a resistive memory, nanowire memory, ferroelectric transistor random access memory (FeTRAM), magnetoresistive random access memory (MRAM) memory that incorporates memristor technology, or spin transfer torque (STT)-MRAM, or a combination of any of the above, or other memory.

In at least one embodiment, system 1900 can include one or more circuits to use a neural network to select a decoder from a plurality of decoders to decode an encoded representation of information received from an encoder or otherwise perform any of the operations described above or elsewhere herein. One or more circuits can be configured by software to use a neural network to select a decoder from a plurality of decoders to decode an encoded representation of information received from an encoder or otherwise perform any of the operations described above or elsewhere herein.

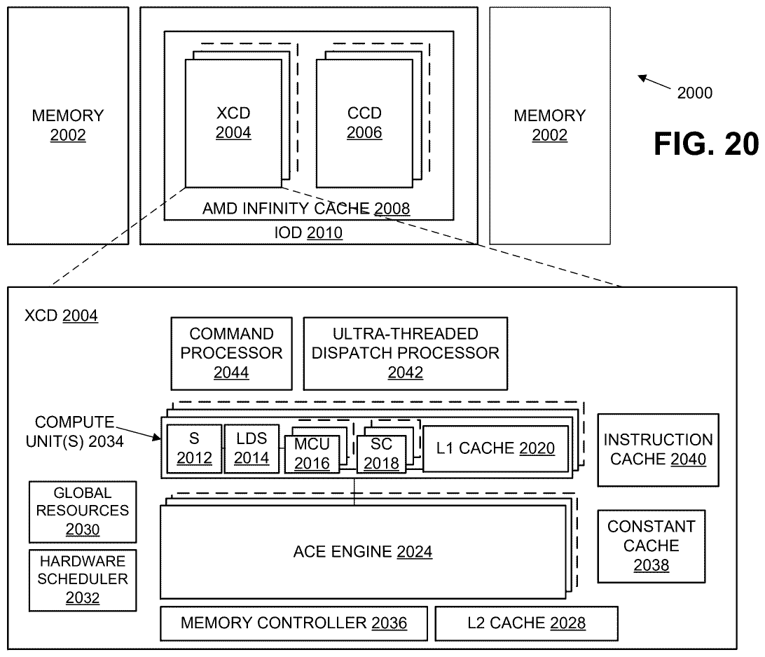

FIG. 20 illustrates accelerated processing unit 2000, in accordance with at least one embodiment. Accelerated processing unit 2000 can include a processor based on CDNA architecture from AMD Corporation in Santa Clara, CA or another processor that shares at least some of the components described herein. Accelerated processing unit 2000 can include one or more accelerator complex dies (XCDs) 2004 for performing operations described elsewhere herein, such as, but not limited to, graphics processing and/or parallel processing as well as computations with instruction-level parallelism, including support for a broad range of precisions (INT8, FP8, BF16, FP16, TF32, FP32, and FP64) and sparse matrix data (e.g., sparsity). XCDs may, in some instances, be referred to as Graphics Compute Dies (GCDs). Accelerated processing unit 2000 can include one or more complex compute dies (CCDs) 2006 for performing operations described elsewhere herein, such as, but not limited to, those operations performed by host processors. CCDs may, in some instances, be referred to as core complexes or CCXs, such as, but not limited to, CCXs used in AMD Ryzen processors. XCDs and CCDs can share any type of cache or memory (e.g., one or more memory units 2002), or have cache or memory allocated to each XCD or CCD or groups of XCDs or CCDs. For example, on-package AMD Infinity Fabric connects XCDs and CCD into shared AMD Infinity Cache 2008 and, in some embodiments, high-bandwidth memory (e.g., HMB3). Accelerated processing unit 2000 can include an AMD MI300a processor that includes three CPU chiplets (or CCDs) and six accelerator chiplets (XCDs) on top of four input-output dies (IODs) that may be layered on a piece of silicon that links them together (e.g., via AMD Infinity Fabric) to eight stacks of high-bandwidth DRAM that ring a superchip. An AMD MI300x processor substitutes CCDs for two more XCDs, for an accelerator-only system.

Accelerated processing unit 2000 can include one or more input/output (I/O) interfaces. For example, XCDs 2004 and CCDs 2006 can be together on one or more input-output dies (IODs) 2010 that can include one or more I/O interfaces. IODs 2010 can include of any number and type of I/O interfaces (e.g., PCI, PCI-Extended (“PCI-X”), PCIe, gigabit Ethernet (“GBE”), USB, etc.). Various types of peripheral devices can be coupled to I/O interfaces 2070. I/O interfaces from IODs 2010 can also be used for connected one or more accelerated processing units 2000, e.g., in a server architecture.

Accelerated processing unit 2000 can include one or more memory units 2002 for storing instructions and other information used to perform operations described elsewhere herein. Memory units 2002 can include any volatile memory, such as, but not limited to, memory types described elsewhere herein and can include, e.g., high-bandwidth memory (e.g., HMB3) or high-bandwidth DRAM. Memory associated with accelerated processing unit 2000 (e.g., memory units 2002) can include system memory that can be used, for example, for commands, instructions and constants, and inputs and outputs. Memory units 2002 can also include device memory that can be used as storage and, for example, for commands, instructions and constants, and inputs and outputs, as return buffer(s) and for private data. Memory units 2002 can be linked to one or more IODs 2010. L1 cache 2020 starts a memory hierarchy that includes shared L2 cache 2028, e.g., within XCDs. AMD Infinity Cache™, which is a last level cache (LLC) located on an active I/O die (IOD). CCDs 2006 and XCDs 2004 may have separate or shared memory. AMD Infinity Architecture and AMD Infinity Fabric™ technology can enable coherent, high-throughput unification of GPU and CPU chiplet technologies (e.g., XCDs, CCDs, and/or CCXs) with memory (e.g., stacked HBM3 memory) in single devices and across multi-device platforms.

As shown in FIG. 20, an XCD 2004 can include a shared set of global resources 2030, which can include hardware scheduler 2032 and Asynchronous Compute Engines (ACE) 2024 that send tasks (e.g., compute shader workgroups) to Compute Units (CUs or cores) 2034. ACEs 2024 (e.g., four) can be each associated with CUs 2034 (e.g., 40 CUs), and some of CUs 2034 can be disabled for yield management. CUs 2034 can have dedicated cache or share cache (e.g., L2 cache) 2028 that may be used to coalesce all memory traffic for a die. CUs 2034 can include threaded and parallel processor cores including instruction fetching and scheduling with Scheduler(S) 2012, matrix core unit (MCU) 2016 and shader core (SC) 2018 (e.g., execution units for scalar, vector and matrix data types), as well as load/store pipelines with an L1 cache 2020 and Local Data Share (LDS) 2014. Local data share can include, for example, a scratch RAM with built-in arithmetic capabilities that allow data to be shared between threads in a workgroup. An instruction cache 2040 (e.g., for storing and providing instructions for performing operations described elsewhere herein) and a constant cache 2038 can be connected to one or more CUs and can be shared between two CUs. Matrix cores 2016 can process a variety of data types, such as, but not limited to, INT8, FP8, FP16, BF16 and TF32 data types. Accelerated processing unit 2000 can include compute units 2034 that may be arranged in an array format, e.g., as a data-parallel-processor (DPP) array. Ultra-threaded dispatch processor 2042 can communicate with compute units 2034, and command processor 2044 can read commands that a host has written to memory-mapped registers in a system-memory address space (not shown). Command processor 2044 can send hardware-generated interrupts to a host processor (e.g., a CCD) when a command is completed. Memory controller 2036 can also have direct access to all device memory and host-specified areas of system memory. To satisfy read and write requests, memory controller 2036 can perform functions of a direct-memory access (DMA) controller, including computing memory-address offsets based on a format of requested data in memory. For example, one or more of APIs described herein can, for example, get compiled into instructions that can be stored in instruction cache 2040 and then fetched by instruction fetch logic in processor 2040, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of processor 2000 (e.g., in cache and/or memory). A result of API(s) can then be stored in storage within or outside of processor 2000, including registers, DRAM, flash, SRAM, cache, or other memory equivalents.

An application can include a program running on a host processor (e.g., a CCD) and programs, called kernels, running on one or more XCDs. Programs can be controlled by host commands that set internal base-address and other configuration registers, specify a data domain on which accelerated processing unit 2000 can operate, invalidate and flush caches on accelerated processing unit 2000, and cause accelerated processing unit 2000 to begin execution of a program. Kernels can be referred to as programs executed by accelerated processing unit 2000. A kernel can be executed independently on every work item, or as groups of work-items that can be referred to as a wavefront, which can execute a kernel on all work-items in a group (e.g., 64) in one pass. Compute units 2034 can include a scalar arithmetic logic unit (ALU), which can operates on one value per wavefront (common to all work items), a vector ALU, which can operate on unique values per work-item, a local data share 2014, which can allow work-items within a workgroup to communicate and share data, a scalar memory (not shown), which can transfer data between scalar general-purpose registers (SGPRs) and memory through a cache, and vector memory, which can transfer data between vector general-purpose registers (VGPRs) and memory, including sampling texture maps. Kernel control flow can be handled using scalar ALU instructions, which can includes if/else, branches and looping. Scalar ALU (SALU) and memory instructions can work on an entire wavefront and operate on one or more SGPRs. Vector memory and ALU instructions can operate on all work-items in a wavefront at one time.

In at least one embodiment, accelerated processing unit 2000 can include one or more circuits to use a neural network to select a decoder from a plurality of decoders to decode an encoded representation of information received from an encoder or otherwise perform any of the operations described above or elsewhere herein. One or more circuits can be configured by software to use a neural network to select a decoder from a plurality of decoders to decode an encoded representation of information received from an encoder or otherwise perform any of the operations described above or elsewhere herein.

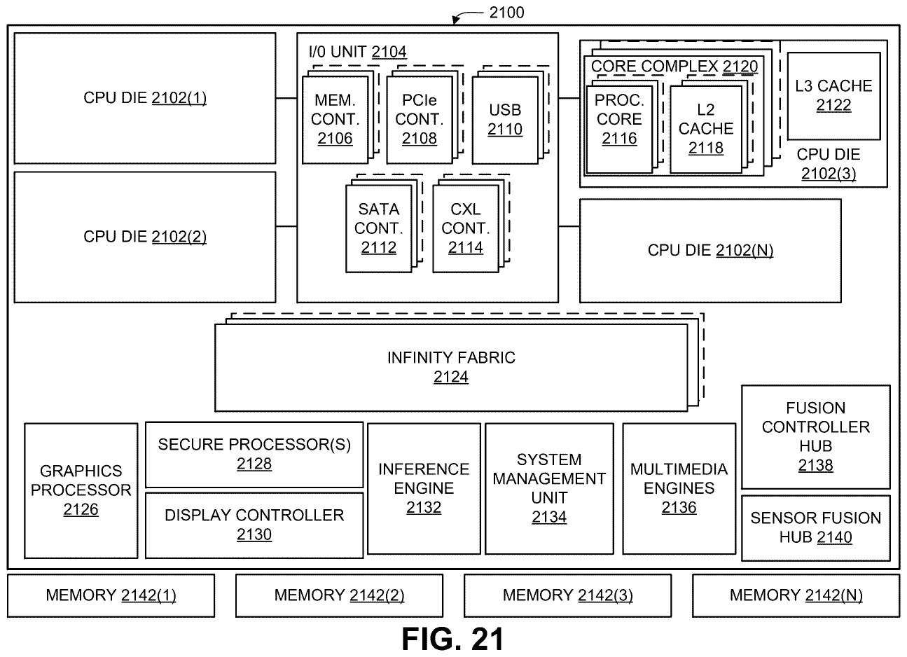

FIG. 21 illustrates a processor 2100, such as, but not limited to, a processor based on a Zen architecture (such as, e.g., Zen 1, 2, 3, 4, 5 or other) from AMD Corporation in Santa Clara, CA or another processor that shares at least some of the components described herein. Processor 2100 includes one or more CPU dies 2102(1)-2102(N), where N is any integer greater than 1. CPU die 2102 can include any number of processor cores 2116 (e.g., to perform any of the operations described elsewhere herein) and any number of cache memories (e.g., to store instructions and other information to perform any of the operations described elsewhere herein), in any combination. For example, L2 Cache units 2118 can be coupled to processor core(s) 2116, which can share and/or couple individually to L2 Cache units 2118. Processor cores 2116 can couple to L3 cache 2122 individually and/or share L3 Cache, which can be a lowest level cache (LLC) 2122 for access to data and other information used by processor cores 2116. One or more processor cores 2116 and one or more L2 Cache units 2118 can be included in a core complex (CCX) 2120 that can include (e.g., a 32 MB) shared cache (e.g., L3 cache 2122). Core complex 2120 can be fabricated onto a die (CCD or CPU die) 2102. For example, up to 12 core complexes 2120 can be configured into a processor along with 8 CPU dies 2102 to provide up to 96 processor cores 2116 for processor 2100. A ‘Zen 4c’ core complex 2120, for example, can include up to eight cores 2116 and a shared 16 MB L3 cache 2122. Two of these core complexes 2120 can be combined onto a single CPU die 2102 for 16 cores per die and a total of 32 MB of L3 cache 2122 per die. Up to eight of CPU dies 2102 may be combined with an I/O unit 2104 to provide CPUs with up to 128 processor cores 2116. Up to four ‘Zen 4c’ dies described above can be combined to provide CPUs with up to 64 processor cores 2116.

Processor 2100 can include a variety of configurations for input/output operations that are described further herein. I/O unit 2104 can include one or more memory controllers 2106 that can manage memory usage (e.g., DDR5 memory) for processor 2100. I/O unit 2104 may include one or more SATA disk controllers for managing storage 2112 and one or more Compute Express Link (CXL™) 1.1+ memory controllers 2114 that can provide CPU-to-device and CPU-to-memory connections and can be flexibly assigned to specific functions at server design time. I/O unit 2104 may include PCIe controller 2108 for connecting peripherals and other components connected to processor 2100. I/O unit 2104 may include USB ports 2110 for connecting to other components separate from processor 2100. CPU dies 2102 can support any number of connections, e.g., one or two connections, to I/O unit 2104. As shown, I/O unit 2104 can include components described further herein, and I/O unit 2104 can be a I/O die that houses several different components. Memory controller 2106, PCIe controller 2108, USB ports 2110, SATA controller 2112, and/or CXL controller 2114 can be integrated anywhere within processor 2100 either separately or in any groups or combinations thereof.

Processor 2100 can include Infinity Fabric 2124 interconnects (which can be similar to or based on PCIe architectures) that can provide connections among CPUs (e.g., CPU dies 2102(1)-2102(N)), graphics processor(s) 2126, inference engine(s) 2132, and other components in a multi-chip architecture, such as secure processor(s) 2128 and I/O unit 2104. One or more AMD Infinity Fabric™ interconnects 2110 can connect to CPU dies 2102(1)-2102(N) and serve as a connection that is used between CPUs. One or more Infinity Fabric connections 2110 can connect each CPU die 2102 to I/O unit 2110.

In at least one embodiment, processor 2100 can include central processing units (CPUs) and other associated hardware and software described above and further herein. Processor 2100 can also include graphics processor(s) 2126. Graphics processor 2126 can be used for image generation and processing, as well as other computations and operations described further herein. Graphics processor 2126 can be based on RDNA 3 or 3.5 architecture from AMD in Santa Clara, CA. Graphics processor 2126 can include graphics compute dies (GCDs) and memory cache dies (MCDs). GCDs can include any number of compute units (CUs) for graphics or other processing, such as operations performed by arithmetic logic units (ALUs) that are described further herein. Graphics processor 2126 can include L2 cache that can be used by compute units. MCDs (not shown) can include any number of memory units and can include cache, such as L3 cache, as well as memory interfaces for coupling to memory, such as memory 2142(1)-(N), where Nis an integer. Components within graphics processor 2126 can be connected using various approaches, such as using Infinity Fabric 2124 interconnects outside or within graphics processor 2126.

Inference engine 2132 can provide neural processing capabilities for processor 2100 for computational processes that are used for neural networks, deep learning, and other artificial intelligence-related operations described further herein. Processor 2100 can include secure processor(s) 2128 for managing security of processor 2100, display controller 2130 for controlling displays, a system management unit 2134 for managing and operating some or all of the components on processor 2100, multimedia engines 2136 for audio and video operations, fusion controller hub 2138 for managing USB, SATA and PCIe connections to processor 2100, and sensor fusion hub 2140 for managing sensors, such as accelerometers. Processor 2100 can also include memory 2142(1)-(N), where N is any integer. Memory can include different memory types, such as LPDDR5 and/or DDR5, or others described elsewhere herein.

For performing operations described further herein, processor 2100 can include an execution pipeline including a front-end that can include a cache (e.g., L1 cache) that stores instructions (not shown). Flow of instructions can be modified by a branch predictor. Instructions can be decoded by a decoder, dispatched to a back-end for execution, and renamed. Instruction fetch and decode pipes, for example, can be dispatched to integer or floating point execution operations that can be scheduled by a scheduler and transferred to vector and/or general-purpose registers. Floating point multiplier and/or add operations can be processed, and arithmetic logic units (ALUs) can also be used to perform computations, such as arithmetic and logic operations. Outputs from computation units can be coupled to a load/store queue, which can be connected to cache, such as L1 cache and/or L2 cache.

With respect to processor 2100 and any of its components described above or elsewhere herein, one or more of APIs or equivalents described herein can, for example, get compiled into instructions or equivalents (e.g., AVX-512 instructions based on an SIMD model), which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of processor 2100 (e.g., in cache and/or memory). A result of API(s) can then be stored in storage within or outside of processor 2100, including registers, DRAM, flash, SRAM, cache, or other memory equivalents.

In at least one embodiment, processor 2100 can include one or more circuits to use a neural network to select a decoder from a plurality of decoders to decode an encoded representation of information received from an encoder or otherwise perform any of the operations described above or elsewhere herein. One or more circuits can be configured by software to use a neural network to select a decoder from a plurality of decoders to decode an encoded representation of information received from an encoder or otherwise perform any of the operations described above or elsewhere herein.

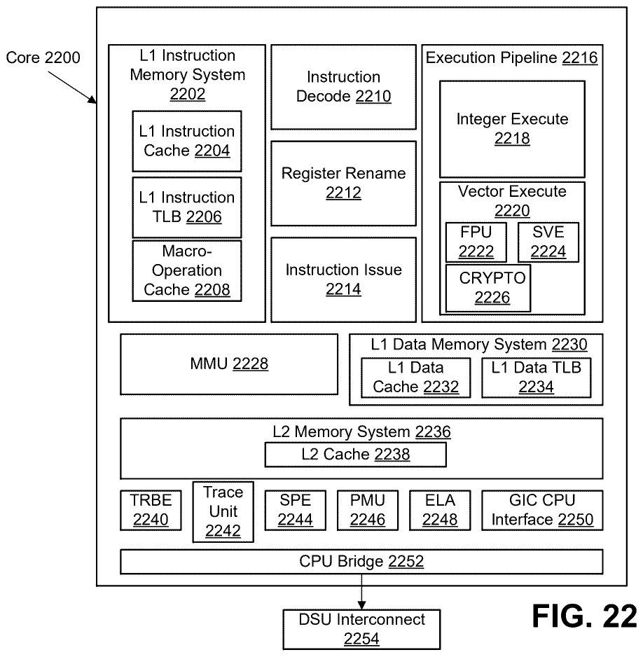

FIG. 22 illustrates an example of a processing core 2200 that may implement Arm architecture (e.g., v9.0-A) or another processor that shares at least some of the components described herein. Neoverse™ V2 core 2200 can be implemented inside a DynamIQ Shared Unit (DSU) cluster via DSU-110 interconnect 2254 for connected one or more cores, e.g., for parallel processing. Neoverse™ V2 core may be implemented as a single core in a DSU cluster that is configured for Direct connect, with or without L3 cache, snoop filter, or Snoop Control Unit (SCU) logic (not shown). Neoverse™ V2 core can include a CPU bridge 2252 that connects core 2200 to DSU-110 interconnect, which can also connect core 2200 to an external memory system and the rest of a system-on-a-chip. L1 instruction memory system 2202 can fetch instructions from an instruction cache 2204 and deliver instructions (e.g., one or more APIs described herein that may be compiled into instructions) to an instruction decode unit 2210, e.g., to perform some or all of operations described above or elsewhere herein. L1 instruction memory system 2202 may include L1 instruction cache 2204, e.g., with 64-byte cache lines, L1 instruction Translation Lookaside Buffer (TLB) 2206, e.g., with native support for 4 KB, 16 KB, 64 KB, and 2 MB page sizes, Macro-Operation Cache (MOP) 2208 (e.g., 1536-entry, 4-way skewed associative L0 MOP cache), which can contain decoded and optimized instructions for higher performance. Instruction decode unit 2210 can decode AArch64 instructions into internal format. Register rename unit 2212 can perform register renaming to facilitate out-of-order execution and dispatches decoded instructions to various issue queues. Instruction issue unit 2214 can control when decoded instructions may be dispatched to execution pipelines, and it can include issue queues for storing instructions pending dispatch to execution pipelines. Integer execution pipeline 2216 can be included in an execution pipeline and include integer execute unit 2218 that can perform arithmetic and logical data processing operations. Vector execute unit 2220 can be included in an execution pipeline and can perform Advanced SIMD and floating-point operations (FPU) 2222, execute Scalable Vector Extension (SVE) and Scalable Vector Extension 2 (SVE2) instructions 2224, and can optionally execute cryptographic instructions (Crypto) 2226. Advanced SIMD can include media and signal processing architecture that adds instructions primarily for audio, video, 3D graphics, image, and speech processing. A floating-point architecture provides support for single-precision and double-precision floating-point operations. L1 data memory system 2230 can execute load and store instructions, as well as service memory coherency requests. L1 data memory system 2230 can include an L1 data cache 2232 and a fully associative L1 data TLB 2234 with native support for 4 KB, 16 KB and 64 KB page sizes and 2 MB and 512 MB block sizes. Memory Management Unit (MMU) 2228 can provide fine-grained memory system control through a set of virtual-to-physical address mappings and memory attributes that can be held in translation tables, which can be saved into TLB 2234 when an address is translated. L2 memory system 2236 can include L2 cache 2238, and it can be connected to DSU-110 2254 through an asynchronous CPU bridge 2252. Neoverse™ V2 core 2200 can support a range of debug, test, and trace options including a trace unit 2242 and a trace buffer 2240, and an Embedded Logic Analyzer (ELA) 2248. Neoverse™ V2 core 2200 can implement Statistical Profiling Extension (SPE) 2244 to provide a statistical view of the performance characteristics of executed instructions that software writers can use to optimize their code for better performance. Performance Monitoring Unit (PMU) 2246 can provide performance monitors that can be configured to gather statistics on operation of each core and memory system. Information can be used for debug and code profiling. Generic Interrupt Controller (GIC) CPU interface 2250, when integrated with an external distributor component, can be a resource for supporting and managing interrupts in a cluster system. In a cluster, there can be one CPU bridge 2252 between each Neoverse™ V2 core 2200 and DSU-110 2254. CPU bridge 2252 can control buffering and synchronization between core 2200 and DSU-110 2254. CPU bridge 2252 can be asynchronous to allow different frequency, power, and area implementation points for each core 2200. CPU bridge 2252 can run synchronously without affecting other interfaces such as, but not limited to, debug and trace which can be asynchronous.

In at least one embodiment, core 2200 can include one or more circuits to use a neural network to select a decoder from a plurality of decoders to decode an encoded representation of information received from an encoder or otherwise perform any of the operations described above or elsewhere herein. One or more circuits can be configured by software to use a neural network to select a decoder from a plurality of decoders to decode an encoded representation of information received from an encoder or otherwise perform any of the operations described above or elsewhere herein.

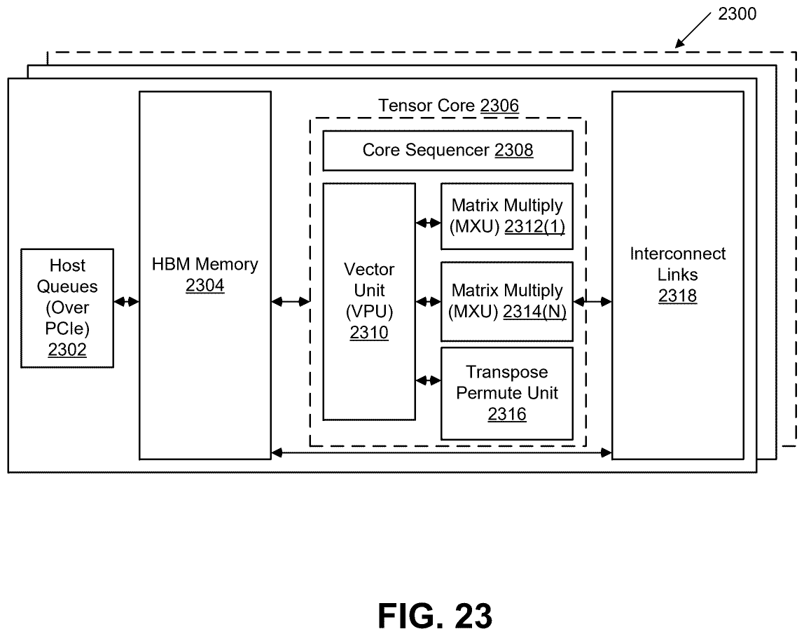

FIG. 23 illustrates one or more chips including one or more tensor processing units (TPUs) 2300, in accordance with at least one embodiment. TPUs 2300 in FIG. 23 can include application specific integrated circuits (ASICs), e.g., to perform some or all of the operations described above or elsewhere herein, such as, but not limited to, accelerate machine learning workloads performing matrix operations. TPUs 2300 may be ASICs from Alphabet Corporation in Mountain View, CA. Cloud TPU includes a cloud service that makes TPUs available as a scalable resource for processing tasks, such as, but not limited to, machine learning workloads that can run on frameworks such as, but not limited to, TensorFlow, Pytorch, and JAX.

Chip 2300 can include any number of TPUs that can include tensor cores 2306. Tensor core 2306 can include one or more core sequencer 2308, vector processing unit (VPU) 2310, matrix multiply unit (MXU) 2312(A)-2314(N), where N is any integer greater than 1, and a transpose permute unit 2316. Core Sequencer 2308 can fetch (e.g., VLIW (Very Long Instruction Word)) instructions from core's 2306 Instruction Memory (Imem), execute scalar operations using a scalar data memory (Smem) and scalar registers (Sregs) (not shown), and forward vector instructions to Vector Processing Unit (VPU) (2310. Instructions can, for example, launch eight operations: two scalar, two vector ALU, vector load and store, and a pair of slots that queue data to and from matrix multiply and transpose units. VPU 2310 can perform vector operations using a large on-chip vector memory (Vmem), and vector registers (Vregs). VPU 2310 can stream data to and from MXU through decoupling FIFOs. VPU 2310 can collect and distribute data to Vmem via data-level parallelism (2D matrix and vector functional units) and instruction-level parallelism (8 operations per instruction). A large two-dimensional matrix multiply unit (MXU) 2312(A)-2312(N) can, e.g., use a systolic array to reduce area and energy plus large, software-controlled on-chip memories instead of caches. Transpose Reduction Permute Unit 2316 can do (e.g., 128×128) matrix transposes, reductions, and permutations of VPU 2310 lanes. High Bandwidth Memory 2304 can be used for applications on chip, and it can be coupled to host queue(s) 2302, e.g., over PCIe. One or more chips 2300 can be connected together for computing. For example, one or more chips 2300 can be connected as a torus, e.g., a 2D torus. Chip 2300 can also include any number (e.g., four) Inter-Core Interconnect (ICI) links 2318 that can enable direct connections between chips to form a supercomputer.

With respect to any processors in chip 2300 and any of its components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of any processors in chip 2300 (e.g., in cache and/or memory). A result of API(s) can then be stored in storage within or outside of any processors in chip 2300, including registers, DRAM, flash, SRAM, cache, or other memory equivalents.

In at least one embodiment, chip 2300 can include one or more circuits to use a neural network to select a decoder from a plurality of decoders to decode an encoded representation of information received from an encoder or otherwise perform any of the operations described above or elsewhere herein. One or more circuits can be configured by software to use a neural network to select a decoder from a plurality of decoders to decode an encoded representation of information received from an encoder or otherwise perform any of the operations described above or elsewhere herein.

### Software Constructions

The following figures set forth, without limitation, examples of software constructs for implementing at least one embodiment.

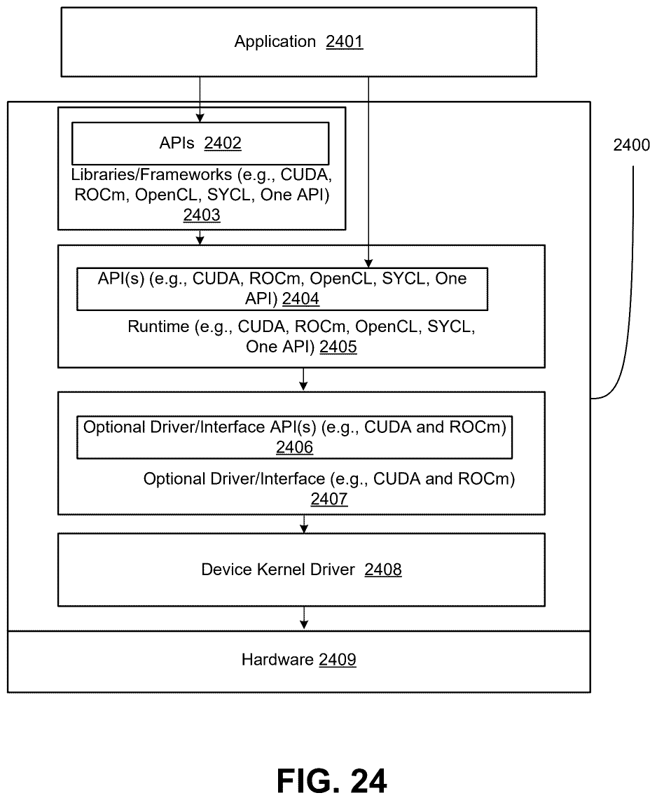

FIG. 24 illustrates a software stack of a programming platform, in accordance with at least one embodiment. A programming platform can include a platform for leveraging hardware on a computing system to accelerate computational tasks. A programming platform may be accessible to software developers through libraries, compiler directives, and/or extensions to programming languages, in at least one embodiment. A programming platform may be CUDA, Radeon Open Compute Platform (“ROCm”), OpenCL (OpenCL™ is developed by Khronos group), SYCL, or Intel oneAPI.

A software stack 2400 of a programming platform can provide an execution environment for an application 2401. Application 2401 may include any computer software capable of being launched on software stack 2400. Application 2401 may include an artificial intelligence (“AI”)/machine learning (“ML”) application, a high performance computing (“HPC”) application, a virtual desktop infrastructure (“VDI”), or a data center workload.

Application 2401 and software stack 2400 run on hardware 2408. Hardware 2408 may include one or more GPUs, CPUs, FPGAs, AI engines, and/or other types of compute devices that support a programming platform. Software stack 2400 may be vendor specific and compatible with only devices from particular vendor(s), such as CUDA, ROCm, OneAPI, OpenCL, or other implementations. Hardware 2408 can include a host connected to one more devices that can be accessed to perform computational tasks via application programming interface (“API”) calls. A device within hardware 2408 may include a GPU, FPGA, AI engine, or other compute device (but may also include a CPU) and its memory, as opposed to a host within hardware 2408 that may include a CPU (but may also include a compute device) and its memory, in at least one embodiment. With respect to any hardware 2408 described above or elsewhere herein, one or more of APIs described herein can, for example, get compiled into instructions, which may be fetched by instruction fetch logic, decoded by a processor decoder, scheduled (e.g., in order or out of order) for execution by a scheduler, executed by execution logic, reordered, and then retired by retirement logic. API(s) (and/or compiled instructions including API(s)) can be stored in any storage outside or inside of hardware 2408 (e.g., in cache and/or memory). A result of API(s) can then be stored in storage within or outside of hardware 2408, including registers, DRAM, flash, SRAM, cache, or other memory. One or more of APIs described herein can receive a call. One or more of APIs described herein can communicate with a library or a portion of a library to perform a function described by the call. One or more of APIs described herein can receive a call and communicate with a library or portion of a library to perform a function described by the call.

Software stack 2400 of a programming platform can include a number of libraries 2403, a runtime 2405, an optional driver/interface 2407, and a device kernel driver 2408. Each of libraries 2403 may include data and programming code that can be used by computer programs and leveraged during software development. Libraries 2403 may include pre-written code and subroutines, classes, values, type specifications, configuration data, documentation, help data, and/or message templates. Libraries 2403 can include functions that may be optimized for execution on one or more types of devices. Libraries 2403 may include functions for performing mathematical, deep learning, and/or other types of operations on devices. Libraries 2403 can be associated with corresponding APIs 2402, which may include one or more APIs, that expose functions implemented in libraries 2403. A processor (e.g. CPU, GPU) may perform, call, or otherwise use one or more APIs to prioritize kernels. For example, a first kernel (e.g., parent) can launch a second kernel (e.g., child kernel), and said second kernel can be used by a processor to launch additional kernels (e.g., grandchildren kernels) independent of said first kernel. A processor may perform an API or calls an API from memory to be performed to support dynamic stream priority (e.g., updating priority while a stream is being used to perform operations). For example, when a processor performs said API, it allows a programmer to copy stream priority from one stream to one or more other streams.

Software stack 2400 may include an API to support dynamic stream priority (e.g., updating priority while a stream is being used to perform operations), which can allow a programmer to set priority of a stream at any time after creation. Software stack 2400 can include an API to support dynamic stream priority (e.g., updating priority while the stream is being used to perform operations), which may allow a programmer to obtain current priority of a stream, where the priority is one of a plurality of attributes of a stream. Software stack 2400 can include an API to support dynamic stream priority (e.g., updating priority while the stream is being used to perform operations), which may allow a programmer to obtain current priority of a stream as a single attribute. Software stack 2400 can include an API to support dynamic stream priority (e.g., updating priority while the stream is being used to perform operations), which allows a programmer to launch a kernel to perform operations on a stream at a set priority, which may be different from the stream priority. Software stack 2400 may include an API to indicate whether an object (e.g., a thread synchronization object such as, but not limited to, a barrier) tracks whether all data movement operations for a set of threads operating on a GPU may be complete has a specified state after a specified period of time, where a specified state can be a state indicating that data has been moved and is ready for use, and is specified using an expected parity value as an input to the API.

Software stack 2400 can include one or more APIs to updated kernels. A processor can perform an API or call an API from memory to be performed to update to an existing API is to support context-free kernels, which may allow a programmer to add a kernel node to a graph without a graphics context, so that a graphics context can be dynamically associated with a kernel at runtime. Software stack 2400 may include one or more APIs to allow a programmer to obtain a kernel identifier and a graphics context as separate parameters from a kernel node, so that parameters to be obtained from kernels and from context-free kernels. Software stack 2400 can include one or more APIs to use parallel processor(s), such as, but not limited to, one or more graphics processing units, to launch task graphs (e.g., task graphs) and to execute one or more task graphs (e.g., including one or more programs).

Software stack 2400 may include one or more APIs to associate one or more instructions with one or more memory ordering operations, such as, but not limited to, a fence or membar operation. Instructions can be associated with one or more domains such that a memory ordering operation is executed in association to one or more particular domains without interfering with instructions of other domains. An API can indicate a thread has arrived (e.g., at a thread synchronization barrier), or finished a stage of work in relation to asynchronous data movement operations on a GPU. Software stack 2400 may include one or more to allow programmers to manually indicate an expected transaction count when a thread has finished a stage of work, which can be used to update an object that tracks whether all data movement operations for a set of threads may be complete.

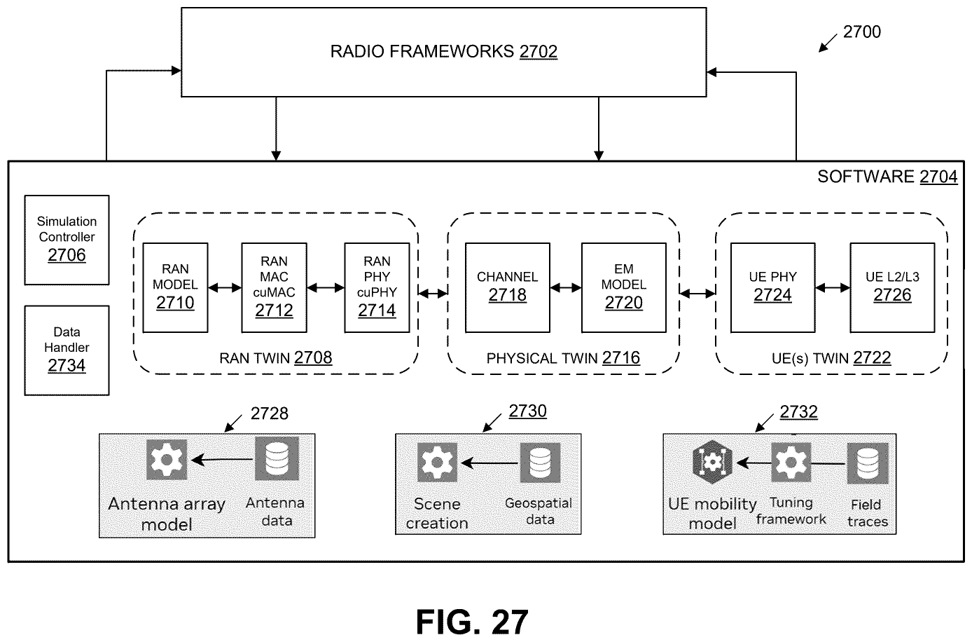

Application 2401 can be written as source code that is compiled into executable code, as discussed in greater detail below in conjunction with FIGS. 27 and 28. Executable code of application 2401 may run, at least in part, on an execution environment provided by software stack 2400. During execution of application 2401, code may be reached that needs to run on a device, as opposed to a host. In such a case, runtime 2405 may be called to load and launch requisite code on a device. Runtime 2405 may include any technically feasible runtime system that is able to support execution of application 2401.

Runtime 2405 can be implemented as one or more runtime libraries associated with corresponding APIs, which are shown as API(s) 2404. One or more of such runtime libraries may include functions for memory management, execution control, device management, error handling, and/or synchronization, among other things,. Memory management functions may include functions to allocate, deallocate, and copy device memory, as well as transfer data between host memory and device memory. Execution control functions may include functions to launch a function (sometimes referred to as a “kernel” when a function is a global function callable from a host) on a device and set attribute values in a buffer maintained by a runtime library for a given function to be executed on a device.

Runtime libraries and corresponding API(s) 2404 may be implemented in any technically feasible manner. One (or any number of) API may expose a low-level set of functions for fine-grained control of a device, while another (or any number of) API may expose a higher-level set of such functions. A high-level runtime API may be built on top of a low-level API. One or more of runtime APIs may be language-specific APIs that may be layered on top of a language-independent runtime API.

An optional driver or interface 2407 may be implemented, e.g., for CUDA and ROCm implementations, that are described further below. Optional driver/interface 2407 may be associated with optional driver or interface API(s), such as, but not limited to, CUDA and/or ROCm API(s).

One or more processors disclosed in “processing systems” can perform, access, or otherwise use software stack 2400. For example, system-on-a-chip 1300, parallel processor 1400, graphics multiprocessor 1434, processor 1500, processor 1600, accelerator 1700, neuromorphic processor 1805, supercomputer 1900, acceleration processing unit 2000, processor 2100, processor 2200, tensor processing unit 2300, processor 2400, and language processing unit 2500 can perform, use, call, or otherwise implement (e.g., through accessing a memory) one or more APIs included in software stack 2400.

Device kernel driver 2408 can be configured to facilitate communication with an underlying device. Device kernel driver 2408 may provide low-level functionalities upon which APIs, such as, but not limited to, API(s) 2404, and/or other software relies. Device kernel driver 2408 may be configured to compile intermediate representation (“IR”) code into binary code at runtime. For CUDA or other implementations such as, but not limited to, ROCm, OneAPI, or OpenCL, device kernel driver 2408 may compile Parallel Thread Execution (“PTX”) IR code that is not hardware specific into binary code for a specific target device at runtime (with caching of compiled binary code), which is also sometimes referred to as “finalizing” code. Doing so may permit finalized code to run on a target device, which may not have existed when source code was originally compiled into PTX code. Alternatively, device source code may be compiled into binary code offline, without requiring device kernel driver 2408 to compile IR code at runtime.

Processors described elsewhere herein, such as, but not limited to, processors in FIGS. 13-25 can include one or more circuits to use a neural network to select a decoder from a plurality of decoders to decode an encoded representation of information received from an encoder or otherwise perform any of the operations described above or elsewhere herein. One or more circuits can be configured by software, e.g., software stack 2400 to use a neural network to select a decoder from a plurality of decoders to decode an encoded representation of information received from an encoder or otherwise perform any of the operations described above or elsewhere herein.

In accordance with at least one embodiment, software stack 2400 of FIG. 24 can be performed in a CUDA implementation. A CUDA software stack 2400, on which an application 2401 may be launched, may include CUDA libraries 2403, a CUDA runtime 2405, a CUDA driver 2407, and a device kernel driver 2408. CUDA software stack 2400 can execute on hardware (e.g., graphics multiprocessor 1434 that may include a GPU that supports CUDA and is developed by NVIDIA Corporation of Santa Clara, CA.

Application 2401, CUDA runtime 2405, and device kernel driver 2408 can perform functionalities that are described above and elsewhere herein. CUDA driver 2407 can include a library (libcuda.so) that may implement a CUDA driver API 2406. Similar to a CUDA runtime API 2404 implemented by a CUDA runtime library (cudart), CUDA driver API 2406 may expose functions for memory management, execution control, device management, error handling, synchronization, and/or graphics interoperability, among other things. CUDA driver API 2406 can differ from CUDA runtime API 2404 in that CUDA runtime API 2404 simplifies device code management by providing implicit initialization, context (analogous to a process) management, and module (analogous to dynamically loaded libraries) management. In contrast to high-level CUDA runtime API 2404, CUDA driver API 2406 can be a low-level API providing more fine-grained control of a device, particularly with respect to contexts and module loading. CUDA driver API 2406 may expose functions for context management that may be not exposed by CUDA runtime API 2404. CUDA driver API 2406 may also be language-independent and support, e.g., OpenCL, in addition to CUDA runtime API 2404. Further, development libraries, including CUDA runtime 2405, may be considered as separate from driver components, including user-mode CUDA driver 2407 and kernel-mode device driver 2408 (also sometimes referred to as a “display” driver).

CUDA libraries 2403 may include mathematical libraries, deep learning libraries, parallel algorithm libraries, and/or signal/image/video processing libraries, which parallel computing applications such as, but not limited to, application 2401 may utilize. CUDA libraries 2403 may include mathematical libraries such as, but not limited to, a cuBLAS library that is an implementation of Basic Linear Algebra Subprograms (“BLAS”) for performing linear algebra operations, a cuFFT library for computing fast Fourier transforms (“FFTs”), and a cuRAND library for generating random numbers, among others. CUDA libraries 2403 may include deep learning libraries such as, but not limited to, a cuDNN library of primitives for deep neural networks and a TensorRT platform for high-performance deep learning inference, among others.

In at least one embodiment, processors described elsewhere herein, such as, but not limited to, processors in FIGS. 13-25 can include one or more circuits to use a neural network to select a decoder from a plurality of decoders to decode an encoded representation of information received from an encoder or otherwise perform any of the operations described above or elsewhere herein. One or more circuits can be configured by software, e.g., software stack 2400 to use a neural network to select a decoder from a plurality of decoders to decode an encoded representation of information received from an encoder or otherwise perform any of the operations described above or elsewhere herein.

In accordance with at least one embodiment, software stack 2400 of FIG. 24 can be performed in a ROCm implementation. A ROCm software stack 2400, on which an application 2401 may be launched, includes a language runtime 2403, a system runtime 2405, a thunk 2407, and a ROCm kernel driver 2408. ROCm software stack 2400 executes on hardware 2409, which may include a GPU that supports ROCm and is developed by AMD Corporation of Santa Clara, CA.

Application 2401 may perform similar functionalities as discussed above in conjunction with FIG. 24. In addition, language runtime 2403 and system runtime 2405 may perform similar functionalities as runtime 2405 discussed above in conjunction with FIG. 24. Language runtime 2403 and system runtime 2405 may differ in that system runtime 2405 is a language-independent runtime that implements a ROCr system runtime API 2404 and makes use of a Heterogeneous System Architecture (“HSA”) Runtime API. HSA runtime API can include a thin, user-mode API that exposes interfaces to access and interact with an AMD GPU, including functions for memory management, execution control via architected dispatch of kernels, error handling, system and agent information, and runtime initialization and shutdown, among other things. In contrast to system runtime 2405, language runtime 2403 can be an implementation of a language-specific runtime API 2402 layered on top of ROCr system runtime API 2404. Language runtime API may include a Heterogeneous compute Interface for Portability (“HIP”) language runtime API, a Heterogeneous Compute Compiler (“HCC”) language runtime API, or an OpenCL API, among others. HIP language in particular is an extension of C++ programming language with functionally similar versions of CUDA mechanisms, and a HIP language runtime API may include functions that may be similar to those of CUDA runtime API discussed above in conjunction with FIG. 24, such as, but not limited to, functions for memory management, execution control, device management, error handling, and synchronization, among other things.

Thunk (ROCt) 2407 can be an interface 2406 that can be used to interact with underlying ROCm driver 2408. ROCm driver 2408 can be a ROCK driver, which is a combination of an AMDGPU driver and a HSA kernel driver (amdkfd). AMDGPU driver can be a device kernel driver for GPUs developed by AMD that performs similar functionalities as device kernel driver 2409 discussed above in conjunction with FIG. 24. HSA kernel driver can be a driver permitting different types of processors to share system resources more effectively via hardware features.

Various libraries (not shown) may be included in ROCm software stack 2400 above language runtime 2403 and provide functionality similar to CUDA libraries 2403, discussed above in conjunction with FIG. 24. Various libraries may include mathematical, deep learning, and/or other libraries such as, but not limited to, a hipBLAS library that implements functions similar to those of CUDA cuBLAS, a rocFFT library for computing FFTs that is similar to CUDA cuFFT, among others.

Processors described elsewhere herein, such as, but not limited to, processors in FIGS. 13-25 can include one or more circuits to use a neural network to select a decoder from a plurality of decoders to decode an encoded representation of information received from an encoder or otherwise perform any of the operations described above or elsewhere herein. One or more circuits can be configured by software, e.g., software stack 2400 to use a neural network to select a decoder from a plurality of decoders to decode an encoded representation of information received from an encoder or otherwise perform any of the operations described above or elsewhere herein.

In accordance with at least one embodiment, software stack 2400 of FIG. 24 can be performed in a OpenCL implementation. An OpenCL software stack 2400, on which an application 2401 may be launched, can include an OpenCL framework 2403, an OpenCL runtime 2405, and a driver 2408. OpenCL software stack 2400 may execute on hardware 2409 that is not vendor-specific. As OpenCL is supported by devices developed by different vendors, specific OpenCL drivers may be required to interoperate with hardware from such vendors.

Application 2401, OpenCL runtime 2405, device kernel driver 2408, and hardware 2409 may perform similar functionalities as other implementations of application 2401, runtime 2405, device kernel driver 2408, and hardware 2409, respectively, that are discussed above in conjunction with FIG. 24. Application 2401 can further include an OpenCL kernel (not shown) with code that is to be executed on a device.

OpenCL may define a “platform” that allows a host to control devices connected to a host. An OpenCL framework can provide a platform layer API and a runtime API, shown as platform API 2402 and runtime API 2404. Runtime API 2404 can use contexts to manage execution of kernels on devices. Each identified device may be associated with a respective context, which runtime API 2404 may use to manage command queues, program objects, and kernel objects, share memory objects, among other things, for that device. Platform API 2402 can expose functions that permit device contexts to be used to select and initialize devices, submit work to devices via command queues, and enable data transfer to and from devices, among other things. In addition, OpenCL framework can provide various built-in functions (not shown), including math functions, relational functions, and image processing functions, among others.

A compiler (not shown) can also be included in OpenCL framework 2403. Source code may be compiled offline prior to executing an application or online during execution of an application. In contrast to CUDA and ROCm, OpenCL applications may be compiled online by a compiler that is representative of any number of compilers that may be used to compile source code and/or IR code, such as, but not limited to, Standard Portable Intermediate Representation (“SPIR-V”) code, into binary code. Alternatively, OpenCL applications may be compiled offline, prior to execution of such applications.

In at least one embodiment, processors described elsewhere herein, such as, but not limited to, processors in FIGS. 13-25 can include one or more circuits to use a neural network to select a decoder from a plurality of decoders to decode an encoded representation of information received from an encoder or otherwise perform any of the operations described above or elsewhere herein. One or more circuits can be configured by software, e.g., software stack 2400 to use a neural network to select a decoder from a plurality of decoders to decode an encoded representation of information received from an encoder or otherwise perform any of the operations described above or elsewhere herein.

In accordance with at least one embodiment, software can be supported by a programming platform that is configured to support various programming models, middlewares and/or libraries, and frameworks that an application may rely upon. Application may be an AI/ML application implemented using, for example, a deep learning framework such as, but not limited to, MXNet, PyTorch, or TensorFlow, which may rely on libraries such as, but not limited to, cuDNN, NVIDIA Collective Communications Library (“NCCL”), and/or NVIDA Developer Data Loading Library (“DALI”) CUDA libraries to provide accelerated computing on underlying hardware.

Programming platform may be one of a CUDA, ROCm, or OpenCL platform described above in conjunction with FIG. 24. Programming platform can support multiple programming models, which may be abstractions of an underlying computing system permitting expressions of algorithms and data structures. Programming models may expose features of underlying hardware in order to improve performance. Programming models may include CUDA, HIP, OpenCL, C++ Accelerated Massive Parallelism (“C++ AMP”), Open Multi-Processing (“OpenMP”), Open Accelerators (“OpenACC”), and/or Vulkan Compute.

Libraries and/or middlewares may provide implementations of abstractions of programming models. Such libraries can include data and programming code that may be used by computer programs and leveraged during software development. Such middlewares can include software that provides services to applications beyond those available from programming platform. Libraries and/or middlewares may include cuBLAS, cuFFT, cuRAND, and other CUDA libraries, or rocBLAS, rocFFT, rocRAND, and other ROCm libraries. In addition, libraries and/or middlewares may include NCCL and ROCm Communication Collectives Library (“RCCL”) libraries providing communication routines for GPUs, a MIOpen library for deep learning acceleration, and/or an Eigen library for linear algebra, matrix and vector operations, geometrical transformations, numerical solvers, and related algorithms.

Application frameworks may depend on libraries and/or middlewares. Each of application frameworks can be a software framework used to implement a standard structure of application software. Returning to the AI/ML example discussed above, an AI/ML application may be implemented using a framework such as, but not limited to, Caffe, Caffe2, TensorFlow, Keras, PyTorch, or MxNet deep learning frameworks, for example.

In at least one embodiment, processors described elsewhere herein, such as, but not limited to, processors in FIGS. 13-25 can include one or more circuits to use a neural network to select a decoder from a plurality of decoders to decode an encoded representation of information received from an encoder or otherwise perform any of the operations described above or elsewhere herein. One or more circuits can be configured by software, e.g., programming platforms described herein, to use a neural network to select a decoder from a plurality of decoders to decode an encoded representation of information received from an encoder or otherwise perform any of the operations described above or elsewhere herein.

### Cloud and Web-Based Services

The following description sets forth, without limitation, cloud-based and/or web-based services and/or systems that can be used to use a neural network to select a decoder from a plurality of decoders to decode an encoded representation of information received from an encoder or otherwise perform some or all of processes, operations and/or and techniques described elsewhere herein. cloud-based and/or web-based services and/or systems can be configured by software to use a neural network to select a decoder from a plurality of decoders to decode an encoded representation of information received from an encoder or otherwise perform any of the operations described above or elsewhere herein.

Cloud computing can include a style of computing in which dynamically scalable and often virtualized resources are provided as a service over the Internet. Users need not have knowledge of, expertise in, or control over technology infrastructure, which can be referred to as “in the cloud,” that supports them. Cloud computing may incorporate infrastructure as a service, platform as a service, software as a service, and other variations that have a common theme of reliance on the Internet for satisfying computing needs of users. A typical cloud deployment, such as in a private cloud (e.g., enterprise network), or a data center (DC) in a public cloud (e.g., Internet) can include thousands of servers (or alternatively, VMs), hundreds of Ethernet, Fiber Channel or Fiber Channel over Ethernet (FCOE) ports, switching and storage infrastructure, etc. A cloud can also include network services infrastructure like IPsec VPN hubs, firewalls, load balancers, wide area network (WAN) optimizers etc. Remote subscribers can access cloud applications and services securely by connecting via a VPN tunnel, such as an IPsec VPN tunnel.

Cloud computing may include a model for enabling convenient, on-demand network access to a shared pool of configurable computing resources (e.g., networks, servers, storage, applications, and services) that can be rapidly provisioned and released with minimal management effort or service provider interaction.

Cloud computing may be characterized by on-demand self-service, in which a consumer can unilaterally provision computing capabilities, such as server time and network storage, as needed automatically without requiring human inter-action with each service's provider. Cloud computing may be characterized by broad network access, in which capabilities are available over a network and accessed through standard mechanisms that promote use by heterogeneous thin or thick client platforms (e.g., mobile phones, laptops, and PDAs). Cloud computing may be characterized by resource pooling, in which a provider's computing resources are pooled to serve multiple consumers using a multi-tenant model, with different physical and virtual resources dynamically as-signed and reassigned according to consumer demand. In at least one embodiment, there is a sense of location independence in that a customer generally has no control or knowledge over an exact location of provided resources, but may be able to specify location at a higher level of abstraction (e.g., country, state, or datacenter). Examples of resources include storage, processing, memory, network bandwidth, and virtual machines. Cloud computing may be characterized by rapid elasticity, in which capabilities can be rapidly and elastically provisioned, in some cases automatically, to quickly scale out and rapidly released to quickly scale in. In at least one embodiment, to a consumer, capabilities available for provisioning often appear to be unlimited and can be purchased in any quantity at any time. Cloud computing may be characterized by measured service, in which cloud systems automatically control and optimize resource use by leveraging a metering capability at some level of abstraction appropriate to a type of service (e.g., storage, processing, bandwidth, and active user accounts). Resource usage can be monitored, controlled, and reported providing transparency for both a provider and consumer of a utilized service.

Cloud computing may be associated with various services. Cloud Software as a Service (SaaS) may refer to as service in which a capability provided to a consumer is to use a provider's applications running on a cloud infrastructure. Applications can be accessible from various client devices through a thin client interface such as a web browser (e.g., web-based email). In at least one embodiment, consumer does not manage or control underlying cloud infrastructure including network, servers, operating systems, storage, or even individual application capabilities, with a possible exception of limited user-specific application configuration settings.

Cloud Platform as a Service (PaaS) may refer to a service in which a capability provided to consumer is to deploy onto cloud infrastructure consumer-created or acquired applications created using programming languages and tools supported by a provider. In at least one embodiment, a consumer does not manage or control underlying cloud infrastructure including networks, servers, operating systems, or storage, but has control over deployed applications and possibly application hosting environment configurations.

Cloud Infrastructure as a Service (IaaS) may refer to a service in which a capability provided to a consumer is to provision processing, storage, networks, and other fundamental computing resources where a consumer is able to deploy and run arbitrary software, which can include operating systems and applications. In at least one embodiment, consumer does not manage or control underlying cloud infrastructure, but has control over operating systems, storage, deployed applications, and possibly limited control of select networking components (e.g., host firewalls).

Cloud computing may be deployed in various ways. A private cloud may refer to a cloud infrastructure that is operated solely for an organization. A private cloud may be managed by an organization or a third party and may exist on-premises or off-premises. A community cloud may refer to a cloud infrastructure that is shared by several organizations and supports a specific community that has shared concerns (e.g., mission, security requirements, policy, and compliance considerations). A community cloud may be managed by organizations or a third party and may exist on-premises or off-premises. A public cloud may refer to a cloud infrastructure that is made available to a general public or a large industry group and is owned by an organization providing cloud services. A hybrid cloud may refer to a cloud infrastructure that is a composition of two or more clouds (private, community, or public) that remain unique entities, but are bound together by standardized or proprietary technology that enables data and application portability (e.g., cloud bursting for load-balancing between clouds). A cloud computing environment is service oriented with a focus on statelessness, low coupling, modularity, and semantic interoperability.

### Logic and Neural Network Training and Deployment

The following figures set forth, without limitation, examples of logic and artificial intelligence-based systems that can be used to implement functionality and/or operations described herein.

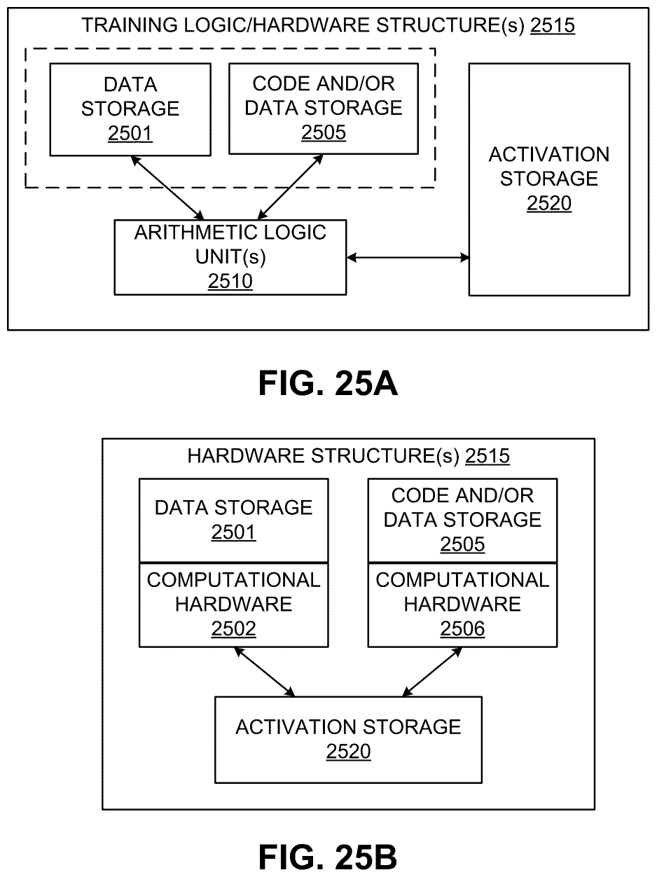

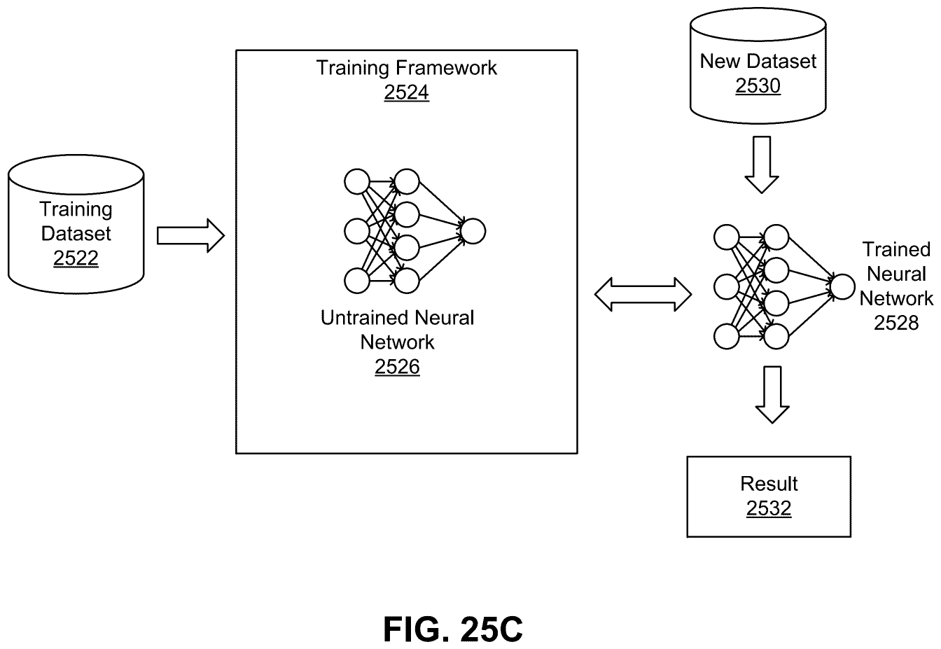

FIGS. 25A and 25B illustrate logic 2515 which, as described elsewhere herein, can be used in one or more devices or systems (e.g., such as any of the processors (e.g., any processor in FIGS. 13-25), data centers, cloud or web-based services described herein) to perform operations such as, but not limited to, those discussed herein, in accordance with at least one embodiment. Logic can refer to any combination of software logic, hardware logic, and/or firmware logic to provide functionality and/or operations described herein, wherein logic may be, collectively or individually, embodied as circuitry that forms part of a larger system, for example, an integrated circuit (IC), an application-specific integrated circuit (ASIC), a field programmable array (FPGA), system-on-chip (SoC), or one or processors (e.g., CPU, GPU). Logic 2515 illustrated in FIGS. 25A and 25B may be used in conjunction with an application-specific integrated circuit (“ASIC”), such as, but not limited to, a TensorFlow® Processing Unit from Google, an inference processing unit (IPU) from Graphcore™, or a Nervana® (e.g., “Lake Crest”) processor from Intel Corp. Logic 2515 illustrated in FIGS. 25A and 25B may be used in conjunction with central processing unit (“CPU”) hardware, graphics processing unit (“GPU”) hardware or other hardware, such as, but not limited to, field programmable gate arrays (“FPGAs”).

Logic 2515 can be used to perform inferencing and/or training operations associated with one or more embodiments. Logic 2515 may be inference and/or training logic. In at least one embodiment, FIG. 25A illustrates inference and/or training logic 2515 used to perform inferencing and/or training operations associated with one or more embodiments. Inference and/or training logic 2515 may include code and/or data storage 2501 to store forward and/or output weight and/or input/output data, and/or other parameters to configure neurons or layers of a neural network trained and/or used for inferencing in aspects of one or more embodiments. Training logic 2515 may include, or be coupled to code and/or data storage 2501 to store graph code or other software to control timing and/or order, in which weight and/or other parameter information is to be loaded to configure, logic, including integer and/or floating point units (collectively, arithmetic logic units (ALUs). Code, such as, but not limited to, graph code, can load weight or other parameter information into processor ALUs based on an architecture of a neural network to which such code corresponds. Code and/or data storage 2501 can store weight parameters and/or input/output data of each layer of a neural network trained or used in conjunction with one or more embodiments during forward propagation of input/output data and/or weight parameters during training and/or inferencing using aspects of one or more embodiments. Any portion of code and/or data storage 2501 may be included with other on-chip or off-chip data storage, including a processor's L1, L2, or L3 cache or system memory.

Any portion of code and/or data storage 2501 may be internal or external to one or more processors or other hardware logic devices or circuits. Code and/or code and/or data storage 2501 may be cache memory, dynamic randomly addressable memory (“DRAM”), static randomly addressable memory (“SRAM”), non-volatile memory (e.g., flash memory), or other storage. A choice of whether code and/or code and/or data storage 2501 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

Inference and/or training logic 2515 may include a code and/or data storage 2505 to store backward and/or output weight and/or input/output data corresponding to neurons or layers of a neural network trained and/or used for inferencing in aspects of one or more embodiments. Code and/or data storage 2505 can store weight parameters and/or input/output data of each layer of a neural network trained or used in conjunction with one or more embodiments during backward propagation of input/output data and/or weight parameters during training and/or inferencing using aspects of one or more embodiments. Training logic 2515 may include, or be coupled to code and/or data storage 2505 to store graph code or other software to control timing and/or order, in which weight and/or other parameter information is to be loaded to configure, logic, including integer and/or floating point units (collectively, arithmetic logic units (ALUs).

Code, such as, but not limited to, graph code, may cause loading of weight or other parameter information into processor ALUs based on an architecture of a neural network to which such code corresponds. Any portion of code and/or data storage 2505 may be included with other on-chip or off-chip data storage, including a processor's L1, L2, or L3 cache or system memory. Any portion of code and/or data storage 2505 may be internal or external to one or more processors or other hardware logic devices or circuits. Code and/or data storage 2505 may be cache memory, DRAM, SRAM, non-volatile memory (e.g., flash memory), or other storage. A choice of whether code and/or data storage 2505 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

Code and/or data storage 2501 and code and/or data storage 2505 may be separate storage structures. Code and/or data storage 2501 and code and/or data storage 2505 may be a combined storage structure. Code and/or data storage 2501 and code and/or data storage 2505 may be partially combined and partially separate. Any portion of code and/or data storage 2501 and code and/or data storage 2505 may be included with other on-chip or off-chip data storage, including a processor's L1, L2, or L3 cache or system memory.

Inference and/or training logic 2515 may include one or more arithmetic logic unit(s) (“ALU(s)”) 2510, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 2520 that may be functions of input/output and/or weight parameter data stored in code and/or data storage 2501 and/or code and/or data storage 2505. Activations stored in activation storage 2520 may be generated according to linear algebraic and or matrix-based mathematics performed by ALU(s) 2510 in response to performing instructions or other code, wherein weight values stored in code and/or data storage 2505 and/or data storage 2501 may be used as operands along with other values, such as, but not limited to, bias values, gradient information, momentum values, or other parameters or hyperparameters, any or all of which may be stored in code and/or data storage 2505 or code and/or data storage 2501 or another storage on or off-chip.

ALU(s) 2510 can be included within one or more processors or other hardware logic devices or circuits, whereas in another embodiment, ALU(s) 2510 may be external to a processor or other hardware logic device or circuit that uses them (e.g., a co-processor). ALUs 2510 may be included within a processor's execution units or otherwise within a bank of ALUs accessible by a processor's execution units either within same processor or distributed between different processors of different types (e.g., central processing units, graphics processing units, fixed function units, etc.). Code and/or data storage 2501, code and/or data storage 2505, and activation storage 2520 may share a processor or other hardware logic device or circuit, whereas in another embodiment, they may be in different processors or other hardware logic devices or circuits, or some combination of same and different processors or other hardware logic devices or circuits. Any portion of activation storage 2520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

Activation storage 2520 may be cache memory, DRAM, SRAM, non-volatile memory (e.g., flash memory), or other storage. Activation storage 2520 may be completely or partially within or external to one or more processors or other logical circuits. A choice of whether activation storage 2520 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 2515 illustrated in FIG. 25A may be used in conjunction with an application-specific integrated circuit (“ASIC”), such as, but not limited to, a TensorFlow® Processing Unit from Google, an inference processing unit (IPU) from Graphcore™, or a Nervana® (e.g., “Lake Crest”) processor from Intel Corp. In at least one embodiment, inference and/or training logic 2515 illustrated in FIG. 25A may be used in conjunction with central processing unit (“CPU”) hardware, graphics processing unit (“GPU”) hardware or other hardware, such as, but not limited to, field programmable gate arrays (“FPGAs”).

FIG. 25B illustrates inference and/or training logic 2515, in accordance with at least one embodiment. Inference and/or training logic 2515 may include hardware logic in which computational resources may be dedicated or otherwise exclusively used in conjunction with weight values or other information corresponding to one or more layers of neurons within a neural network. Inference and/or training logic 2515 illustrated in FIG. 25B may be used in conjunction with an application-specific integrated circuit (ASIC), such as, but not limited to, TensorFlow® Processing Unit from Google, an inference processing unit (IPU) from Graphcore™, or a Nervana® (e.g., “Lake Crest”) processor from Intel Corp. Inference and/or training logic 2515 illustrated in FIG. 25B may be used in conjunction with central processing unit (CPU) hardware, graphics processing unit (GPU) hardware or other hardware, such as, but not limited to, field programmable gate arrays (FPGAs). Inference and/or training logic 2515 can include code and/or data storage 2501 and code and/or data storage 2505, which may be used to store code (e.g., graph code), weight values and/or other information, including bias values, gradient information, momentum values, and/or other parameter or hyperparameter information. In FIG. 25B, for example, each of code and/or data storage 2501 and code and/or data storage 2505 is associated with a dedicated computational resource, such as, but not limited to, computational hardware 2502 and computational hardware 2506, respectively. Each of computational hardware 2502 and computational hardware 2506 can include one or more ALUs that perform mathematical functions, such as, but not limited to, linear algebraic functions, only on information stored in code and/or data storage 2501 and code and/or data storage 2505, respectively, result of which is stored in activation storage 2520.

Each of code and/or data storage 2501 and 2505 and corresponding computational hardware 2502 and 2506, respectively, correspond to different layers of a neural network, such that resulting activation from one storage/computational pair 2501/2502 of code and/or data storage 2501 and computational hardware 2502 is provided as an input to a next storage/computational pair 2505/2506 of code and/or data storage 2505 and computational hardware 2506, in order to mirror a conceptual organization of a neural network. Each of storage/computational pairs 2501/2502 and 2505/2506 may correspond to more than one neural network layer. Additional storage/computation pairs (not shown) subsequent to or in parallel with storage/computation pairs 2501/2502 and 2505/2506 may be included in inference and/or training logic 2515.

In at least one embodiment, logic 2515 described elsewhere herein, can include one or more circuits to use a neural network to select a decoder from a plurality of decoders to decode an encoded representation of information received from an encoder or otherwise perform any of the operations described above or elsewhere herein. One or more circuits in logic 2515 can be configured by software described herein, to use a neural network to select a decoder from a plurality of decoders to decode an encoded representation of information received from an encoder or otherwise perform any of the operations described above or elsewhere herein.

FIG. 25C illustrates training and deployment of a deep neural network, in accordance with at least one embodiment. An untrained neural network 2526 can be trained using a training dataset 2522. Training framework 2524 can be a PyTorch framework, and/or a training framework 2504 can include a TensorFlow, Boost, Caffe, Microsoft Cognitive Toolkit/CNTK, MXNet, Chainer, Keras, Deeplearning4j, or other training framework. Training framework 2524 can train an untrained neural network 2526 and enables it to be trained using processing resources described herein to generate a trained neural network 2528. Weights may be chosen randomly or by pre-training using a deep belief network. Training may be performed in either a supervised, partially supervised, or unsupervised manner.

Untrained neural network 2526 can be trained using supervised learning, wherein training dataset 2522 includes an input paired with a desired output for an input, or where training dataset 2522 includes input having a known output and an output of neural network 2526 is manually graded. Untrained neural network 2526 can be trained in a supervised manner and processes inputs from training dataset 2522 and compares resulting outputs against a set of expected or desired outputs. Errors can then be propagated back through untrained neural network 2526. Training framework 2524 can adjust weights that control untrained neural network 2526. Training framework 2524 can include tools to monitor how well untrained neural network 2526 is converging towards a model, such as, but not limited to, trained neural network 2528, suitable to generating correct answers, such as, but not limited to, in result 2532, based on input data such as, but not limited to, a new dataset 2530. Training framework 2524 can train untrained neural network 2526 repeatedly while adjust weights to refine an output of untrained neural network 2526 using a loss function and adjustment algorithm, such as, but not limited to, stochastic gradient descent. Training framework 2524 can train untrained neural network 2526 until untrained neural network 2526 achieves a desired accuracy. Trained neural network 2528 can then be deployed to implement any number of machine learning operations.

Untrained neural network 2526 can be trained using unsupervised learning, wherein untrained neural network 2526 attempts to train itself using unlabeled data. Unsupervised learning training dataset 2522 can include input data without any associated output data or “ground truth” data. Untrained neural network 2526 can learn groupings within training dataset 2522 and can determine how individual inputs may be related to untrained dataset 2522. Unsupervised training can be used to generate a self-organizing map in trained neural network 2528 capable of performing operations useful in reducing dimensionality of new dataset 2530. Unsupervised training can also be used to perform anomaly detection, which allows identification of data points in new dataset 2530 that deviate from normal patterns of new dataset 2530.

Semi-supervised learning may be used, which is a technique in which in training dataset 2522 includes a mix of labeled and unlabeled data. Training framework 2524 may be used to perform incremental learning, such as, but not limited to, through transferred learning techniques. Incremental learning can enable trained neural network 2528 to adapt to new dataset 2530 without forgetting knowledge instilled within trained neural network 2528 during initial training.

Training framework 2524 can include a framework processed in connection with a software development toolkit such as, but not limited to, an OpenVINO (Open Visual Inference and Neural network Optimization) toolkit. An OpenVINO toolkit can include a toolkit such as, but not limited to, those developed by Intel Corporation of Santa Clara, CA.

OpenVINO can include a toolkit for facilitating development of applications, specifically neural network applications, for various tasks and operations, such as, but not limited to, human vision emulation, speech recognition, natural language processing, recommendation systems, and/or variations thereof. OpenVINO can support neural networks such as, but not limited to, convolutional neural networks (CNNs), recurrent and/or attention-based neural networks, and/or various other neural network models. OpenVINO can support various software libraries such as, but not limited to, OpenCV, OpenCL, and/or variations thereof.

OpenVINO can support neural network models for various tasks and operations, such as, but not limited to, classification, segmentation, object detection, face recognition, speech recognition, pose estimation (e.g., humans and/or objects), monocular depth estimation, image inpainting, style transfer, action recognition, colorization, and/or variations thereof.

OpenVINO can include one or more software tools and/or modules for model optimization, also referred to as a model optimizer. A model optimizer can include a command line tool that facilitates transitions between training and deployment of neural network models. A model optimizer may optimize neural network models for execution on various devices and/or processing units, such as, but not limited to, a GPU, CPU, PPU, GPGPU, and/or variations thereof. A model optimizer can generate an internal representation of a model, and can optimize said model to generate an intermediate representation. A model optimizer may reduce a number of layers of a model. A model optimizer can remove layers of a model that may be utilized for training. A model optimizer may perform various neural network operations, such as, but not limited to, modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as, but not limited to, floating point, to a second representation, such as, but not limited to, integer), and/or variations thereof.

OpenVINO can include one or more software libraries for inferencing, also referred to as an inference engine. An inference engine can include a C++ library, or any suitable programming language library. An inference engine can be utilized to infer input data. An inference engine may implement various classes to infer input data and generate one or more results. An inference engine can implement one or more API functions to process an intermediate representation, set input and/or output formats, and/or execute a model on one or more devices.

OpenVINO may provide various abilities for heterogeneous execution of one or more neural network models. Heterogeneous execution, or heterogeneous computing, can refer to one or more computing processes and/or systems that utilize one or more types of processors and/or cores. OpenVINO can provide various software functions to execute a program on one or more devices. OpenVINO may provide various software functions to execute a program and/or portions of a program on different devices. OpenVINO may provide various software functions to, for example, run a first portion of code on a CPU and a second portion of code on a GPU and/or FPGA. OpenVINO may provide various software functions to execute one or more layers of a neural network on one or more devices (e.g., a first set of layers on a first device, such as, but not limited to, a GPU, and a second set of layers on a second device, such as, but not limited to, a CPU).

OpenVINO can include various functionality similar to functionalities associated with a CUDA programming model, such as, but not limited to, various neural network model operations associated with frameworks such as, but not limited to, TensorFlow, PyTorch, and/or variations thereof. One or more CUDA programming model operations may be performed using Open VINO. Various systems, methods, and/or techniques described herein may be implemented using Open VINO.

In at least one embodiment, one or more circuits can be used to cause one or more neural networks and training frameworks described elsewhere herein to use a neural network to select a decoder from a plurality of decoders to decode an encoded representation of information received from an encoder or otherwise perform any of the operations described above or elsewhere herein. One or more neural networks and training frameworks can be configured by software to use a neural network to select a decoder from a plurality of decoders to decode an encoded representation of information received from an encoder or otherwise perform any of the operations described above or elsewhere herein.

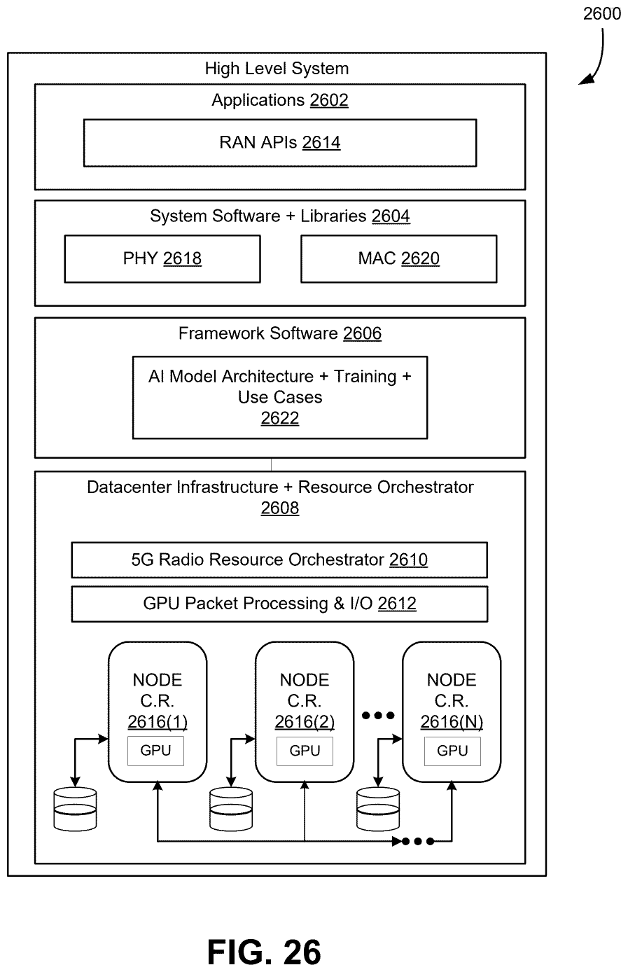

FIG. 26 illustrates an example high level system 2600. In at least one embodiment, high level system 2600 includes applications 2602, system software+libraries 2604, framework software 2606 and a datacenter infrastructure+resource orchestrator 2608. In at least one embodiment, high level system 2600 may be implemented as a cloud service, physical service, virtual service, network service, and/or variations thereof.

In at least one embodiment, as shown in FIG. 26, datacenter infrastructure+resource orchestrator 2608 may include 5G radio resource orchestrator 2610, GPU packet processing & I/O 2612, and node computing resources (“node C.R.s”) 2616(1)-2616(N), where “N” represents any whole, positive integer. In at least one embodiment, node C.R.s 2616(1)-2616(N) may include, but are not limited to, any number of central processing units (“CPUs”) or other processors (including accelerators, field programmable gate arrays (FPGAs), graphics processors (“GPUs”), etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 2616(1)-2616(N) may be a server having one or more of above-mentioned computing resources.

In at least one embodiment, 5G radio resource orchestrator 2610 may configure or otherwise control one or more node C.R.s 2616(1)-2616(N) and/or other various components and resources a 5G network architecture may comprise. In at least one embodiment, 5G radio resource orchestrator 2610 may include a software design infrastructure (“SDI”) management entity for high level system 2600. In at least one embodiment, 5G radio resource orchestrator 2610 may include hardware, software, or some combination thereof. In at least one embodiment, 5G radio resource orchestrator 2610 may be utilized to configure or otherwise control various medium access control sublayers, radio access networks, physical layers or sublayers, and/or variations thereof, which may be part of a 5G network architecture. In at least one embodiment, 5G radio resource orchestrator 2610 may configure or allocate grouped compute, network, memory or storage resources to support one or more workloads which may be executed as part of a 5G network architecture.

In at least one embodiment, GPU packet processing & I/O 2612 may configure or otherwise process various inputs and outputs, as well as packets such as data packets, which may be transmitted/received as part of a 5G network architecture, which may be implemented by high level system 2600. In at least one embodiment, a packet may be data formatted to be provided by a network and may be typically divided into control information and payload (e.g., user data). In at least one embodiment, types of packets may include Internet Protocol version 4 (IPv4) packets, Internet Protocol version 6 (IPv6) packets, and Ethernet II frame packets. In at least one embodiment, control data of a data packet may be classified into data integrity fields and semantic fields. In at least one embodiment, network connections that a data packet may be received upon include a local area network, a wide-area network, a virtual private network, Internet, an intranet, an extranet, a public switched telephone network, an infrared network, a wireless network, a satellite network, and any combination thereof.

In at least one embodiment, framework software 2606 includes an AI Model Architecture+Training+Use Cases 2622. In at least one embodiment, AI Model Architecture+Training+Use Cases 2622 may include tools, services, software, or other resources to train one or more machine learning models or predict or infer information using one or more machine learning models according to one or more embodiments. For example, in at least one embodiment, a machine learning model may be trained by calculating weight parameters according to a neural network architecture using software and computing resources described above with respect to high level system 2600. In at least one embodiment, trained machine learning models corresponding to one or more neural networks may be used to infer or predict information using resources described above with respect to high level system 2600 by using weight parameters calculated through one or more training techniques. In at least one embodiment, framework software 2606 may include a framework to support system software+libraries 2604 and applications 2602.

In at least one embodiment, system software+libraries 2604 or applications 2602 may respectively include web-based service software or applications, such as those provided by Amazon Web Services, Google Cloud and Microsoft Azure. In at least one embodiment, framework software 2606 may include, but is not limited to, a type of free and open-source software web application framework such as Apache Spark™ (hereinafter “Spark”). In at least one embodiment, system software+libraries 2604 may include software used by at least portions of node C.R.s 2616(1)-2616(N). In at least one embodiment, one or more types of software may include, but are not limited to, Internet web page search software, e-mail virus scan software, database software, and streaming video content software.

In at least one embodiment, PHY 2618 is a set of system software and libraries configured to provide an interface with a physical layer of a wireless technology, which may be a physical layer such as a 5G New Radio (NR) physical layer. In at least one embodiment, an NR physical layer utilizes a flexible and scalable design and may comprise various components and technologies, such as modulation schemes, waveform structures, frame structures, reference signals, multi-antenna transmission and channel coding.

In at least one embodiment, a NR physical layer supports quadrature phase shift keying (QPSK), 16 quadrature amplitude modulation (QAM), 64 QAM and 256 QAM modulation formats. In at least one embodiment, different modulation schemes for different user entity (UE) categories may also be included in a NR physical layer. In at least one embodiment, a NR physical layer may utilize cyclic prefix orthogonal frequency division multiplexing (CP-OFDM) with a scalable numerology (subcarrier spacing, cyclic prefix) in both uplink (UL) and downlink (DL) up to at least 52.6 GHz. In at least one embodiment, a NR physical layer may support discrete Fourier transform spread orthogonal frequency division multiplexing (DFT-SOFDM) in UL for coverage-limited scenarios, with single stream transmissions (that is, without spatial multiplexing).

In at least one embodiment, a NR frame supports time division duplex (TDD) and frequency division duplex (FDD) transmissions and operation in both licensed and unlicensed spectrum, which enables very low latency, fast hybrid automatic repeat request (HARQ) acknowledgements, dynamic TDD, coexistence with LTE and transmissions of variable length (for example, short duration for ultra-reliable low-latency communications (URLLC) and long duration for enhanced mobile broadband (eMBB)). In at least one embodiment, NR frame structure follows three key design principles to enhance forward compatibility and reduce interactions between different features.

In at least one embodiment, a first principle is that transmissions are self-contained, which can refer to a scheme in which data in a slot and in a beam are decodable on its own without dependency on other slots and beams. In at least one embodiment, this implies that reference signals required for demodulation of data are included in a given slot and a given beam. In at least one embodiment, a second principle is that transmissions are well confined in time and frequency, which results in a scheme in which new types of transmissions in parallel with legacy transmissions may be introduced. In at least one embodiment, a third principle is avoiding static and/or strict timing relations across slots and across different transmission directions. In at least one embodiment, usage of a third principle can entail utilizing asynchronous hybrid automatic repeat request (HARQ) instead of predefined retransmission time.

In at least one embodiment, NR frame structure also allows for rapid HARQ acknowledgement, in which decoding is performed during reception of DL data and HARQ acknowledgement is prepared by a UE during a guard period, when switching from DL reception to UL transmission. In at least one embodiment, to obtain low latency, a slot (or a set of slots in case of slot aggregation) is front-loaded with control signals and reference signals at a beginning of a slot (or set of slots).

In at least one embodiment, NR has an ultra-lean design that minimizes always-on transmissions to enhance network energy efficiency and ensure forward compatibility. In at least one embodiment, reference signals in NR are transmitted only when necessary. In at least one embodiment, four main reference signals are demodulation reference signal (DMRS), phase-tracking reference signal (PTRS), sounding reference signal (SRS) and channel-state information reference signal (CSI-RS).

In at least one embodiment, DMRS is used to estimate a radio channel for demodulation. In at least one embodiment, DMRS is UE-specific, can be beamformed, confined in a scheduled resource, and transmitted only when necessary, both in DL and UL. In at least one embodiment, to support multiple-layer multiple-input, multiple-output (MIMO) transmission, multiple orthogonal DMRS ports can be scheduled, one for each layer. In at least one embodiment, a basic DMRS pattern is front loaded, as a DMRS design takes into account an early decoding requirement to support low-latency applications. In at least one embodiment, for low-speed scenarios, DMRS uses low density in a time domain. In at least one embodiment, however, for high-speed scenarios, a time density of DMRS is increased to track fast changes in a radio channel.

In at least one embodiment, PTRS is introduced in NR to enable compensation of oscillator phase noise. In at least one embodiment, typically, phase noise increases as a function of oscillator carrier frequency. In at least one embodiment, PTRS can therefore be utilized at high carrier frequencies (such as mmWave) to mitigate phase noise. In at least one embodiment, PTRS is UE-specific, confined in a scheduled resource and can be beamformed. In at least one embodiment, PTRS is configurable depending on a quality of oscillators, carrier frequency, OFDM sub-carrier spacing, and modulation and coding schemes used for transmission.

In at least one embodiment, SRS is transmitted in UL to perform channel state information (CSI) measurements mainly for scheduling and link adaptation. In at least one embodiment, for NR, SRS is also utilized for reciprocity-based precoder design for massive MIMO and UL beam management. In at least one embodiment, SRS has a modular and flexible design to support different procedures and UE capabilities. In at least one embodiment, an approach for channel state information reference signal (CSI-RS) is similar.

In at least one embodiment, NR employs different antenna solutions and techniques depending on which part of a spectrum is used for its operation. In at least one embodiment, for lower frequencies, a low to moderate number of active antennas (up to around 32 transmitter chains) is assumed and FDD operation is common. In at least one embodiment, acquisition of CSI requires transmission of CSI-RS in a DL and CSI reporting in an UL. In at least one embodiment, limited bandwidths available in this frequency region require high spectral efficiency enabled by multi-user MIMO (MU-MIMO) and higher order spatial multiplexing, which is achieved via higher resolution CSI reporting compared with LTE.

In at least one embodiment, for higher frequencies, a larger number of antennas can be employed in a given aperture, which increases a capability for beamforming and multiuser (MU)-MIMO. In at least one embodiment, here, spectrum allocations are of TDD type and reciprocity-based operation is assumed. In at least one embodiment, high-resolution CSI in a form of explicit channel estimations is acquired by UL channel sounding. In at least one embodiment, such high-resolution CSI enables sophisticated precoding algorithms to be employed at a base station (BS). In at least one embodiment, for even higher frequencies (in mmWave range) an analog beamforming implementation is typically required currently, which limits transmission to a single beam direction per time unit and radio chain. In at least one embodiment, since an isotropic antenna element is very small in this frequency region owing to a short carrier wavelength, a great number of antenna elements is required to maintain coverage. In at least one embodiment, beamforming needs to be applied at both transmitter and receiver ends to combat increased path loss, even for control channel transmission.

In at least one embodiment, to support these diverse use cases, NR features a highly flexible but unified CSI framework, in which there is reduced coupling between CSI measurement, CSI reporting and an actual DL transmission in NR compared with LTE. In at least one embodiment, NR also supports more advanced schemes such as multi-point transmission and coordination. In at least one embodiment, control and data transmissions follow a self-contained principle, where all information required to decode a transmission (such as accompanying DMRS) is contained within a transmission itself. In at least one embodiment, as a result, a network can seamlessly change a transmission point or beam as a UE moves in a network.

In at least one embodiment, MAC 2620 is a set of system software and libraries configured to provide an interface with a medium access control (MAC) layer, which may be part of a 5G network architecture. In at least one embodiment, a MAC layer controls hardware responsible for interaction with a wired, optical, or wireless transmission medium. In at least one embodiment, MAC provides flow control and multiplexing for a transmission medium.

In at least one embodiment, a MAC sublayer provides an abstraction of a physical layer such that complexities of a physical link control are invisible to a logical link control (LLC) and upper layers of a network stack. In at least one embodiment, any LLC sublayer (and higher layers) may be used with any MAC. In at least one embodiment, any MAC can be used with any physical layer, independent of transmission medium. In at least one embodiment, a MAC sublayer, when sending data to another device on a network, encapsulates higher-level frames into frames appropriate for a transmission medium, adds a frame check sequence to identify transmission errors, and then forwards data to a physical layer as soon as appropriate channel access method permits it. In at least one embodiment, MAC is also responsible for compensating for collisions if a jam signal is detected, in which a MAC may initiate retransmission.

In at least one embodiment, applications 2602 may include one or more types of applications used by at least portions of node C.R.s 2616(1)-2616(N) and/or framework software 2606. In at least one embodiment, one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, RAN APIs 2614 may be a set of subroutine definitions, communication protocols, and/or software tools that provide a method of communication with components of a radio access network (RAN) which may be part of a 5G network architecture. In at least one embodiment, a radio access network is part of a network communications system and may implement a radio access technology. In at least one embodiment, radio access network functionality is typically provided by a silicon chip residing in both a core network as well as user equipment. Further information regarding a radio access network can be found in the description of FIG. 27.

In at least one embodiment, high level system 2600 may use CPUs, application-specific integrated circuits (ASICs), GPUs, FPGAs, or other hardware to perform training, inferencing, and/or other various processes using above-described resources. In at least one embodiment, moreover, one or more software and/or hardware resources described above may be configured as a service to allow users to train or performing inferencing of information, such as image recognition, speech recognition, or other artificial intelligence services, as well as other services such as services that allow users to configure and implement various aspects of a 5G network architecture.

In at least one embodiment, high level system 2600 can include or otherwise implement one or more circuits to use one or more neural networks to receive historical connection request information for one or more devices within one or more radio access networks (RANs) and generate an indication of priority of one or more next connection requests for the one or more UE devices, wherein the indication is used to cause the one or more connection next requests to be accepted, rejected, or prioritized and/or otherwise perform any of the operations described above or elsewhere herein. One or more circuits can be configured by software to use one or more neural networks to receive historical connection request information for one or more UE devices within one or more radio access networks (RANs) and generate an indication of priority of one or more next connection requests for the one or more UE devices, wherein the indication is used to cause the one or more connection next requests to be accepted, rejected, or prioritized and/or otherwise perform any of the operations described above or elsewhere herein.

FIG. 27 illustrates simulation software 2700 for a wireless network, such as a 5G New Radio (NR) or radio access network (RAN). Simulation software 2700 performed by processing circuitry can receive wireless signal data processed by radio framework 2702 from real-world wireless networks. Simulation software 2700 can use this data to simulate network performance under modified configurations of network components, including changes to base stations, antennas, and UE devices.

Radio framework 2702 (e.g., software performed by a processor to receive, collect, or otherwise get information) obtains wireless signal data from base station cell sites, antennas, and UE devices operating under protocols and standards that define wireless communication establishment, management, and optimization such as those from 3rd Generation Partnership Project. Radio framework 2702 can include databases for storing signal data, software libraries and modules for signal processing, and machine learning models for radio signal analysis. These components can enable simulation software to generate predictions about network performance based on modifications to network infrastructure and configurations.

Software 2704 performed by one or more processors can generate a virtual model of a network, including a RAN model, physical infrastructure models, and UE models. Software 2704 performed by one or more processors can use multiple models in a single simulation environment to optimize, monitor, manage, and simulate network performance.

Software 2704 performed by one or more processors can replicate a physical network infrastructure, including base stations, antennas, and other network components, to mirror real-world behavior, performance, and interactions. For example, software 2704 can be NVIDIA's Digital Twin software that receives network data from radio framework 2702 and updates virtual models to reflect real-time changes in the network environment. Input data can include network traffic, signal strength, device connectivity, configuration settings, historical network data, environmental conditions, and outputs from other simulations or neural network models.

Simulation controller 2706 performed by one or more processors can allocate computing resources to execute network simulations at varying levels of resolution. Simulation controller 2706 performed by one or more processors can adjust simulation settings based on user-defined configurations, dynamically modifying capacity limitations and computing resource allocation. Simulation controller 2706 can scale simulations from single cell sites to city-wide networks with thousands of base stations. To optimize computing resource utilization, simulation controller 2706 performed by processing circuitry can assign different spatial, frequency-based, or temporal resolutions to individual network cells. For example, simulation controller 2706 performed by processing circuitry can configure spatial resolution by setting wireless signal ray spacing to 10 cm or 1 cm, or adjust temporal resolution by modifying the frequency of simulation updates for network interactions.

Software 2704 performed by processing circuitry can include, access, or otherwise use data handler 2734, antenna model 2728, scene creation model 2730, and UE mobility model 2732. These models support network simulations executed by simulation controller 2706. Software 2704 can integrate models that simulate, generate, or otherwise use simulations such as RAN twin 2708, physical twin 2716, and UE twin 2722 to generate a comprehensive simulation environment.

Antenna model 2728 performed by processing circuitry can generate a representation of network antennas using input from antenna data sources such as base stations, RAN twin 2708, and physical twin 2716. The antenna model can include configuration data, beamforming parameters, radiation patterns, frequency, bandwidth, gain, efficiency, and environmental interference levels. The simulation software can include this model to evaluate antenna system performance and optimize beamforming configurations.

Scene creation model 2730 performed by a processor can construct a digital representation of the network environment using geospatial data, e.g., it can process geographic coordinates, terrain data, infrastructure layouts, and other environmental factors to create 3D network models. These models can enable simulation software to analyze how the physical environment impacts wireless signal propagation and network performance.

UE mobility model 2732 can generate, represent, or otherwise simulate movement patterns, historical behavior, and usage trends of UE devices such as smartphones and tablets. The UE mobility model can process field trace data, including GPS coordinates, signal strength, and cell site handovers, to simulate real-world UE interactions within the network. The simulation software can use this model to optimize network parameters such as transmission power and handover management.

Field trace data can include UE movement information, signal strength variations, and network handover records. The tuning framework processes field trace data to refine mobility models, which characterize UE movement speeds, directional changes, and connectivity patterns. The simulation software incorporates these models to evaluate network quality, coverage, and congestion levels.

The simulation software performed by processing circuitry can use, communicate, or otherwise correspond with RAN twin 2708, physical twin 2716, and UE twin 2722 to generate a comprehensive virtual network environment. RAN twin 2708 can digitally replicate base stations, antennas, and signal propagation behaviors. Physical twin 2716 can model real-world environmental factors affecting signal transmissions, such as terrain, buildings, and weather conditions. UE twin 2722 simulates UE behaviors, including data usage, mobility patterns, and connectivity changes.

Simulation software 2700 performed by processing circuitry can enable interaction between RAN twin 2708, physical twin 2716, and UE twin 2722. For example, RAN twin 2708 receives environmental data from physical twin 2716 and simulates network performance under various physical conditions. As another example, UE twin 2722 provides mobility and behavior data to RAN twin 2708, which then adjusts network configurations accordingly.

Simulation controller 2706 performed by processing circuitry can execute network simulations using inputs from RAN twin 2708, physical twin 2716, and UE twin 2722. Simulation controller 2706 can dynamically adjust network parameters, simulation settings, and computing resource allocations based on performance requirements and available computing power.

Simulation software 2700 performed by processing circuitry can use neural networks to analyze historical connection requests from UE devices in a RAN. The processing circuitry can generate priority indications for upcoming connection requests, which can be used to accept, reject, or prioritize network access. For example, during a simulation, a simulated base station can use these priority indicators to determine whether to establish a connection, while the simulation controller can adjust network barring time factors to delay specific connection attempts.

At least one embodiment of the disclosure can be described in view of the following clauses:

1. A system comprising:
one or more processors to:
   receive a wireless signal corresponding to encoded information that was generated using one or more encoders used by one or more user equipment devices (UEs);
   select, using a machine learning model, a decoder from a plurality of decoders based at least on one or more characteristics of the encoded information;
   decode, using the selected decoder, the encoded information;
   generate a response corresponding to the decoded information; and
   transmit the response to the one or more UEs using one or more wireless standard protocols.

2. The system of clause 1, wherein the one or more processors are comprised in at least one of:
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system for performing conversational artificial intelligence (AI) operations;
a system implementing one or more multi-model language models (MMLM);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or a system implemented at least partially using cloud computing resources.

3. The system of clause 1 or 2, wherein the one or more wireless standard protocols include at least one of the following: Fourth generation (4G), Fourth Generation Long-Term Evolution (4G LTE), Fifth generation (5G), and Sixth generation (6G).

4. The system of any of clauses 1-3, wherein the one or more processors are to train the machine learning model and the selected decoder jointly using one or more compressed representations of one or more messages generated by a neural encoder corresponding to the selected decoder.

5. The system of any of clauses 1-4, wherein the one or more processors are to train the machine learning model and the selected decoder using different loss functions.

6. The system of any of clauses 1-5, wherein the one or more processors are to use the machine learning model to generate a classification, wherein the classification corresponds to an identification of at least one of the plurality of decoders.

7. A method comprising:
receiving an encoded representation of information;
causing a machine learning model to use one or more characteristics of the encoded representation of information to select a decoder from a plurality of decoders that correspond to a corresponding plurality of encoders; and
using the selected decoder to decode the encoded representation of the information.

8. The method of clause 7, wherein the encoded representation includes a compressed representation of a message generated using one or more neural encoders used by one or more user equipment (UE) devices.

9. The method of clause 7 or 8, wherein the encoded representation includes information to detect and correct errors as a result of wireless transmission.

10. The method of any of clauses 7-9, wherein the encoded representation includes information corresponding to one or more of noise, interference, attenuation, multipath fading, or doppler shift that a wireless channel had on the encoded representation.

11. The method of any of clauses 7-10, wherein each of the plurality of decoders includes one or more machine learning models.

12. The method of any of clauses 7-11, wherein the machine learning model and the plurality of decoders are located in a base station.

13. The method of any of clauses 7-12, further comprising:
training the machine learning model and the selected decoder at least one of jointly or separately.

14 The method of any of clauses 7-13, wherein the method is performed using at least one of: a control system for an autonomous or semi-autonomous machine;
a perception system for an autonomous or semi-autonomous machine;
a system for performing one or more simulation operations;
a system for performing one or more digital twin operations;
a system for performing one or more light transport simulations;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or a system implemented at least partially using cloud computing resources.

15. One or more processors, comprising:
circuitry to use a machine learning model to select a decoder from a plurality of decoders based at least on an analysis of an encoded representation of information to be decoded by the selected decoder.

16. The one or more processors of clause 15, wherein the encoded representation includes a compressed representation of a message generated by one or more user equipment (UE) devices that are to use one or more encoders to generate the compressed representation.

17. The one or more processors of clause 15 or 16, wherein the encoded representation includes information corresponding to a modulation scheme used before transmission.

18 The one or more processors of any of clauses 15-17, wherein the encoded representation includes information corresponding to effects of a wireless channel on the encoded representation.

19. The one or more processors of any of clauses 15-18, wherein each of the plurality of decoders includes one or more neural decoders.

20 The one or more processors of any of clauses 15-19, wherein the machine learning model and the selected decoder are trained at least one of separately or jointly.

As will be apparent to one of ordinary skill in the art, other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

As described further herein, processors, such as those disclosed in FIGS. 13-25 can use instructions to perform any of the operations described herein. Instructions, for example, can be performed using one or more threads. A thread block can include any number of threads of execution. A workgroup can be a thread block. A processor can execute a group of threads (e.g., 16 threads). A group of threads can also be referred to as a warp, or subgroup, or wavefront (e.g., as used by AMD and Intel). Each thread in a warp, wave, subgroup, or wavefront can belong to a single thread block and can be configured to process a different set of data based on a single set of instructions. A lane can be a thread. A work item can be a thread, such as, but not limited to, e.g., with OpenCL.

A processor, such as, processors described further herein (e.g., FIGS. 13-25) can include one or more threads that can perform instructions synchronously. A thread can perform instructions synchronously. For example, a thread can perform a sequence of two instructions. An output of the first instruction can be input to the second instruction.

In at least one embodiment, a thread performs an instruction asynchronously if the thread performs one or more subsequent instructions before a processor's completion of all operations corresponding to the instruction have been completely been performed. For example, the thread can perform the instruction to cause a processor to queue or otherwise begin performing an operation and the thread can perform subsequent instructions before the processor has completed performing the operation. A processor, such as, processors described further herein (e.g., FIGS. 13-25) can perform instructions asynchronously. For example, a thread may submit or issue an instruction to be performed by processor, and processor can perform the instruction independently of a thread that can be performing other instruction(s). A thread may submit or issue an instruction that can be performed by processor, and, for example, can inform one or more threads (the same thread or other threads) when the processor has performed a previously submitted or issued instruction. A thread may perform a first instruction to wait to be informed that processor has performed previously submitted or issued instructions, and, for example, output from the processor can be available to the thread. Output from processor can be input to a thread performing a second instruction. Instructions can be performed asynchronously in a variety of sequences. For example, one or more threads may submit one or more instructions to a processor, and processor may perform instructions in a sequence that is the same or different than an order submitted by the threads. Processor may specify a sequencing for the instructions that the processor performs.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Use of “may” and/or “can” is intended to indicate by way of example without limiting any particular embodiment or component or other function described above, below, or elsewhere herein. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as, but not limited to, phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). Number of items in a plurality can be at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. A process such as, but not limited to, those processes described herein (or variations and/or combinations thereof) can be performed under control of one or more computer systems configured with executable instructions and is implemented as code (e.g., executable instructions, one or more computer programs or one or more applications) executing collectively on one or more processors, by hardware or combinations thereof. Code can be stored on a computer-readable storage medium, for example, in form of a computer program comprising a plurality of instructions executable by one or more processors. A computer-readable storage medium can be a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. Code (e.g., executable code or source code) can be stored on a set of one or more non-transitory computer-readable storage media having stored thereon executable instructions (or other memory to store executable instructions) that, when executed (e.g., as a result of being executed) by one or more processors of a computer system, cause computer system to perform operations described herein. A set of non-transitory computer-readable storage media can include multiple non-transitory computer-readable storage media and one or more of individual non-transitory storage media of multiple non-transitory computer-readable storage media lack all of code while multiple non-transitory computer-readable storage media collectively store all of code. Executable instructions can be executed such that different instructions are executed by different processors—for example, a non-transitory computer-readable storage medium store instructions and a main central processing unit (“CPU”) executes some of instructions while a graphics processing unit (“GPU”) executes other instructions. Different components of a computer system can have separate processors and different processors execute different subsets of instructions.

An arithmetic logic unit can include a set of combinational logic circuitry that takes one or more inputs to produce a result. An arithmetic logic unit can be used by a processor to implement mathematical operation such as, but not limited to, addition, subtraction, or multiplication. An arithmetic logic unit is used to implement logical operations such as, but not limited to, logical AND/OR or XOR. An arithmetic logic unit can be stateless, and made from physical switching components such as, but not limited to, semiconductor transistors arranged to form logical gates. An arithmetic logic unit may operate internally as a stateful logic circuit with an associated clock. An arithmetic logic unit may be constructed as an asynchronous logic circuit with an internal state not maintained in an associated register set. An arithmetic logic unit can be used by a processor to combine operands stored in one or more registers of the processor and produce an output that can be stored by the processor in another register or a memory location.

As a result of processing an instruction retrieved by the processor, the processor may present one or more inputs or operands to an arithmetic logic unit, causing the arithmetic logic unit to produce a result based at least in part on an instruction code provided to inputs of the arithmetic logic unit. The instruction codes provided by the processor to the ALU may be based at least in part on the instruction executed by the processor. Combinational logic in the ALU may process the inputs and produces an output which is placed on a bus within the processor. A processor can select a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

One or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Computer systems can be configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or example language (e.g., “such as, but not limited to,”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as, but not limited to, “processing,” “computing,” “calculating,” “determining,” or like, refer to action and/or processes of a computer or computing system, or similar electronic computing device, that manipulate and/or transform data represented as physical, such as, but not limited to, electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as, but not limited to, tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

References may be made to obtaining, acquiring, receiving, or inputting analog or digital data into a subsystem, computer system, or computer-implemented machine. Processes of obtaining, acquiring, receiving, or inputting analog and digital data can be accomplished in a variety of ways such as, but not limited to, by receiving data as a parameter of a function call or a call to an application programming interface. Processes of obtaining, acquiring, receiving, or inputting analog or digital data can be accomplished by transferring data via a serial or parallel interface. Processes of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as example forms of implementing the claims.

What is claimed is:

1. A system comprising:
one or more processors to:
receive a wireless signal corresponding to encoded information that was generated using one or more encoders used by one or more user equipment devices (UEs);
select, using a machine learning model, a decoder from a plurality of decoders based at least on one or more characteristics of the encoded information;
decode, using the selected decoder, the encoded information;
generate a response corresponding to the decoded information; and
transmit the response to the one or more UEs using one or more wireless standard protocols.

2. The system of claim 1, wherein the one or more processors are comprised in at least one of:
a system for performing simulation operations;
a system for performing digital twin operations;
a system for performing light transport simulations;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system for performing conversational artificial intelligence (AI) operations;
a system implementing one or more multi-model language models (MMLM);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

3. The system of claim 1, wherein the one or more wireless standard protocols include at least one of the following: Fourth generation (4G), Fourth Generation Long-Term Evolution (4G LTE), Fifth generation (5G), and Sixth generation (6G).

4. The system of claim 1, wherein the one or more processors are to train the machine learning model and the selected decoder jointly using one or more compressed representations of one or more messages generated by a neural encoder corresponding to the selected decoder.

5. The system of claim 1, wherein the one or more processors are to train the machine learning model and the selected decoder using different loss functions.

6. The system of claim 1, wherein the one or more processors are to use the machine learning model to generate a classification, wherein the classification corresponds to an identification of at least one of the plurality of decoders.

7. A method comprising:
receiving an encoded representation of information;
causing a machine learning model to use one or more characteristics of the encoded representation of information to select a decoder from a plurality of decoders that correspond to a corresponding plurality of encoders; and
using the selected decoder to decode the encoded representation of the information.

8. The method of claim 7, wherein the encoded representation includes a compressed representation of a message generated using one or more neural encoders used by one or more user equipment (UE) devices.

9. The method of claim 7, wherein the encoded representation includes information to detect and correct errors as a result of wireless transmission.

10. The method of claim 7, wherein the encoded representation includes information corresponding to one or more of noise, interference, attenuation, multipath fading, or doppler shift that a wireless channel had on the encoded representation.

11. The method of claim 7, wherein each of the plurality of decoders includes one or more machine learning models.

12. The method of claim 7, wherein the machine learning model and the plurality of decoders are located in a base station.

13. The method of claim 7, further comprising:
training the machine learning model and the selected decoder at least one of jointly or separately.

14. The method of claim 7 wherein the method is performed using at least one of: a control system for an autonomous or semi-autonomous machine;
a perception system for an autonomous or semi-autonomous machine;
a system for performing one or more simulation operations;
a system for performing one or more digital twin operations;
a system for performing one or more light transport simulations;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

15. One or more processors, comprising:
circuitry to use a machine learning model to select a decoder from a plurality of decoders based at least on an analysis of an encoded representation of information to be decoded by the selected decoder.

16. The one or more processors of claim 15, wherein the encoded representation includes a compressed representation of a message generated by one or more user equipment (UE) devices that are to use one or more encoders to generate the compressed representation.

17. The one or more processors of claim 15, wherein the encoded representation includes information corresponding to a modulation scheme used before transmission.

18. The one or more processors of claim 15, wherein the encoded representation includes information corresponding to effects of a wireless channel on the encoded representation.

19. The one or more processors of claim 15, wherein each of the plurality of decoders includes one or more neural decoders.

20. The one or more processors of claim 15, wherein the machine learning model and the selected decoder are trained at least one of separately or jointly.
